(19) United States
(12) Patent Application Publication
(10) Pub. No.: US 2026/0344692 A1
(43) Pub. Date: Nov. 5, 2026

(54) DAIRY PRODUCT AND PROCESS

(71) Applicant: Fonterra Co-operative Group Limited, Auckland (NZ)

(72) Inventors: Abbas Mehrabadi, Palmerston North (NZ); Esra Cakir Fuller, Palmerston North (NZ); Brent Anthony Vautier, Palmerston North (NZ); Lisa Marie Rutherford, Palmerston North (NZ); David Francis Elgar, Palmerston North (NZ); Michael Joseph Sowa, Boardman, OR (US)

(21) Appl. No.: 19/741,497

(22) Filed: Jul. 14, 2026

Related U.S. Application Data
(63) Continuation of application No. 18/859,410, filed on Apr. 26, 2023.
(60) Provisional application No. 63/363,914, filed on Apr. 29, 2022.
(60) Provisional application No. 63/382,595, filed on Nov. 7, 2022.

(51) Int. Cl. A23C 21/02; A21D 2/26; A23C 9/13; A23J 3/08; A23J 3/34; A23L 2/66

(52) U.S. Cl. CPC A23C 21/02; A21D 2/263; A23C 9/1307; A23J 3/08; A23J 3/343; A23L 2/66

(57) ABSTRACT

The present disclosure relates to a denatured whey protein composition. The denatured whey protein composition comprises submicrometre particles having a volume weighted mean diameter D(4,3) of not more than 1 μm and a substantially monomodal distribution wherein at least 95% by volume of the particles are not more than 2 μm. The present disclosure also relates to high protein beverages, food products, and nutritional compositions comprising such denatured whey protein compositions and methods for manufacturing such denatured whey protein compositions.

### CROSS-REFERENCE TO RELATED APPLICATIONS

This application is a continuation of U.S. application Ser. No. 18/859,410, filed on Oct. 23, 2024 as a National Stage Entry of International Application Number PCT/IB2023/054315, filed on Apr. 26, 2023, which claims priority to U.S. Provisional Application No. 63/382,595, filed on Nov. 7, 2022, and U.S. Provisional Application No. 63/363,914, filed on Apr. 29, 2022, the entire contents of each being incorporated herein by reference.

### TECHNICAL FIELD

The present invention relates to denatured whey protein compositions comprising heat-stable submicrometre particles, methods for preparing such compositions, and use of such compositions in neutral ready-to-drink high protein beverages, high protein drinking yoghurts, and food products, including high protein snacks, protein or nutrition bars, and set or stirred yoghurts.

### BACKGROUND

High-protein foods and beverages can be made using an ingredient with a high-protein content. Desirable properties of an ingredient with high-protein content include heat-stability to allow for subsequent heat treatment to ensure product safety and extended shelf life such as retort or ultra-high temperature (UHT) processing, and for beverage applications in particular, suspendability with minimal or essentially no sedimentation.

Microparticulated whey protein concentrate (WPC) ingredients have been known and used by the food industry to boost the protein content of various applications including cultured and ready-to-drink beverages, and food products, including bars and set or stirred yoghurts.

Microparticulation of whey proteins is an advanced technology for the production of whey protein particles. The size of the whey protein particles is important in delivering the desired mouthfeel; particles from 0.1 to 3 μm provide a creamy mouthfeel, whereas particles >3 μm cause a powdery and even gritty sensation and particles having a size of 0.1 μm create a watery mouthfeel. In fact, particle sizes in the range of less than 0.1 μm are known to contribute a greasy taste which is objectionable if it is perceived as the dominant tactile characteristic. Moreover, it can be desirable to keep the amount of whey protein particles having a size below 0.5 μm to a minimum as these smaller particles may provide an undesirably high viscosity to the products comprising them.

The principal mechanism of the formation of whey protein particles involves two steps: first, the whey proteins unfold during heating; and second, the unfolded protein molecules aggregate primarily via disulfide bonds and hydrophobic interactions. Processing conditions, such as temperature, heating time, pH, and shear stress determine the reaction kinetics as well as physical and chemical properties of the particles.

Traditional microparticulation processes incorporate shear or turbulent flow to limit the size of the whey protein particles. However, where high whey protein concentrations are used to manufacture the protein particles, the microparticulation/aggregation reaction occurs very rapidly likely due to the high molecule (protein) density and high collision efficiency. Although these technologies are effective in preventing the formation of very large microparticulates/aggregates, the mean size of the protein particles created during the traditional microparticulation process ranges from 1 micrometre to 10 micrometres with most of the particles having a diameter greater than 1 micrometre. This particle size range is still prone to cause sedimentation or precipitation in liquid applications over the shelf life of the product and to cause undesirable instability. Moreover, reduction of the protein particle sizes while ensuring all unfolded proteins forming into a stable microparticles has not been technically achievable.

Singer (U.S. Pat. No. 4,734,287) prepared a proteinaceous, water-dispersible, colloid comprising substantially non-aggregated particles of sweet whey protein coagulate having mean diameter particle size distributions, when dried, ranging from greater than about 0.1 μm to less than about 2.0 μm, with less than about 2 percent of the total number of particles exceeding 3.0 μm in diameter. According to Singer, these particles were heat labile and would form fused aggregates when subjected to additional heat denaturing treatment.

McCarthy (U.S. Pat. No. 5,350,590) sought to improve upon the composition provided by Singer and further demonstrated the heat-instability of a commercially available product manufactured according to Singer (designated as SIMPLESSE 100D). McCarthy prepared whey “loosely bound” agglomerates comprising whey protein and casein and suggested that the desolubilized casein substantially prevented formation of covalent bonds. McCarthy noted that agglomerates prepared without casein exhibited very poor thermal stability. As shown in FIG. 7, the particles prepared from whey protein alone were larger than 1 μm—and even greater than 10 μm—and the peak(s) of the particle distribution were greater than 1 μm, and, in some instances, greater than 10 μm.

Likewise, Huss and Spiegel (U.S. Pat. No. 6,767,575) prepared a denatured whey protein aggregate having a mean aggregate size (median) between 1 and 4 μm starting from a relatively dilute protein stream (<3% w/v protein). Again, the majority of particles were larger than 1 μm, particles having a size greater than 2 μm—and even greater than 5 μm-were present, and the peak of the particle distribution, by volume, was greater than 1 μm.

Villagran (U.S. Pat. No. 6,605,311) utilized a similar conventional process, starting from a 20% by mass whey protein solution, to produce a whey protein composition with a total protein content of less than 60%. According to Villagran, the resulting protein particles had a degree of protein insolubility of about 80%, and a mean diameter particle size distribution range of from about 0.1 μm to about 3.0 μm, with less than about 5% of the total number of particles exceeding about 3.0 μm in diameter.

Arase (US20150181908) reported that the denatured protein product obtained by the method of Villagran had an average particle size (defined by Arase as the particle size corresponding to 50% of the cumulative distribution of the particle size) of 1.6 μm and lacked heat stability. In fact, Arase reported that the denatured protein product obtained by the method of Villagran showed visually identifiable gelation upon heat treatment in an autoclave for 15 minutes at 120 °C. Arase sought to improve upon this product and utilized a feed having a lower percent protein by mass (12.5% in Arase's working example). The resultant product had an average particle size of 0.38 to 0.7 μm, a degree of protein insolubility of 43 to 47%, and exhibited better stability than products made by Villagran's method. Nevertheless, the product made by Arase's method exhibited heat instability in that the average particle size increased to 0.5 to 3.5 μm when a 10% by mass solution of the protein was heated at 120 °C for 15 minutes by an autoclave.

Have a (WO2010120199) provided methods for preparing a whey protein concentrate by providing an aqueous whey protein solution having a protein concentration of 15-50% (w/v), at a pH of 4.7-8.5; and heat treating the solution to more than 50 °C, for a time that allows protein denaturation to occur; the heat treatment comprised heating the solution while under conditions of turbulent flow, for example with a Reynolds number of at least 500.

Gulla (WO2013065014) and Cakir-Fuller (WO2020104954) reported that one exemplary heat denatured whey protein concentrate made using the method described in Havea had a primary aggregate size D(4,3) for a 10% total solids protein solution of 1.70 μm, with good heat stability as indicated by 1% aggregate growth after heating the 10% total solids protein solution. Other exemplary heat denatured whey protein concentrates made using the method described in Havea had a primary aggregate size D(4,3) for a 10% total solids protein solution ranging from 1.62 to 2.50 μm and exhibited varying degrees of heat stability.

Eriksen (WO2013117599) related to the use of a microparticulated whey protein in a frozen confectionery product. Eriksen exemplified microparticulated whey protein products where at least about 10% of the particles are above 5 μm. For example, in FIG. 2, Eriksen showed a multimodal particle size distribution having one peak between 0.1 and 1 μm and another peak between 1 and 10 μm, to yield a d₁₀ of 0.097 μm, a d₅₀ of 0.316 μm, and a d₉₀ of 4.579 μm.

Mikkelsen (WO2015059243) exemplified a process for production of a high protein denatured whey protein composition in which an aqueous solution containing sweet whey protein concentrate was prepared by dissolving whey protein concentrate in water to obtain a dry-matter content of 16% and adjusting the pH to 6.4. Denaturation and microparticulation was performed in a 6+6 Scraped Surface Heat Exchanger (SSHE), APV Shear Agglomerator. After passage through a holding cell (60 sec) the product was cooled down in a SSHE followed by a plate heat-exchanger (PHE) to 10 °C. During the heat-treatment (80 °C for a duration of 10 minutes) the protein was denatured and particles in the size 0.5-10 μm were formed. The product suspension was pumped to a storage tank, and some of it was subsequently dried to a powder by means of spray-drying. Mikkelsen reported that the resultant product suspension contained insoluble whey protein particles in the size range of 0.5 to 10 μm. Several additional patent applications from Arla Foods, including WO2018149869, WO2019110668, and WO2020187842, utilized the same process as outlined in Mikkelsen to obtain a denatured whey protein product comprising insoluble particles of denatured whey protein. Arla Foods sells microparticulated WPC, including Nutrilac®-YO8075, which are discussed in detail herein.

Burling (WO2005041677) prepared a whey protein gel suitable for stabilizing of low fat spreads and yoghurts using only small amounts of whey protein by cold gelation. Burling noted that it was of particular importance that the calcium concentration is kept very low, the protein concentration is kept relatively low and the pH value is kept at or above 7 during the heat treatment. In particular, pH>7 during the heating step promoted formation of soluble aggregates or filaments having a size of 20-100 nm prior to gel formation.

A series of patent applications from Nestec, including WO2007110421, WO2007110422, and WO2007110423, referred to a whey protein micelle powder that was produced in such a way that the micelles had an extremely sharp size distribution, such that more than 80% of the micelles produced had a size smaller than 1 μm, preferably between 100 nm and 900 nm, more preferably between 100-770 nm, most preferably between 200 and 400 nm. Micellisation occurred at pH 6.0 but not at pH 6.8, which instead resulted in formation of linear aggregates (i.e., acid-gellable whey protein aggregates). It was found that the conversion yield of native whey protein to micelles decreased when the initial protein concentration was 12% or higher. Turbidity measured at 500 nm for 3.4% protein solution was reported to be 21 (Example 2) and a 4% whey protein micelle dispersion exhibited a reported turbidity at 500 nm of 80 (Examples 11-12).

Minor (WO2009113845) prepared pasteurized liquid compositions comprising 12 g/100 mL or 16 g/100 mL whey protein. The average particle diameter as obtained from static light scattering (Malvern Mastersizer 2000), D(4,3), of the liquid compositions falls between 3.7 and 7.7 μm before and after heat treatment. Example 4 of Minor shows that the average particle diameter as obtained from static light scattering (Malvern Mastersizer 2000), D(4,3), of the whey protein composition was 0.48 μm before spray cooking and 0.29 μm after spray cooking.

Nielsen (WO2021136785) prepared whey protein nanogels from β-lactoglobulin isolate and a mixture of β-lactoglobulin isolate and whey protein isolate. Nielsen explained that whey protein nanogels have also been referred to as whey protein micelles by Nestec (e.g., WO2007/110421) but that their micellar nature is questionable. Nielsen emphasized that it was important to control levels of Na, K, and Ca ions to avoid gelation of the whole sample. Secondary heat treatment at UHT temperatures in the absence of applied shear forces resulted in gelation of the samples—heating at 150 °C for 7 min 30 sec induced gelation of the 14% and 16% protein content samples and heating at 150 °C for 3 min 10 sec induced gelation of the 20% protein content sample (and of the 14% protein content sample concentrated to 24%).

Dissanayake and Vasiljevic (J. Dairy Sci. 92, 1387-1397, 2009) prepared whey protein compositions by first heat treating 10% (w/w) whey protein retentate samples at 90 °C for 20 minutes and then applying dynamic high-pressure shearing (microfluidization) using 1 or 5 passes at 140 MPa. The average particle size of heat-treated and microfluidized whey protein was around 10 μm. These heat-treated, microfluidized samples were relatively unstable, exhibiting a heat coagulation time (HCT) at 140 °C of 87.8 seconds for 1 pass and 102.5 seconds for 5 passes.

The same group explored the functional properties of whey proteins microparticulated at low pH (Dissanayake et al., J. Dairy Sci. 95, 1667-1679, 2012). The average particle size of whey proteins microparticulated at low pH was around 100 nm. In particular, heat-treated, microparticulated, citric acid-acidified (HTM-CA) and heat-treated, microparticulated, lactic acid-acidified (HTM-LA) samples were reported to be 100±6.3 nm and 101±19.3 nm, respectively. Both the denatured microparticulated whey protein samples acidified with citric and lactic acids exhibited a heat coagulation time (HCT) at 140 °C greater than 3 minutes. However, the samples exhibited reduced heat stability—the protein content retained in the supernatant after heating 140 °C for 10 seconds followed by centrifugation (12,000×g, 20 °C) was only 19.7% and 10.9%, respectively, which may have resulted from specific acidulant effects.

While certain existing denatured whey protein compositions provide some resistance to gelation in a standard heat coagulation time test at 10% protein content (e.g., HCT of 2 minutes or more at 140 °C), these existing denatured whey protein compositions do not have the particle size distributions defined herein and, in particular, do not have particle size distributions that remain substantially the same following secondary heat treatment.

Thus, there remains a need for a microparticulated whey protein composition that is stable when exposed to secondary heat treatment, particularly a composition that exhibits substantially no change in particle size distribution upon exposure to secondary heat treatment.

### SUMMARY OF THE INVENTION

This disclosure is directed to denatured whey protein compositions as well as methods for preparing and using such compositions. The denatured whey protein compositions comprise submicrometre size particles comprising denatured whey protein.

By way of example, the particle size distribution of the denatured whey protein compositions have some, and preferably all, of the following characteristics: at least 55% by volume of the particles have a diameter between about 0.2 μm and about 1.0 μm; less than 45% by volume of the particles have a diameter between about 1.0 μm and about 10.0 μm; a d₅₀ from about 0.5 to about 1.2 μm or from about 0.6 to about 1.0 μm; a d₉₀ from about 0.9 to about 1.7 μm or from about 1.1 to about 1.5 μm; a volume weighted mean diameter D(4,3) between about 0.6 to about 1.0 μm; and/or a substantially monomodal distribution such that at least 95% or at least 98% by volume of the particles have a diameter less than about 2.0 μm. Without wishing to be bound by theory, it is believed that at least the step of treating the aqueous whey protein solution and/or whey protein retentate with an oxidizing agent provides a denatured whey protein composition in which the reactivity of the denatured proteins and microparticles upon further heating is minimal, thereby rendering the microparticles relatively resistant to further growth by subsequent heat treatment. Indeed, such denatured whey protein compositions are highly stable to secondary heating conditions and exhibit minimal or essentially no primary particle size growth after heating a 10% (w/w) protein content aqueous solution (at pH 6.8) at 120 °C for 15 minutes. In certain embodiments, the denatured whey protein composition has an insolubility of at least 55%, at least 60%, at least 65%, at least 70%, at least 75%, at least 80%, at least 85%, or at least 90%. In certain embodiments, the residual denaturable whey protein in the composition is less than 20%, less than 18%, less than 16%, or less than 14% or less than 12%. In some such embodiments, residual denaturable whey protein is less than 16%, or less than 14% or less than 12%. In certain embodiments, the denatured whey protein in the composition has a high degree of covalent bonding. For example, at least 60%, at least 70%, or at least 80% of β-lactoglobulin in the denatured whey protein composition is covalently cross-linked to form a multimer (e.g., dimer, trimer, etc.). As another example, the ratio of covalent to non-covalent interactions in the microparticles is at least 4 to 1. Moreover, high protein liquid applications, such as a drinking yoghurt or a liquid nutritional composition, made using the denatured whey protein compositions exhibit essentially no change in the particle size after heat treatment and, therefore, show minimal or essentially no sedimentation upon prolonged storage. As such, high protein liquid applications enabled by the present technology are expected to provide excellent stability over the shelf life of the product.

In one aspect, this disclosure provides denatured whey protein compositions comprising submicrometre particles having the particle size distributions described herein. The particle size distribution of such denatured whey protein compositions is stable when exposed to secondary heat treatment. For example, after heating a 10% (w/w) protein content aqueous solution at 120 °C for 15 minutes (e.g., in an autoclave or oil bath), the d₅₀ remains from about 0.6 to about 1.0 μm and/or the doo remains from about 0.9 to about 1.7 μm.

This disclosure provides a heat-stable, denatured whey protein composition comprising an amount of total protein of at least 60% on a dry weight basis and microparticles comprising denatured whey protein, wherein the microparticles have a particle size distribution comprising at least two characteristics selected from the group consisting of: (i) a volume weighted mean diameter D(4,3) of not more than about 1.0 μm, (ii) a d₅₀ of not more than about 1.0 μm, (iii) a d₉₀ of not more than about 2.0 μm, (iv) at least 92% by volume of the particles have a diameter less than about 2.0 μm, and (v) not more than 45% by volume of the microparticles have a diameter between about 1.0 and about 10.0 μm.

This disclosure also provides a liquid composition, such as a drinking yoghurt, an acidic beverage, a neutral beverage, or a liquid nutritional composition, comprising the heat-stable, denatured whey protein composition disclosed herein and a food product, such as a baked food product, a bar, or a set or stirred yoghurt comprising the heat-stable, denatured whey protein composition disclosed herein.

This disclosure also provides a heat-treated, shelf-stable high protein liquid composition comprising at least 6% (w/v) whey protein, wherein said whey protein comprises microparticles comprising denatured whey protein; and wherein (i) the liquid composition has a d₅₀ of not more than about 1.0 μm and a d₉₀ of not more than about 2.0 μm after secondary heat treatment applied for microbial control; (ii) said liquid composition has a viscosity of less than 400 mPa·s or less than 200 mPa·s measured at 100 s⁻¹ at 20 °C; (iii) said liquid composition exhibits less than 10% sedimentation following storage at a temperature from about 20 °C to about 25 °C for 6 weeks; and/or (iv) said liquid composition exhibits less than 10% sedimentation after centrifugation at 1540×g for 5 minutes.

This disclosure also provides a liquid nutritional composition comprising at least 12% (w/v) total protein, such as 12% to 18% (w/v) total protein, wherein at least 95% of the total protein in the liquid nutritional composition is denatured whey protein. The liquid nutritional composition may further comprise a lipid component and/or a carbohydrate component; for example, the lipid component may be present in amount up to 30% (w/v) and the carbohydrate component may be present in amount up to 30% (w/v). In certain embodiments, substantially all of the total protein in the liquid nutritional composition is denatured whey protein. In certain embodiments, the liquid nutritional composition has a caloric density less than 1 kcal/ml, alternatively 1 to 2 kcal/ml, alternatively greater than 2 kcal/ml. In certain embodiments, the liquid nutritional composition has a caloric density of 1.5 to 2.5 kcal/ml. In certain embodiments, (i) the liquid nutritional composition has a d₅₀ of not more than about 1.0 μm after secondary heat treatment applied for microbial control; (ii) said liquid nutritional composition has a viscosity of less than 400 mPa·s or less than 200 mPa·s measured at 100s⁻¹ at 20 °C; (iii) said liquid nutritional composition exhibits less than 10% sedimentation following storage at a temperature from about 20 °C to about 25 °C for 6 weeks; and/or (iv) said liquid nutritional composition exhibits less than 10% sedimentation after centrifugation at 1540×g for 5 minutes.

In one aspect, this disclosure provides a denatured whey protein composition comprising microparticles, said microparticles comprising denatured whey protein, wherein at least 55% by volume of the microparticles have a diameter from about 0.2 μm to about 1.0 μm and at least 95%, at least 98%, or at least 99% by volume of the microparticles have a diameter less than about 2.0 μm; and wherein the denatured whey protein composition exhibits substantially no change in particle size distribution upon exposure to secondary heat treatment. In certain embodiments, after heating a 10% (w/w) protein content aqueous solution at 120 °C for 15 minutes (e.g., in an autoclave or oil bath), the d₅₀ remains from about 0.6 to about 1.0 μm and/or the d₉₀ remains from about 0.9 to about 1.7 μm.

In another aspect, this disclosure provides a denatured whey protein composition comprising microparticles, said microparticles comprising denatured whey protein, wherein the microparticles have a volume weighted mean diameter D(4,3) from about 0.6 to about 1.0 μm, at least 98% by volume of the microparticles have a diameter less than about 2.0 μm, and at least 99% by volume of the microparticles have a diameter less than about 3.0 μm; and wherein the denatured whey protein composition exhibits substantially no change in particle size distribution upon exposure to secondary heat treatment. In certain embodiments, after heating a 10% (w/w) protein content aqueous solution at 120 °C for 15 minutes (e.g., in an autoclave or oil bath), the d₅₀ remains from about 0.6 to about 1.0 μm and/or the doo remains from about 0.9 to about 1.7 μm.

In certain embodiments of any aspect disclosed herein, the stability of the particle size distribution is determined by assessing primary particle growth following (secondary) heat treatment of a 10% (w/w) protein content aqueous solution at 120 °C for 15 minutes or 140 °C for 90 seconds (e.g., in an autoclave or oil bath).

In some such embodiments, a 10% (or 12%, or 14%, or 16%) (w/w) protein content solution containing the denatured whey protein, when subjected to a primary particle growth test, exhibits minimal or essentially no shift in particle size distribution. As an example, the primary particle growth test comprises (secondary) heat treatment at 120 °C for 15 minutes (e.g., in an oil bath).

In some such embodiments, the d₅₀ of a 10% (or 12%, or 14%, or 16%) (w/w) protein content solution does not substantially increase following a primary particle growth test comprising heat treatment at 120 °C for 15 minutes (e.g., in an autoclave or oil bath).

In some such embodiments, the d₅₀ of a 10% (w/w) protein content aqueous solution following the primary particle growth test comprising heat treatment at 120 °C for 15 minutes (e.g., in an autoclave or oil bath) is not more than about 1.0 μm. In some such embodiments, the d₅₀ of a 10% (w/w) protein content aqueous solution following the primary particle growth test is from about 0.6 to about 1.0 μm.

In some such embodiments, the d₅₀ of a 10% (w/w) protein content aqueous solution prior to the primary particle growth test is not more than 20%, not more than 18%, not more than 16%, not more than 14%, not more than 12%, not more than 10%, not more than 9%, not more than 8%, not more than 7%, not more than 6%, or not more than 5% different from the d₅₀ following the primary particle growth test.

In some such embodiments, the d₉₀ of a 10% (or 12%, or 14%, or 16%) (w/w) protein content solution does not substantially increase following a primary particle growth test comprising heat treatment at 120 °C for 15 minutes (e.g., in an autoclave or oil bath).

In some such embodiments, the d₉₀ of a 10% (w/w) protein content aqueous solution following the primary particle growth test comprising heat treatment at 120 °C for 15 minutes (e.g., in an autoclave or oil bath) is less than about 2.0 μm. In some such embodiments, the d₉₀ of a 10% (w/w) protein content aqueous solution following the primary particle growth test is from about 0.9 to about 1.7 μm or from about 1.1 to about 1.5 μm.

In some such embodiments, the d₉₀ of a 10% (w/w) protein content aqueous solution prior to the primary particle growth test is not more than 30%, not more than 25%, or not more than 20% different from the doo following the primary particle growth test.

In some such embodiments, the d₅₀ of a 10% (w/w) protein content aqueous solution following the primary particle growth test comprising heat treatment at 120 °C for 15 minutes (e.g., in an autoclave or oil bath) is from about 0.6 to about 1.0 μm and the d₉₀ of a 10% (w/w) protein content aqueous solution following the primary particle growth test is from about 0.9 to about 1.7 μm.

In certain embodiments of any aspect disclosed herein, heat coagulation time (HCT)—the time required to observe the formation of visible aggregates in a 10% (w/w) protein content aqueous solution containing the denatured whey protein composition during heating at 140 °C (e.g., in an oil bath)—of the denatured whey protein composition is at least 3 minutes, at least 4 minutes, at least 5 minutes, at least 6 minutes, at least 9 minutes, at least 12 minutes, at least 15 minutes, or at least 18 minutes.

In certain embodiments of any aspect disclosed herein, (i) the denatured whey protein composition comprises 65% to 95%, 75% to 90%, or 80% to 85% by weight total protein on a dry weight basis; (ii) residual denaturable whey protein in the denatured whey protein composition is less than 16%, less than 14%, or less than 12% and/or the denatured whey protein composition has an insolubility of at least 60% or at least 65%; (iii) the ratio of covalent to non-covalent interactions in the microparticles is at least 2 to 1, at least 3 to 1, or at least 4 to 1 and/or at least 60%, at least 70%, or at least 80% of β-lactoglobulin is covalently cross-linked; (iv) β-lactoglobulin is not more than 80% or not more than 75% of the total protein in the denatured whey protein composition; (v) the denatured whey protein composition has a lactose content of at most 10%, at most 8%, at most 6%, or at most 4% by weight; (vi) the denatured whey protein composition has a fat content of at most 20%, at most 18%, at most 16%, at most 14%, at most 12%, at most 10%, at most 8%, at most 6%, or at most 4% by weight; (vii) the denatured whey protein composition has an ash content of at most 10%, at most 8%, at most 6%, or at most 4% by weight; (viii) the denatured whey protein composition has a casein content of at most 5%, at most 4%, at most 3%, at most 2%, or at most 1% by weight; or (ix) a combination of any two or more of, or all of, (i) to (viii).

This disclosure also provides methods for making the denatured whey protein composition described herein. The methods comprise (a) providing an aqueous whey protein solution or a whey protein retentate; (b) contacting the aqueous whey protein solution or the whey protein retentate with an oxidizing agent; and (c) subjecting the whey protein solution or the whey protein retentate to a heat treatment under conditions that allow for protein denaturation to occur, wherein the total protein content of the aqueous whey protein solution or whey protein retentate during step (c) is preferably at least 16% (w/w). In certain embodiments, the oxidizing agent is a peroxide, such as hydrogen peroxide, and step (b) comprises contacting the aqueous whey protein solution or the whey protein retentate with the peroxide in combination with a peroxidase enzyme. In certain embodiments, the oxidizing agent is optionally inactivated, removed, or consumed prior to step (c) and, therefore, the aqueous whey protein solution or the whey protein retentate may be substantially free of the oxidizing agent during the heat treatment of step (c). In certain embodiments, the aqueous whey protein solution or the whey protein retentate is substantially free of the oxidizing agent during the heat treatment of step (c) where no active steps are taken to inactivate, remove, or consume the oxidizing agent. For example, the oxidizing agent may be present in an amount (e.g., <10 ppm) such that removal or consumption of the oxidizing agent is not desirable. In certain embodiments, the heat treatment of step (c) comprises a temperature of at least 70 °C.

The disclosure also provides edible consumer products, including food and beverages as well as liquid nutritional compositions comprising the denatured whey protein composition described herein.

The disclosure also provides methods for providing nutritional supplementation to a subject in need thereof. The methods comprise enterally administering to the subject the denatured whey protein composition disclosed herein or a liquid nutritional composition comprising such denatured whey protein composition.

The disclosure also provides a liquid composition comprising a denatured whey protein composition, wherein the liquid composition exhibits minimal or essentially no change in particle size distribution after pasteurization or sterilization. In certain embodiments, the liquid composition has a d₅₀ of less than 1 μm and a d₉₀ of less than 2 μm. In certain embodiments, the liquid composition, after storage (e.g., at a temperature from about 20 °C to about 25 °C) for 1, 3, 6, or 12 months, exhibits essentially no sedimentation, retains relatively low viscosity, and exhibits pleasant taste and mouthfeel with no powderiness or grittiness.

It is an object of the invention to provide: denatured whey protein compositions with improved heat stability; and/or compositions exhibiting minimal or essentially no primary particle size growth upon secondary heat treatment; and/or products containing denatured whey protein compositions wherein such products have particles size distributions that provide improved mouthfeel, sedimentation, and/or shelf-life; and/or at least to provide the public with a useful choice.

These and other objects of the invention are described in the following paragraphs. These objects should not be deemed to narrow the scope of the invention.

### BRIEF DESCRIPTION OF THE DRAWINGS

FIG. 1 is a process flow diagram for the manufacture of an exemplary denatured whey protein composition.

FIG. 2 is a process flow diagram for the manufacture of an exemplary liquid composition, namely a high protein beverage, comprising a denatured whey protein composition.

FIG. 3 is a process flow diagram for the manufacture of an exemplary liquid composition, namely a drinking yoghurt, comprising a denatured whey protein composition.

FIG. 4 shows the particle size distributions of high protein beverages after heating at 120 °C for 15 minutes prepared with Powder A, Powder G or Powder H.

FIG. 5 shows the particle size distributions of protein solutions containing Powder A after heating at 120 °C for 15 minutes at 10%, 12%, 14% or 16% (w/w) protein.

FIG. 6 shows the heat coagulation time of the denatured whey protein compositions prepared at protein concentrations of 10% to 20% (w/w).

FIG. 7 shows the particle size distributions of high protein (15% (w/w) and 20% (w/w)) drinking yoghurts comprising denatured whey protein concentrates at 1 week.

FIG. 8 shows the heat coagulation time (HCT) of the denatured whey protein compositions prepared from samples treated at different peroxide dosing rate.

FIG. 9 shows the protein profile of samples after treatment by enzyme and before heat treatment analyzed by HPLC.

FIG. 10 shows the particle size distribution of 12% (w/v) low calorie high protein beverage before and after indirect UHT heating (143 °C, 6 seconds).

### DETAILED DESCRIPTION OF THE INVENTION

This detailed description is intended only to acquaint others skilled in the art with the present invention, its principles, and its practical application so that others skilled in the art may adapt and apply the invention in its numerous forms, as they may be best suited to the requirements of a particular use. This description and its specific examples are intended for purposes of illustration only. This invention, therefore, is not limited to the embodiments described in this patent application, and may be variously modified.

### A. DEFINITIONS

As used in the specification and the appended claims, unless specified to the contrary, the following terms have the meaning indicated:

The term “about” refers generally to a range of numerical values (e.g., ±5 to 10% of the recited value) that one of ordinary skill in the art would consider equivalent to the recited value. Ranges can be expressed herein as from “about” one particular value, and/or to “about” another particular value. When such a range is expressed, the range is inclusive of the recited values.

The term “denatured whey protein composition” refers to a composition which contains at least some denatured whey protein and preferably a significant amount of denatured whey protein. The composition may also contain non-denatured whey protein. However, the denatured whey protein composition preferably has an insolubility of at least 50%. Alternatively or additionally, the residual denaturable whey protein in the composition is preferably less than 20%.

The term “dry weight basis” refers to the percentage of the substance in the composition or product after removing the moisture in the product. This can be calculated by applying a correction to allow for the retained moisture in the product.

The term “liquid nutritional composition” refers to an aqueous composition to be administered preferably by mouth or by other means, generally by tube feeding, to the stomach of a subject. Such other means include naso-gastric feeding and gastric feeding. The term “liquid nutritional composition” includes medical food, enteral nutrition, food for special medical purposes, liquid meal replacers and supplements. The liquid nutritional compositions described herein provide significant amounts of protein and carbohydrate and usually also lipid. They may also include vitamins and minerals. In various embodiments, a subject in need of nutrition may be suffering from or predisposed to a disease or condition, or may be being or have been treated for a disease or condition, is an elderly person, a person that is recovering from a disease or condition, or a person that is malnourished. In other embodiments, the subject may also be a healthy individual, including but not limited to, a sportsman or active elderly person, including persons having particular nutritional requirements.

The term “microparticles” refers to a population of insoluble aggregates comprising denatured whey proteins. Such aggregates may be formed via covalent (e.g., intermolecular sulphydryl-disulphide interchange reactions) and/or non-covalent interactions (e.g., hydrophobic interactions). In general, individual microparticles may have a particle size from about 0.1 μm up to about 3.0 μm or larger (e.g., up to about 20 μm) and a population of particles has the particle size distribution as further defined herein.

The term “non-dairy protein” refers to any protein that is not a milk protein (i.e., any protein that is not derived from animal milk). Non-dairy protein includes plant-derived protein, fungal protein, and algal protein.

The term “non-whey protein” refers to any protein that is not whey protein. As used herein, the term “non-whey protein” includes casein and protein derived from one or more non-dairy sources.

The term “subject” includes humans and other primates as well as other mammals such as farm animals, sport animals, and pets. In certain embodiments, the subject is a human. In some such embodiments, the subject is a human infant, a human toddler, a human child, or a human adult. In certain embodiments, the subject is in need of nutritional support.

The term “substantially non-hydrolysed” refers to protein that is not hydrolysed (intact) and protein having a degree of hydrolysis of less than about 10.0%, 5.0%, 4.0%, 3.5%, 3.0%, 2.5%, 2.0%, 1.5%, 1.0%, or less than about 0.5%. Unless indicated otherwise, the whey protein and non-whey protein for use herein is substantially non-hydrolysed.

The term “total protein” pertains to the total amount of protein of a composition or product and can be determined, for example, using the Kjeldahl method and the appropriate nitrogen conversion factor for dairy proteins.

The term “whey protein concentrate” or “WPC” refers to a fraction of whey from which lactose has been at least partially removed to increase the protein content to at least 20% by weight. In certain embodiments, WPC has at least 35%, and, preferably, at least 60%, at least 65%, at least 70%, at least 75%, or at least 80% by weight of the total solids (TS) as whey protein. For the purposes of this specification, the term “WPC” includes whey protein isolate (WPI) when the context allows.

The term “whey protein isolate” as used herein refers to a composition that consists primarily of whey proteins with negligible lipid and lactose content. Accordingly, the preparation of WPI typically requires a more rigorous separation process such as a combination of micro-filtration and ultra-filtration or ion exchange chromatography. It is generally recognized that a WPI refers to a composition in which at least 90% by weight of the solids are whey proteins.

The term “yoghurt” or “yogurt” refers to an acidic or fermented food or beverage product prepared from a dairy source, and containing either viable micro-organisms or chemical acidulants or both. The term “yoghurt” or “yogurt” includes set or stirred yoghurts as well as drinking yoghurts and also includes ambient yoghurts.

### B. DENATURED WHEY PROTEIN COMPOSITIONS

Denatured whey protein compositions disclosed herein comprise submicrometre particles and may exhibit substantially no change in particle size distribution upon exposure to secondary heat treatment. Such whey protein compositions are well-suited for applications that involve secondary heating conditions such as high temperature pasteurization, ultra-high temperature (UHT) processing or retort heating applied for sterilization and microbial control. The denatured whey protein compositions disclosed herein may provide a thinner, less powdery mouthfeel than previously known compositions and exhibit minimal or essentially no grittiness or sandiness.

### 1. Particle Size Distribution Characteristics

As discussed herein, particle size distribution characteristics are predicated on particle size distribution for a reconstituted liquid comprising the denatured whey protein composition disclosed herein.

In certain embodiments, the composition comprises microparticles comprising denatured whey protein, wherein the microparticles have a volume weighted mean diameter D(4,3) of not more than about 1.0 μm. In some such embodiments, the volume weighted mean diameter D(4,3) of the microparticles is from about 0.6 to about 1.0 μm or from about 0.7 to about 1.0 μm. In some such embodiments, at least 91% by volume of the microparticles have a diameter less than about 2.0 μm. Alternatively, at least 92%, at least 93%, at least 94%, at least 95%, at least 96%, at least 97%, at least 98%, or at least 99% by volume of the microparticles have a diameter less than about 2.0 μm. In some such embodiments, at least 95%, at least 96%, at least 97%, at least 98%, or at least 99% by volume of the microparticles have a diameter less than about 1.5 μm. In some such embodiments, at least 98% by volume of the microparticles have a diameter less than about 3.0 μm. Alternatively, at least 99% by volume of the microparticles have a diameter less than about 3.0 μm.

In certain embodiments, the composition comprises microparticles comprising denatured whey protein, wherein at least 40% by volume of the microparticles have a diameter from about 0.1 μm to about 1.0 μm. In some such embodiments, at least 45% by volume of the microparticles have a diameter from about 0.1 μm to about 1.0 μm. In some such embodiments, at least 50% by volume of the microparticles have a diameter from about 0.1 μm to about 1.0 μm. In some such embodiments, at least 55% by volume of the microparticles have a diameter from about 0.1 μm to about 1.0 μm. In some such embodiments, at least 60% by volume of the microparticles have a diameter from about 0.1 μm to about 1.0 μm. In some such embodiments, at least 85%, at least 86%, at least 87%, at least 88%, or at least 89% by volume of the microparticles have a diameter less than about 1.5 μm. In some such embodiments, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein at least 40% by volume of the microparticles have a diameter from about 0.2 μm to about 1.0 μm. In some such embodiments, at least 45% by volume of the microparticles have a diameter from about 0.2 μm to about 1.0 μm. In some such embodiments, at least 50% by volume of the microparticles have a diameter from about 0.2 μm to about 1.0 μm. In some such embodiments, at least 55% by volume of the microparticles have a diameter from about 0.2 μm to about 1.0 μm. In some such embodiments, at least 60% by volume of the microparticles have a diameter from about 0.2 μm to about 1.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein at least 40% by volume of the microparticles have a diameter from about 0.3 μm to about 1.0 μm. In some such embodiments, at least 45% by volume of the microparticles have a diameter from about 0.3 μm to about 1.0 μm. In some such embodiments, at least 50% by volume of the microparticles have a diameter from about 0.3 μm to about 1.0 μm. In some such embodiments, at least 55% by volume of the microparticles have a diameter from about 0.3 μm to about 1.0 μm. In some such embodiments, at least 60% by volume of the microparticles have a diameter from about 0.3 μm to about 1.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein at least 40% by volume of the microparticles have a diameter from about 0.4 μm to about 1.0 μm. In some such embodiments, at least 45% by volume of the microparticles have a diameter from about 0.4 μm to about 1.0 μm. In some such embodiments, at least 50% by volume of the microparticles have a diameter from about 0.4 μm to about 1.0 μm. In some such embodiments, at least 55% by volume of the microparticles have a diameter from about 0.4 μm to about 1.0 μm. In some such embodiments, at least 60% by volume of the microparticles have a diameter from about 0.4 μm to about 1.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein at least 40% by volume of the microparticles have a diameter from about 0.5 μm to about 1.0 μm. In some such embodiments, at least 45% by volume of the microparticles have a diameter from about 0.5 μm to about 1.0 μm. In some such embodiments, at least 50% by volume of the microparticles have a diameter from about 0.5 μm to about 1.0 μm. In some such embodiments, at least 55% by volume of the microparticles have a diameter from about 0.5 μm to about 1.0 μm. In some such embodiments, at least 60% by volume of the microparticles have a diameter from about 0.5 μm to about 1.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein the microparticles have a d₅₀ of not more than about 1.2 μm, not more than about 1.1 μm, not more than about 1.0 μm. In some such embodiments, the microparticles have a d₅₀ from about 0.5 to about 1.2 μm, from about 0.6 to about 1.1 μm, from about 0.6 to about 1.0 μm, or from about 0.7 to about 1.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein the microparticles have a d₉₀ of not more than about 2.0 μm, not more than about 1.9 μm, or not more than about 1.8 μm. In some such embodiments, the microparticles have a d₉₀ from about 0.6 to about 2.0 μm, from about 0.7 to about 1.9 μm, from about 0.8 to about 1.8 μm, from about 0.9 to about 1.7 μm, from about 1.0 to about 1.6 μm, or from about 1.1 to about 1.5 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein the microparticles have a d₅₀ from about 0.5 to about 1.2 μm and a d₉₀ from about 0.9 to about 1.7 μm. In some such embodiments, the microparticles have a d₅₀ from about 0.6 to about 1.0 μm and a doo from about 0.9 to about 1.7 μm. In some such embodiments, the microparticles have a d₉₀ from about 1.1 to about 1.5 μm. Thus, in some such embodiments, the microparticles have a d₅₀ from about 0.6 to about 1.0 μm and a d₉₀ from about 1.1 to about 1.5 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein the microparticles have a d₁₀ from about 0.2 to about 0.8 μm, a d₅₀ from about 0.5 to about 1.2 μm, and a d₉₀ from about 0.9 to about 1.7 μm. In some such embodiments, the microparticles have a d₁₀ from about 0.3 to about 0.7 μm or from about 0.4 to about 0.6 μm. In some such embodiments, the microparticles have a d₅₀ from about 0.6 to about 1.0 μm. In some such embodiments, the microparticles have a doo from about 1.1 to about 1.5 μm. Thus, in some such embodiments, the microparticles have a d₁₀ from about 0.4 to about 0.6 μm, a d₅₀ from about 0.6 to about 1.0 μm, and a d₉₀ from about 1.1 to about 1.5 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

In certain embodiments, the composition comprises microparticles comprising denatured whey protein, wherein not more than 45% by volume of the microparticles have a diameter between about 1.0 and about 10.0 μm. In some such embodiments, at least 85%, at least 86%, at least 87%, at least 88%, or at least 89% by volume of the microparticles have a diameter less than about 1.5 μm. In some such embodiments, at least 91%, at least 92%, at least 93%, at least 94%, at least 95%, at least 96%, at least 97%, at least 98%, or at least 99% by volume of the microparticles have a diameter less than about 2.0 μm. In some such embodiments, at least 98% or at least 99% by volume of the microparticles have a diameter less than about 2.5 μm. In some such embodiments, at least 99% or at least 99.9% by volume of the microparticles have a diameter less than about 3.0 μm.

As used herein, a particle size of about 0.4 μm encompasses 0.35 to 0.44 μm, a particle size of about 0.5 μm encompasses 0.45 to 0.54 μm, about 0.6 μm encompasses 0.55 to 0.64 μm, a particle size of about 0.7 μm encompasses 0.65 to 0.74 μm, a particle size of about 0.8 μm encompasses 0.75 to 0.84 μm, a particle size of about 0.9 μm encompasses 0.85 to 0.94 μm, and a particle size of about 1.0 μm encompasses 0.95 to 1.04 μm.

Methods for assessing particle size are known in the art. As an example, particle size can be measured using a Malvern Mastersizer 2000 (Malvern Instruments Ltd, Worcs, UK) with a refractive index for the particles of 1.46, and for the solvent of 1.33. For example, in an exemplary embodiment, primary aggregate size of a reconstituted powder is determined by homogenizing (e.g., 150/50 bar) a suspension of 10% total solids (TS) at natural pH and determining the mean particle size (characterized by D [4,3]) using a Malvern Mastersizer 2000 (Malvern Instruments Ltd, Worcs, UK) with a refractive index for the particles of 1.46 and for the solvent of 1.33 as described above.

### 2. Stable Particle Size Distribution

In certain embodiments, the particle size distribution of the denatured whey protein composition is substantially unchanged following a primary particle growth test comprising heat treatment at 120 °C for 15 minutes (e.g., in an autoclave or oil bath).

In certain embodiments, the denatured whey protein composition exhibits minimal or essentially no shift in particle size distribution when subjected to a primary particle growth test. In certain embodiments, the primary particle growth test comprises (secondary) heat treatment at 120 °C for 15 minutes (e.g., in an autoclave or oil bath). For example, a 10% (w/w) protein content aqueous solution containing the denatured whey protein composition exhibits minimal or essentially no shift in particle size distribution following the primary particle growth test.

In some such embodiments, the d₅₀ of a 10% (or 12%, or 14%, or 16%) (w/w) protein content solution does not substantially increase following a primary particle growth test comprising heat treatment at 120 °C for 15 minutes (e.g., in an autoclave or oil bath).

In some such embodiments, the d₅₀ of a 10% (w/w) protein content aqueous solution following the primary particle growth test comprising heat treatment at 120 °C for 15 minutes (e.g., in an autoclave or oil bath) is not more than about 1.0 μm. In some such embodiments, the d₅₀ of a 10% (w/w) protein content aqueous solution following the primary particle growth test is from about 0.6 to about 1.0 μm.

In some such embodiments, the d₅₀ of a 10% (w/w) protein content aqueous solution prior to the primary particle growth test is not more than 20%, not more than 18%, not more than 16%, not more than 14%, not more than 12%, not more than 10%, not more than 9%, not more than 8%, not more than 7%, not more than 6%, or not more than 5% different from the d₅₀ following the primary particle growth test.

In some such embodiments, the d₅₀ of the denatured whey protein compositions disclosed herein is stable when subjected to a primary particle growth test at a protein content up to 16% (w/w).

In some such embodiments, the d₉₀ of a 10% (or 12%, or 14%, or 16%) (w/w) protein content solution does not substantially increase following a primary particle growth test comprising heat treatment at 120 °C for 15 minutes (e.g., in an autoclave or oil bath).

In some such embodiments, the d₉₀ of a 10% (w/w) protein content aqueous solution following the primary particle growth test comprising heat treatment at 120 °C for 15 minutes (e.g., in an autoclave or oil bath) is not more than about 2.0 μm, not more than about 1.9 μm, or not more than about 1.8 μm. In some such embodiments, the d₉₀ of a 10% (w/w) protein content aqueous solution following the primary particle growth test is from about 0.6 to about 2.0 μm, from about 0.7 to about 1.9 μm, from about 0.8 to about 1.8 μm, from about 0.9 to about 1.7 μm, from about 1.0 to about 1.6 μm, or from about 1.1 to about 1.5 μm.

In some such embodiments, the d₉₀ of a 10% (w/w) protein content aqueous solution prior to the primary particle growth test is not more than 30%, not more than 28%, not more than 26%, not more than 24%, not more than 22%, not more than 20%, not more than 18%, or not more than 16% different from the d₉₀ following the primary particle growth test.

In some such embodiments, the d₉₀ of the denatured whey protein compositions disclosed herein is stable when subjected to a primary particle growth test at a protein content up to 16% (w/w).

In some such embodiments, the d₅₀ of a 10% (w/w) protein content aqueous solution following the primary particle growth test comprising heat treatment at 120 °C for 15 minutes (e.g., in an autoclave or oil bath) is from about 0.6 to about 1.0 μm and the d₉₀ of a 10% (w/w) protein content aqueous solution following the primary particle growth test is from about 1.1 to about 1.5 μm.

Methods for assessing primary particle growth are known in the art. In certain embodiments, primary particle growth is determined as described herein. Briefly, a 10% (w/w) protein solution (at pH 6.8) is heated at 120 °C for 15 minutes (e.g., in an autoclave or oil bath). Particle size distribution can be assessed following heat treatment.

Stability of the particle size distribution of the denatured whey protein composition or a liquid composition comprising the denatured whey protein composition includes having minimal or essentially no gelation, sedimentation, or aggregation after secondary heat treatment. Gelation of a liquid composition is considered to be a change in state from a liquid to a soft to firm solid. If the solution no longer flows following heating, it is considered to have gelled.

In certain embodiments, the particle size distribution of the denatured whey protein composition is stable upon sterilization and/or pasteurization (e.g., high temperature pasteurization, UHT processing or retort heating). High temperature pasteurization requires a temperature of 80-85 °C for 20-30 minutes or 90-95 °C for 5 minutes. UHT processing typically involves subjecting a composition to a temperature above 135 °C, such as 135 °C to 150 °C, to achieve sterilization. Typical holding times for UHT are 4 to 10 seconds (or longer). Typically, two variations of UHT treatment are used: direct or indirect. In the direct UHT heating system, the steam is directly mixed with the liquid composition whereas in the indirect UHT heating system, the liquid composition is heated by contacting with the steam or superheated water throughout the metal surface of a heat exchanger (Zadow, 1986). Retort processing typically involves subjecting a composition to temperatures between 110 °C and 130 °C for 10 to 20 minutes in a sealed can to achieve sterilization.

### 3. Heat Coagulation Time

In certain embodiments, the heat coagulation time (HCT) of a 10% (w/w) protein content aqueous solution containing the denatured whey protein composition, is at least 3 minutes, at least 4 minutes, at least 5 minutes, at least 6 minutes, at least 7 minutes, at least 8 minutes, at least 9 minutes, at least 10 minutes, at least 11 minutes, or at least 12 minutes. In some such embodiments, the HCT of a 10% (w/w) protein content aqueous solution containing the denatured whey protein composition is at least 14 minutes. HCT is defined as the time required to observe the formation of visible (i.e., visible to the naked eye) aggregates during heating in an oil bath at 140 °C.

Methods for determining heat coagulation time (HCT) are known in the art. The HCT method involves sealing 1 mL of a sample in a glass tube which is clipped onto a platform and placed in a silicone oil bath thermostatically controlled at 140 °C with a defined rocking rate. The length of time that elapses between placing the container in the oil bath and onset of visible aggregates formation is defined as the HCT (Singh H & Creamer LK (1992), Determination of heat stability, In: Advanced Dairy Chemistry e.d. Fox PF Elsevier).

Applicants believe, without wishing to be bound by any theory and based on their experience including that described herein, any liquid composition having a heat coagulation time of less than 60 seconds has a high risk of extensive fouling and blocking of UHT heating equipment, while any liquid composition with 65-80 seconds HCT at 140 °C has a potential risk of fouling. As described herein, liquid compositions having a heat coagulation time of higher than 80 seconds are believed to be stable to UHT heating treatment at 140 °C for 5 seconds. Alternatively, or additionally, following heating at 121 °C in an oil bath, a sample having an HCT less than 3 minutes has a high risk of gelation and aggregation in a retort can.

In some such embodiments, the denatured whey protein compositions disclosed herein exhibit minimal or substantially no gelation or coagulation following 2 minutes at 140 °C at a protein content up to 16% (w/w).

In certain embodiments, the HCT of a 12%, or 14%, or 16% (w/w) protein content solution containing the denatured whey protein composition is at least 2 minutes. In some such embodiments, the HCT of a 12% (w/w) protein content solution containing the denatured whey protein composition is at least 8 minutes. In some such embodiments, the HCT of a 14% (w/w) protein content solution containing the denatured whey protein composition is at least 4 minutes. In some such embodiments, the HCT of a 16% (w/w) protein content solution containing the denatured whey protein composition is at least 2 minutes.

### 4. High Protein Content

In certain embodiments, the denatured whey protein composition comprises 60% to 95% by weight total protein on a dry weight basis. In some such embodiments, the denatured whey protein composition comprises 65% to 95% by weight total protein on a dry weight basis. In some such embodiments, the denatured whey protein composition comprises 70% to 95% by weight total protein on a dry weight basis. In some such embodiments, the denatured whey protein composition comprises 75% to 90% by weight total protein on a dry weight basis. In some such embodiments, the denatured whey protein composition comprises 80% to 85% by weight total protein on a dry weight basis.

In certain embodiments, the denatured whey protein composition comprises at least 60%, at least 65%, at least 70%, at least 75%, or at least 80% by weight total protein on a dry weight basis. In some such embodiments, the denatured whey protein composition comprises at least 70%, at least 75%, or at least 80% by weight total protein on a dry weight basis.

Methods for assessing protein concentration are known in the art. As an example, protein concentration can be measured using the Kjeldahl method. This method is based on nitrogen determination and protein concentration is calculated by multiplying the total nitrogen result by a nitrogen conversion factor of 6.38 for dairy proteins.

Optionally, non-protein nitrogen (NPN) is also determined such as by following ISO 8968-4/IDF 020-4-Milk—Determination of nitrogen content—Part 4: Determination of non-protein-nitrogen content and the true protein content of a sample is calculated as (m_{total nitrogen}−m_{NPN})*6.38. Unless otherwise specified herein, total protein content is reported without reference to NPN.

### 5. Highly Denatured

Whey proteins include bovine serum albumin (BSA), α-lactalbumin, β-lactoglobulin, lactoferrin, immunoglobulins, and other minor proteins. Cheese whey-based ingredients may contain additional proteins, such as glycomacropeptide (GMP) and proteose peptone 5 (pp5), which are a casein-related proteins. Heat treatment of whey or WPC results in denaturation of BSA, α-lactalbumin, β-lactoglobulin, lactoferrin, immunoglobulins. In contrast, GMP and pp5 are non-denaturable.

As noted herein, acid casein whey, which lacks GMP, can be used as a source of whey proteins. For example, an exemplary ingredient can be made using 60% cheese WPC and 40% acid WPC, which would provide a higher level of heat-denaturable protein than a corresponding ingredient made from cheese WPC alone.

Methods to determine the degree of protein denaturation are known in the art. Exemplary methods used herein rely on HPLC (Elgar et al (2000) J Chromatography A, 878, 183-196); and other methods suitable for use include methods reliant on an Agilent 2100 Bioanalyzer (Agilent Technologies, Inc. 2000, 2001-2007, Waldbronn, Germany) and microfluidic chips, and utilizing Agilent 2100 Expert software (e.g. Anema, (2009) International Dairy J, 19, 198-204), and polyacrylamide gel electrophoresis (e.g. Patel et al, (2007) Le Lait, 87, 251-268).

The denatured whey protein compositions may be characterized by measuring the residual denaturable protein as a proportion of total protein (TN×6.38) according to the following formula:

$$\% Residual denaturable protein = \frac{( soluble denaturable protein ) \times 100}{( Total Nitrogen \times 6.38 )}$$

where the soluble whey protein is determined using reversed phase HPLC (Elgar et al., 2000) as described above and is expressed as grams protein/100 grams powder.

The denaturable whey protein is measured as Z (bovine serum albumin+α-lactalbumin+β-lactoglobulin+lactoferrin+immunoglobulins).

In certain embodiments, the residual denaturable whey protein in the composition is less than 20%, less than 18%, less than 16%, or less than 14% or less than 12%. In some such embodiments, residual denaturable whey protein is less than 16%, or less than 14% or less than 12%.

For an exemplary denatured whey protein composition, the proportion of denaturable protein that has been denatured can be estimated according to the following formula:

$$1 - \frac{( residual denaturable protein )}{( total denaturable protein )} \times 100$$

The denatured whey protein compositions may also be characterized in terms of insolubility. For example, a suspension containing the denatured whey protein composition in NaCl is treated with acetic acid and subjected to centrifugation. The total protein content of the supernatant and of the suspension not subjected to centrifugation are determined and the percent insolubility of the sample can be determined as follows:

$$\% insolubility = 1 - \frac{( TNsupernatant \times 6.38 )}{( TNsuspension \times 6.38 )} \times dilution factor of acetic acid$$

In certain embodiments, the denatured whey protein composition has an insolubility of at least 55%, at least 60%, at least 65%, at least 70%, at least 75%, at least 80%, at least 85%, at least 90%.

In certain embodiments, at least 50%, at least 55%, at least 60%, at least 65%, at least 70%, at least 75%, at least 80%, at least 85%, at least 90%, or at least 95% of heat-denaturable whey protein in the composition is present in a denatured state. In some such embodiments, at least 60% of heat-denaturable whey protein is present in a denatured state, at least 70% of heat-denaturable whey protein is present in a denatured state, or at least 80% of heat-denaturable whey protein is present in a denatured state.

The denatured whey protein compositions may also be characterized in terms of the ratio of undenaturable protein (e.g., GMP) to residual denaturable protein(s). For example, in certain embodiments, the ratio of GMP to the sum of soluble α-lactalbumin and soluble β-lactoglobulin is at least 1, at least 2, or at least 3.

### 6. Covalent/Non-Covalent Bonds

Both covalent and non-covalent interactions can be involved in the formation of whey protein microparticles. Covalent interactions involve electron sharing and are relatively stronger bonds. Non-covalent interactions involved in the formation of whey protein microparticles include van der Waals forces, hydrophobic interactions, and hydrogen bonds. Without wishing to be bound by theory, it is believed that the covalent interactions provide for irreversible aggregation of whey proteins.

The presence of free sulfhydryl (—SH) or intramolecular disulfide (SS) groups in the secondary structure of whey proteins facilitates the formation of covalent interactions. β-lactoglobulin contains two intramolecular disulfide (SS) groups and one free SH group, making it highly reactive in covalent interactions. BSA contains 17 SS bonds and one SH group, also making it capable of initiating covalent aggregation. α-lactalbumin contains four SS bonds but no free SH group to serve as the starting point for a covalent aggregation reaction.

In certain embodiments, the denatured whey protein in the composition has a high degree of covalent bonding.

For example, at least 60%, at least 70%, or at least 80% of β-lactoglobulin in the denatured whey protein composition is covalently cross-linked to another protein (e.g., another β-lactoglobulin molecule and/or BSA and/or α-lactalbumin) to form a multimer (e.g., dimer, trimer, etc.). In some such embodiments, at least 85% of β-lactoglobulin in the denatured whey protein composition is covalently cross-linked to another protein.

As another example, the ratio of covalent to non-covalent interactions in the microparticles is at least 2 to 1, at least 3 to 1, or at least 4 to 1.

### 7. Further Characteristics of the Denatured Whey Protein Composition

In certain embodiments, α-lactalbumin is not more than 60%, not more than 50%, or not more than 40% of the total protein in the denatured whey protein composition.

In certain embodiments, the denatured whey protein composition comprises from about 5% to about 30% α-lactalbumin, about 10% to about 25% α-lactalbumin, or about 15% to about 20% α-lactalbumin, relative to the total protein in the denatured whey protein composition.

In certain embodiments, β-lactoglobulin is not more than 80%, not more than 75%, or not more than 70% of the total protein in the denatured whey protein composition.

In certain embodiments, the denatured whey protein composition comprises from about 30% to about 80% β-lactoglobulin, about 35% to about 75%, about 40% to about 65%, or about 45% to about 60% β-lactoglobulin, relative to the total protein in the denatured whey protein composition.

In certain embodiments, the denatured whey protein composition has an α-lactalbumin to β-lactoglobulin ratio from about 1 to 15 to about 10 to 1, from about 1 to 10 to about 5 to 1, or from about 1 to 5 to about 1 to 1.

In certain embodiments, the denatured whey protein composition, when in an aqueous solution, exhibits substantial turbidity. For example, a 3.4% (w/w) protein content aqueous solution containing the denatured whey protein composition exhibits a turbidity value measured at 500 nm and at 20 °C of at least 50 absorbance units. In some such embodiments, a 3.4% (w/w) protein content aqueous solution containing the denatured whey protein composition exhibits a turbidity value measured at 500 nm of at least 75 or at least 100 absorbance units. As another example, a 4% (w/w) protein content aqueous solution containing the denatured whey protein composition exhibits a turbidity value measured at 500 nm of at least 90 absorbance units. In some such embodiments, a 4% (w/w) protein content aqueous solution containing the denatured whey protein composition exhibits a turbidity value measured at 500 nm of at least 100, at least 110, or at least 120 absorbance units.

To assess turbidity, it may be necessary to further dilute the aqueous solution. For example, a 3.4% (w/w) protein content aqueous solution can be diluted to protein content less than 1%, less than 0.5%, less than 0.1%, or less than 0.05%, such as, for example, 0.025%. In such instances, the dilution factor can be used to obtain the absorbance units for the original solution.

In certain embodiments, the denatured whey protein composition has a total concentration of monovalent metal cations of at least 25 mM or at least 30 mM. In some such embodiments, the concentration of monovalent metal cations in the denatured whey protein composition is from about 25 mM to about 200 mM, such as from about 30 mM to about 150 mM. Monovalent metal cations include Na⁺ and K⁺.

In certain embodiments, the denatured whey protein composition comprises less than about 10%, less than about 9%, less than about 8%, less than about 7%, less than about 6%, less than about 5%, less than about 4%, less than about 3%, less than about 2%, less than about 1%, or less than about 0.1% lactose by weight. In some such embodiments, the denatured whey protein composition has a lactose content of at most 10%, at most 8%, at most 6%, or at most 4% by weight.

In certain embodiments, the denatured whey protein composition has a whey protein to lactose ratio that is at least 10 to 1, at least 15 to 1, at least 20 to 1, at least 25 to 1, at least 30 to 1, at least 35 to 1, at least 40 to 1, at least 45 to 1, or at least 50 to 1.

In certain embodiments, the denatured whey protein composition has been treated, or is derived from a source (e.g., WPC) that has been treated, to reduce lactose concentration, such as by hydrolysis of lactose.

In certain embodiments, the denatured whey protein composition has a whey protein to carbohydrate ratio that is at least 10 to 1, at least 15 to 1, at least 20 to 1, at least 25 to 1, at least 30 to 1, at least 35 to 1, at least 40 to 1, at least 45 to 1, or at least 50 to 1.

In certain embodiments, the denatured whey protein composition comprises less than about 20%, less than about 15%, less than about 10%, less than about 9%, less than about 8%, less than about 7%, less than about 6%, less than about 5%, less than about 4%, less than about 3%, less than about 2%, less than about 1%, or less than about 0.1% fat by weight. In some such embodiments, the denatured whey protein composition has a fat content of at most 10%, at most 8%, at most 6%, or at most 4% by weight.

In certain embodiments, the denatured whey protein composition has a whey protein to fat ratio that is at least 4 to 1, at least 6 to 1, at least 8 to 1, at least 10 to 1, at least 12 to 1, at least 14 to 1, at least 16 to 1, at least 18 to 1, at least 20 to 1, at least 22 to 1, at least 24 to 1, at least 26 to 1, at least 28 to 1, or at least 30 to 1.

In certain embodiments, the denatured whey protein composition comprises less than about 12%, less than about 11%, less than about 10%, less than about 9%, less than about 8%, less than about 7%, less than about 6%, less than about 5%, or less than about 4% ash by weight. In some such embodiments, the denatured whey protein composition has an ash content of at most 10%, at most 8%, at most 6%, or at most 4% by weight.

In certain embodiments, the denatured whey protein composition has a whey protein to ash ratio that is at least 10 to 1, at least 12 to 1, at least 14 to 1, at least 16 to 1, at least 18 to 1, or at least 20 to 1.

In certain embodiments, the denatured whey protein composition comprises less than about 10%, less than about 9%, less than about 8%, less than about 7%, less than about 6%, less than about 5%, less than about 4%, less than about 3%, less than about 2%, less than about 1%, or less than about 0.1% casein by weight. In some such embodiments, the denatured whey protein composition has a casein content of at most 5%, at most 4%, at most 3%, at most 2%, or at most 1% by weight. In some such embodiments, the denatured whey protein composition is substantially free of casein.

In certain embodiments, the denatured whey protein composition has a whey protein to casein ratio that is at least 10 to 1, at least 15 to 1, at least 20 to 1, at least 25 to 1, at least 30 to 1, or at least 35 to 1.

Each feature of the denatured whey protein composition described herein may be combined with any other feature or features unless clearly indicated to the contrary. In particular, any feature indicated as being preferred or advantageous may be combined with any other feature or features indicated as being preferred or advantageous.

By way of example and not limitation, in certain embodiments, the denatured whey protein composition comprises microparticles comprising denatured whey protein and has a particle size distribution that is substantially stable following secondary heat treatment. The particle size distribution of the denatured whey protein compositions has some, and preferably all, of the following characteristics: at least 55% by volume of the particles have a diameter between about 0.2 μm and about 1.0 μm; less than 45% by volume of the particles have a diameter between about 1.0 μm and about 10.0 μm; a d₅₀ from about 0.5 to about 1.2 μm or from about 0.6 to about 1.0 μm; a d₉₀ from about 0.9 to about 1.7 μm or from about 1.1 to about 1.5 μm; a volume weighted mean diameter D(4,3) between about 0.6 to about 1.0 μm; and/or a substantially monomodal distribution such that at least 95% or at least 98% by volume of the particles have a diameter less than about 2.0 μm.

Following a primary particle growth test comprising heat treatment at 120 °C for 15 minutes (e.g., in an autoclave or oil bath), some, and preferably all, of the aforementioned particle size distribution characteristics remain substantially the same. For example, the d₅₀ of a 10% (w/w) protein content aqueous solution following the primary particle growth test is not more than about 1.0 μm and the do of the 10% (w/w) protein content aqueous solution following the primary particle growth test is not more than about 2.0 μm, not more than about 1.9 μm, or not more than about 1.8 μm. In some such embodiments, the d₅₀ of a 10% (w/w) protein content aqueous solution following the primary particle growth test is from about 0.6 to about 1.0 μm and the d₉₀ of the 10% (w/w) protein content aqueous solution following the primary particle growth test is from about 1.1 to about 1.5 μm.

In some such embodiments, the denatured whey protein composition has a particle size distribution that is substantially stable and exhibits minimal or essentially no primary particle size growth after heating a 10% (w/w) protein content aqueous solution (at pH 6.8) at 120 °C for 15 minutes and, further, has the following property or combination of properties:
(i) the denatured whey protein composition comprises 65% to 95%, 75% to 90%, or 80% to 85% by weight total protein on a dry weight basis;
(ii) residual denaturable whey protein in the denatured whey protein composition is less than 16%, less than 14%, or less than 12% and/or the denatured whey protein composition has an insolubility of at least 60% or at least 65%;
(iii) the ratio of covalent to non-covalent interactions in the microparticles is at least 2 to 1, at least 3 to 1, or at least 4 to 1 and/or at least 60%, at least 70%, or at least 80% of β-lactoglobulin is covalently cross-linked;
(iv) β-lactoglobulin is not more than 80% or not more than 75% of the total protein in the denatured whey protein composition;
(v) the denatured whey protein composition has a lactose content of at most 10%, at most 8%, at most 6%, or at most 4% by weight;
(vi) a fat content of at most 20%, at most 18%, at most 16%, at most 14%, at most 12%, at most 10%, at most 8%, at most 6%, or at most 4% by weight;
(vii) the denatured whey protein composition has an ash content of at most 10%, at most 8%, at most 6%, or at most 4% by weight;
(viii) the denatured whey protein composition has a casein content of at most 5%, at most 4%, at most 3%, at most 2%, or at most 1% by weight; or
(ix) a combination of any two or more of, or all of, (i) to (viii).

In certain embodiments, the denatured whey protein composition is heat-stable (e.g., a 10% (w/w) protein content aqueous solution exhibits an HCT of at least 3, at least 6, at least 9, or at least 12 minutes) and comprises microparticles comprising denatured whey protein, wherein at least 50%, at least 55%, or at least 60%, by volume of the microparticles have a diameter from about 0.1 μm to about 1.0 μm.

### C. WHEY PROTEIN SOURCE

The source of whey protein for the denatured whey protein compositions may be any source that provides one or more whey proteins, such as sweet whey or acid casein whey or milk whey (obtained from microfiltration of skim milk as the permeate phase) or a combination thereof. Exemplary sources of whey protein include, but are not limited to, rennet whey or cheese whey, lactic acid whey, mineral acid whey, casein whey and microfiltered skim milk whey. In certain embodiments, the source of the whey protein for the denatured whey protein compositions is whey protein concentrate (WPC) or whey protein isolate (WPI). Whey protein compositions, including WPC and WPI, may be derived from acid casein whey or cheese whey. Alternative sources of the whey protein for the denatured whey protein compositions included enriched compositions containing individual whey proteins (e.g., a β-lactoglobulin enriched composition or α-lactalbumin enriched composition).

WPC is rich in whey proteins, but also contains other components such as lipid, lactose, minerals/ash, and, in the case of cheese whey-based WPCs, glycomacropeptide (GMP), a casein-related non-globular protein that is non-denaturable. Typical methods of production of whey protein concentrate utilize membrane filtration.

WPCs are frequently described with the percent (w/w) as whey protein being appended to “WPC.” For example, WPC80 is a WPC with 80% by weight whey protein.

Whey proteins may originate from any mammalian animal species, such as, for example cows, sheep, goats, horses, buffalos, deer, and camels. Preferably, the whey protein is bovine.

In certain embodiments, denatured whey proteins can be obtained according to a process as specified according to U.S. Pat. No. 6,767,575 (Huss & Spiegel), US2006/0204643 (Merrill et al), U.S. Pat. No. 4,734,827 (Singer et al), U.S. Pat. No. 5,494,696 (Holst et al), US2012/0114795 (Havea et al; also published as WO 2010/120199), EP0412590 (Hakkaart et al), and U.S. Pat. No. 5,188,842 (Visser et al; also published as EP0347237). Each method of making a denatured whey protein ingredient would impart different properties so anyone using this invention should select the protein ingredient to best suit their process.

In certain embodiments, the whey protein source is available as a powder, preferably a WPC or WPI powder.

The denatured whey protein compositions may be prepared from a mixture of cheese and/or acid WPCs and/or WPIs or from a mixture of proteins. In certain embodiments, the whey protein source is or comprises WPC and/or WPI. In certain embodiments, the whey protein source is or comprises a blend of a WPC and/or WPI and, optionally, one or more ingredients comprising whey and/or non-whey protein.

In certain embodiments, the whey protein source is cheese whey or a WPC prepared from cheese whey. In some such embodiments, a coloring agent is employed during the cheese making process. For example, cheese manufacturers may use annatto to provide an orange-yellow color for colored cheeses, such as cheddar, Leicester, Gloucester, etc. Annatto coloring agents are derived from the seeds of Bixa orellana (achiote), a shrub native to Central America. The seeds contain carotenoid pigments, including bixin, norbixin, and orelline. In some such embodiments, the whey protein source comprises a coloring agent.

### D. METHOD OF MANUFACTURE

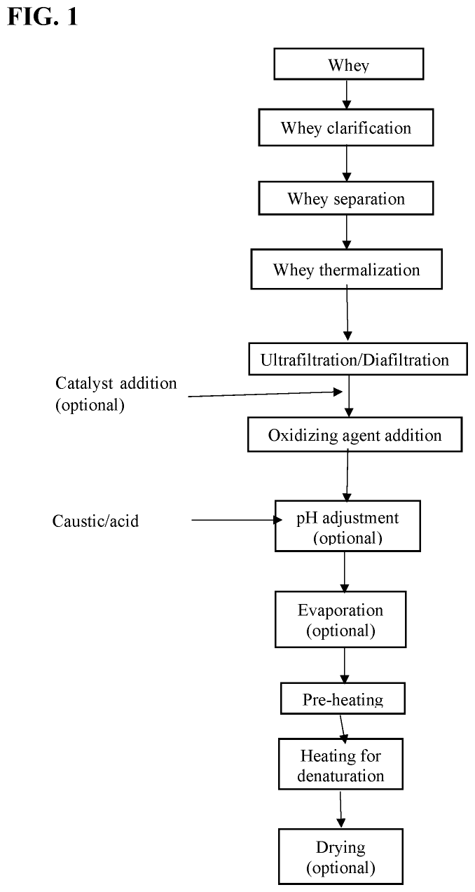

In at least one aspect, this disclosure provides methods for manufacturing denatured whey protein compositions. An exemplary method for manufacturing denatured whey protein compositions is described below and shown in FIG. 1. Suitable alterations to the method that achieve the denatured whey protein compositions described herein will be apparent to those skilled in the art.

In certain embodiments, the method comprises (a) providing an aqueous whey protein solution or a whey protein retentate; (b) contacting the aqueous whey protein solution or the whey protein retentate with an oxidizing agent; and (c) subjecting the whey protein solution or the whey protein retentate to a heat treatment under conditions that allow for desired protein denaturation to occur, wherein the total protein content of the aqueous whey protein solution or whey protein retentate is preferably at least 16% (w/w). In some such embodiments, the denaturing heat treatment is performed at a temperature above 70 °C under conditions of mechanical shear and/or turbulent flow, as known in the art.

In certain embodiments, the oxidizing agent is a peroxide, such as hydrogen peroxide, and step (b) comprises contacting the aqueous whey protein solution or the whey protein retentate with the peroxide in combination with a peroxidase enzyme.

In certain embodiments, the amount of oxidizing agent is less than 300 ppm, such as from about 5 to about 250 ppm, such as from about 5 to about 200 ppm or from about 10 to about 150 ppm or from about 20 to about 120 ppm; from about 10 to about 200 ppm, such as from about 40 to about 190 ppm or from about 140 ppm to about 190 ppm; or from about 20 to about 220 ppm, such as from about 20 to about 120 ppm or from about 30 to about 100 ppm.

In certain embodiments, the amount of oxidizing agent is less than 1200×10⁻⁶ kg/kg of whey protein, such as from about 20×10⁻⁶ kg/kg of whey protein to about 900×10⁻⁶ kg/kg of whey protein, from about 40×10⁻⁶ kg/kg of whey protein to about 800×10⁻⁶ kg/kg of whey protein, or from about 60×10⁻⁶ kg/kg of whey protein to about 700×10⁻⁶ kg/kg of whey protein, such as from about 80×10⁻⁶ kg/kg of whey protein to about 600×10⁻⁶ kg/kg of whey protein, such as from about 100×10⁻⁶ kg/kg of whey protein to about 400×10⁻⁶ kg/kg of whey protein.

In certain embodiments, the amount of oxidizing agent is less than 2000×10⁻⁶ kg/kg of denaturable whey protein, such as from about 30×10⁻⁶ kg/kg of denaturable whey protein to about 1400×10⁻⁶ kg/kg of denaturable whey protein, from about 60×10⁻⁶ kg/kg of denaturable whey protein to about 1200×10⁻⁶ kg/kg of denaturable whey protein, or from about 90×10⁻⁶ kg/kg of denaturable whey protein to about 1000×10⁻⁶ kg/kg of denaturable whey protein, such as from about 120×10⁻⁶ kg/kg of denaturable whey protein to about 800×10⁻⁶ kg/kg of denaturable whey protein, such as from about 150×10⁻⁶ kg/kg of denaturable whey protein to about 600×10⁻⁶ kg/kg of denaturable whey protein.

In certain embodiments, the amount of oxidizing agent is less than 2400×10⁻⁶ kg/kg of β-lactoglobulin protein, such as from about 40×10⁻⁶ kg/kg of β-lactoglobulin protein to about 1800×10⁻⁶ kg/kg of β-lactoglobulin protein, from about 80×10⁻⁶ kg/kg of β-lactoglobulin protein to about 1600×10⁻⁶ kg/kg of β-lactoglobulin protein, or from about 120×10⁻⁶ kg/kg of β-lactoglobulin protein to about 1400×10⁻⁶ kg/kg of β-lactoglobulin protein, such as from about 160×10⁻⁶ kg/kg of β-lactoglobulin protein to about 1200×10⁻⁶ kg/kg of β-lactoglobulin protein, such as from about 200×10⁻⁶ kg/kg of β-lactoglobulin protein to about 800×10⁻⁶ kg/kg of β-lactoglobulin protein.

In certain embodiments, the mole ratio of oxidizing agent to β-lactoglobulin protein is less than 2, such as from about 0.04 to about 1.8, from about 0.08 to about 1.5, from about 0.12 to about 1.2, from about 0.16 to about 0.9, from about 0.2 to about 0.7, from about 0.24 to about 0.6, from about 0.28 to about 0.5.

In some such embodiments, the aqueous whey protein solution or the whey protein retentate comprises a whey protein source such as WPC and/or WPI. In some such embodiments, the whey protein source comprises a coloring agent.

In certain embodiments, the oxidizing agent is a peroxide, such as hydrogen peroxide, and step (b) comprises contacting the aqueous whey protein solution or the whey protein retentate with the peroxide in combination with a peroxidase enzyme.

In certain embodiments, the amount of oxidizing agent is added in one step. More preferably and to avoid catalyst inhibition and inactivation, the total amount of peroxide is added in more than one step, for example in 2, 3, 4, 5 or more steps. More preferably the amount of peroxide is added continuously. The skilled person in the art can determine the optimum oxidizing agent addition rate as a function of catalyst/enzyme activity and protein concentration in whey solution.

In certain embodiments, the oxidizing agent is optionally inactivated, removed, or consumed prior to step (c) and, therefore, the aqueous whey protein solution or the whey protein retentate may be substantially free of the oxidizing agent during the heat treatment of step (c). In certain embodiments, the aqueous whey protein solution or the whey protein retentate is substantially free of the oxidizing agent during the heat treatment of step (c) where no active steps are taken to inactivate, remove, or consume the oxidizing agent. For example, the oxidizing agent may be present in an amount (e.g., <10 ppm) such that removal or consumption of the oxidizing agent is not desirable.

In certain embodiments, the denaturing heat treatment step is performed at a temperature above 70 °C performed under conditions of high shear stress/force which can be generated by increasing serum viscosity, or wall shear rate, or changing flow pattern to turbulent flow or applying mechanical shear or combination thereof.

In one exemplary embodiment, and as shown in FIG. 1, the method comprises providing a source of whey proteins, such as cheese whey; clarifying, separating, and/or thermalizing (pasteurizing) the cheese whey to produce a whey protein solution; subjecting the whey protein solution to ultrafiltration and/or diafiltration to produce a whey protein retentate; contacting the retentate with an oxidizing agent (e.g., hydrogen peroxide and, optionally, in combination with a peroxidase enzyme); and subjecting the whey protein retentate to a heat treatment step (preferably, when no detectable oxidizing agent is left) that allows protein denaturation to occur.

As shown in FIG. 1, cheese whey collected after cheese manufacturing is clarified, and thermalized (pasteurized) to provide microbial control and also to deactivate any of the remaining rennet enzyme and starter cultures from cheese making.

General conditions for thermalization (pasteurization) are known in the art and include, but are not limited to, about 63 °C (about 145 °F) for 30 minutes (also referred to the batch holding method), about 72 °C (about 161 °F) for 15 seconds (also referred to the high temperature short time (HTST) method), about 89 °C (about 192 °F) for 1 second, or any alternative thermal and non-thermal treatments that have a bactericidal effect equivalent to the above treatments.

As shown in FIG. 1, the whey protein solution is subjected to microfiltration and/or ultrafiltration, optionally with diafiltration to obtain a retentate. In certain embodiments, the whey protein retentate has a total solids (TS) content from about 10% to about 40%. In some such embodiments, the whey protein retentate has a TS content from about 13% to about 38%, from about 18% to about 33%, or from about 23% to about 28%. In some such embodiments, the whey protein retentate has a TS content of at least 18%, at least 20%, at least 22%, or at least 24%.

In certain embodiments, the filtration step is run to provide a retentate having from about 65% to about 95% total protein by weight. In some such embodiments, the total protein content of the whey protein retentate is from about 75% to about 90% or from about 80% to about 85% by weight. In some such embodiments, the total protein content of the whey protein retentate is at least 65%, at least 70%, at least 75%, or at least 80% by weight.

At this stage, and particularly during thermalization, it may be desirable to ensure that the whey protein solution and/or the whey protein retentate remains substantially undenatured (e.g., less than 10% denatured). Without wishing to be bound by theory, the uncontrolled formation of denatured aggregates may cause formation of larger than desired aggregates during the heat-denaturation step.

In some such embodiments, the whey protein solution and/or the whey protein retentate have a low level of denaturation prior to the denaturing heat treatment step. For example, the denaturation level of the whey protein solution and/or the whey protein retentate prior to the denaturing heat treatment step can be less than 10%, such as from about 3% to about 8%. Alternatively, the denaturation level of the whey protein solution and/or the whey protein retentate prior to the denaturing heat treatment step can be less than 9%, less than 8%, less than 7%, less than 6%, or less than 5%. In some such embodiments, the denaturation level of the whey protein solution and/or the whey protein retentate prior to the denaturing heat treatment step is about 5%, about 4%, about 3%, about 2%, or about 1%.

As shown in FIG. 1, the retentate (and/or the whey protein solution) is contacted with an oxidizing agent. It should be understood that the timing of treating the whey protein stream with the oxidizing agent may be varied. For example, a dilute whey protein composition (i.e., prior to UF/DF) is contacted with the oxidizing agent.

In some such embodiments, the oxidizing agent is any food grade oxidizing agent. In some such embodiments, the oxidizing agent is oxygen (O₂), ozone, a peroxide including an alkyl hydroperoxide, superoxide, peroxynitrite, peroxydisulfuric acid, or lactoperoxidase.

In some such embodiments, the oxidizing agent is a peroxide, preferably an organic peroxide. Exemplary peroxides include, but are not limited to, a metal peroxide (e.g., an alkali metal peroxide such as sodium peroxide; an alkaline earth metal peroxide such as magnesium peroxide, or calcium peroxide; or a transition metal peroxide such as zinc peroxide), hydrogen peroxide, and benzoyl peroxide. In some such embodiments, the oxidizing agent is a perborate such as sodium perborate.

In some such embodiments, the oxidizing agent is benzoyl peroxide or hydrogen peroxide. Hydrogen peroxide can be obtained in various concentrations and purities. In one embodiment, the hydrogen peroxide is food grade.

In some such embodiments, the oxidizing agent is employed with a catalyst, which may be either an enzymatic catalyst or a chemical catalyst. In some such embodiments, the oxidizing agent is employed with a catalyst enzyme such as for example, a microbial peroxidase enzyme. An exemplary fungal peroxidase enzyme is MaxiBright® (DSM Food Specialties). Other exemplary microbial peroxidase enzymes include Dye-decolorizing (DyP-type) peroxidases such as EfeB/YcdB from Escherichia coli O157, DyPB from Rhodococcus jostii RHA1; and DyP2 from Amycolatopsis sp. 75iv2. Exemplary chemical catalysts include, but are not limited to, copper, iron, zinc, or manganese.

In some such embodiments, the oxidizing agent is added over a period of time. For example, an initial amount of oxidizing agent may be added and then subsequent amount(s) of oxidizing agent may be added as the initial amount is consumed. As such, the total amount of peroxide can be added in more than one step, for example in 2, 3, 4, 5 or more steps or added continuously over a period of time.

Exemplary oxidizing agents, including hydrogen peroxide, have been previously employed by the dairy industry to bleach whey.

Hydrogen peroxide (H₂O₂) is a clear, colorless liquid with a slightly pungent odor. Hydrogen peroxide is one of the two bleaching agents currently approved for bleaching whey in the United States to decolor whey compositions prepared from cheese containing annatto.

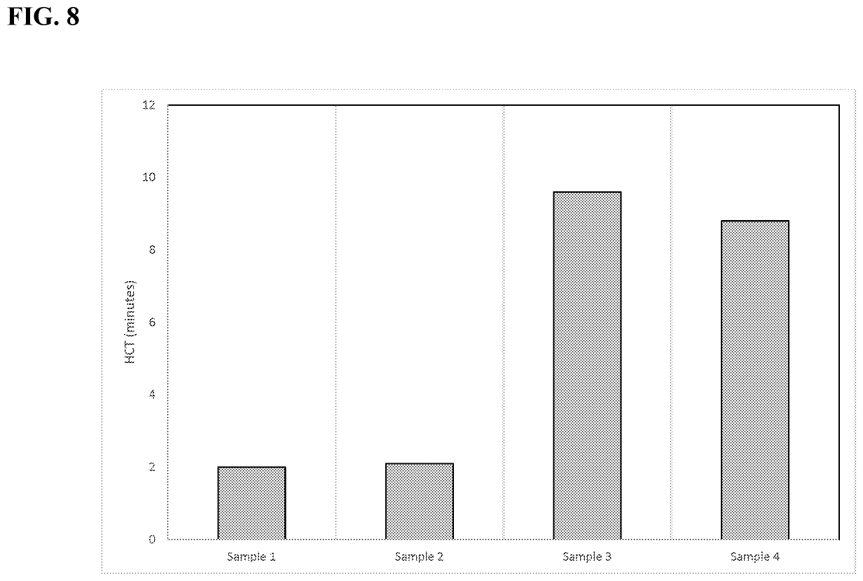

Previous reports provide contradictory information regarding the effects of hydrogen peroxide on whey protein denaturation. For example, Kramer et al., J. Agric. Food Chem, 65, 10258-10269 (2017) reported that when low levels of hydrogen peroxide (e.g., 500 μM, i.e., 5:1 molar ratio compared to the protein) were present during the heating stage, enhanced aggregation of β-lactoglobulin (β-Lg) alone and of mixtures of β-Lg and α-lactalbumin (α-La) was observed. Likewise, Kang et al., J. Dairy Sci., 93, 3891-3901 (2010) reported that concentrations of hydrogen peroxide above the legal limit (500 ppm) increased the amount of whey protein denaturation. On the other hand, there are several reports that hydrogen peroxide decreased denaturation of whey protein (see, e.g., Fish and Mickelsen, Journal of Dairy Science, 50 (7), 1045-1048 (1967), noting that treating skim milk with hydrogen peroxide before being forewarmed at 89 °C for 30 minutes reduced the denaturation of acid whey proteins; Sutariya and Patel, Food Chemistry, 223, 114-120 (2017), suggesting that addition of hydrogen peroxide to a whey protein isolate prevented whey protein denaturation and aggregation; see also US2016/0235082, FIG. 8). Moreover, Bechtle (U.S. Pat. No. 3,818,109) reported that a combination of mild heat (e.g., temperatures of from 60 °C to 70 °C) and hydrogen peroxide treatment avoided any appreciable denaturation of the whey protein while achieving sterilization of the medium. Notably, these reports appear to describe application of heat to a hydrogen peroxide-containing sample.

On the other hand, in certain embodiments, the methods for manufacturing denatured whey protein compositions disclosed herein provide for removing or consuming the oxidizing agent prior to the denaturing heat treatment step. Thus, in some such embodiments, the oxidizing agent is consumed prior to subjecting the aqueous whey protein solution or the whey protein retentate to a denaturing heat treatment step under conditions that allow for protein denaturation to occur. Thus, the aqueous whey protein solution or the whey protein retentate may be substantially free of the oxidizing agent during the denaturing heat treatment step.

In certain embodiments, the oxidizing agent is employed with a catalyst enzyme such as for example, a microbial peroxidase enzyme and the quantities of the oxidizing agent and peroxidase enzyme are such that the oxidizing agent is completely used up by the enzyme. Alternatively, when the oxidizing agent is hydrogen peroxide, a catalase enzyme may be used to catalyze the decomposition of hydrogen peroxide to water and oxygen. In certain embodiments, a catalase enzyme is not employed.

The aqueous whey protein solution or the whey protein retentate may be sampled to confirm that it is substantially free of the oxidizing agent. As an example, the aqueous whey protein solution or the whey protein retentate may be sampled and tested for detectable peroxide using a colometric test strip available from Merck/MilliporeSigma.

In some such embodiments, the method further comprises adjusting the pH of the aqueous whey protein solution or the whey protein retentate prior to the denaturing heat treatment step. In some such embodiments, the pH of the aqueous whey protein solution or the whey protein retentate prior to the denaturing heat treatment step is at least 5.6, at least 5.8, at least 6.0, or at least 6.2. In some such embodiments, the pH of the aqueous whey protein solution or the whey protein retentate prior to the denaturing heat treatment step is from about 5.8 to about 7.0, from about 6.0 to about 6.8, or from about 6.2 to about 6.6.

As shown in FIG. 1, the whey protein solution or the whey protein retentate is subjected to a heat treatment. Heat treatment is applied to impart the required denaturation.

In certain embodiments, the denaturing heat treatment step comprises heating the aqueous whey protein solution or the whey protein retentate to more than about 70 °C while under conditions of high wall shear rate even under laminar flow, for example with a wall shear rate of at least 1000 s⁻¹. In some such embodiments, the wall shear rate is from about 1000 s⁻¹ to about 10000 s⁻¹, or from about 1500 s⁻¹ to about 5000 s⁻¹, or from about 1500 s⁻¹ to about 4000 s⁻¹ or from about 2000 s⁻¹ to about 3000 s⁻¹.

In certain embodiments, the denaturing heat treatment step comprises heating the aqueous whey protein solution or the whey protein retentate to more than about 70 °C while under conditions of turbulent flow, for example with a Reynolds number of at least 2000. In some such embodiments, the Reynolds number is from about 2000 to about 20,000, from about 2000 to about 10,000, or from about 2000 to about 5000. In some such embodiments, the Reynolds number is from about 2000 to about 2500 or from about 2100 to about 2300.

Turbulent flow is defined as having sufficient mass flow rate in the heating tubes to provide a Reynolds number, referred to as Re, of at least 2000. Such Reynolds numbers are a characteristic of turbulent flow and are known in the art of hydrodynamics. The determination of Re depends on the mass velocity of the fluid and its highest viscosity at the target heating temperature, which is defined as the nominal viscosity determined using the Hagen-Poiseuille equation from a measurement of the pressure drop along a known length of horizontal pipe of known uniform circular cross section at a known flowrate of the heat treated fluid at a uniform temperature before it is dried. To calculate Re for a given process, formula for Newtonian fluids can be used subject to using the highest viscosity of heat treated fluid at the target temperature. This implies Re at all the other viscosities (i.e., lower viscosities) would be higher and would fall in the turbulent zone.

In certain embodiments, the denaturing heat treatment step comprises heating the aqueous whey protein solution or the whey protein retentate to more than about 50 °C combined with mechanical shear. In some such embodiments, a homogenizer, colloid mill, high pressure pump, scraped surface heat exchanger, high shear mixer or the like is used to mix the solution or break down the aggregates upon or after formation.

In certain embodiments, the denaturing heat treatment step comprises heating the aqueous whey protein solution or the whey protein retentate to a temperature from about 70 °C to about 90 °C at pH 6 to pH 7 while under conditions of high enough shear stress/force resulted from increasing serum viscosity, high wall shear rate, turbulent flow, mechanical shear or a combination of two or more. In some such embodiments, the denaturing heat treatment step comprises heating the aqueous whey protein solution or the whey protein retentate to a temperature from about 80 °C to about 85 °C at pH 6.3 to pH 6.7 while under conditions of high enough shear stress/force resulted from increasing serum viscosity, high wall shear rate, turbulent flow, mechanical shear or combination of two or more.

Known factors such as heating temperature and pH may impact protein aggregation. However, as reported herein, variations within the established ranges for temperature and pH did not dramatically impact particle size indicating that the methods disclosed herein are robust and reproducible.

In certain embodiments, the aqueous whey protein solution or the whey protein retentate is substantially free of the oxidizing agent during the heat treatment step that allows protein denaturation to occur. For example, the oxidizing agent may be inactivated, consumed, and/or removed prior to the heat treatment step.

One of the major mechanisms of protein aggregation is considered to be the formation of intermolecular disulfide involving sulfhydryl-disulfide interchange. Without wishing to be bound by theory, it is believed that the pretreatment with the oxidizing agent influences the aggregation pathway and reaction kinetics via promoting the intermolecular sulfhydryl-disulfide interchange. Without wishing to be bound by theory, it is believed that the microparticles disclosed herein are predominantly disulphide bonded with low levels of thiols. Additionally or independently, limiting pre-denaturation of the whey protein (the level of denaturation prior to the denaturing heat treatment step) may also enable formation of small particles.

Following the denaturing heat treatment step, the denatured whey protein composition may be dried or, alternatively, the denatured whey protein composition may be used directly for preparation of high protein products without drying.

In certain embodiments, the denatured whey protein composition is not subjected to a particle size reduction or a particle size selection procedure such as further microfiltration to achieve the particle size distribution(s) described herein.

### E. APPLICATIONS AND METHODS OF USE

In at least one aspect, this disclosure provides an ingredient used in the preparation of an edible consumer product, a beverage, or a liquid nutritional composition such as a medical food. In some such embodiments, the ingredient is provided in liquid or dry (powder) form, or a blend thereof.

Examples of suitable edible consumer products include, but are not limited to, baked products (e.g., muffins, cookies, brownies, etc.), puffed and/or extruded snack products, protein-fortified snacks, confectionary products including chocolate, gels, ice creams, caramel, snack bars, spreads, sauces, dips, dairy products including drinking yoghurt (including ambient yoghurt), stirred yoghurt, and cheese, food additives such as protein sprinkles, and dietary supplement products including daily tablets.

An exemplary edible consumer product is a solid, set gel, such as a set yoghurt. A set yoghurt prepared using the denatured whey protein composition provided herein may exhibit reduced firmness compared to a control yoghurt having the same ingredient composition and protein content except that the control yoghurt does not comprise a denatured whey protein composition provided herein.

Another exemplary edible consumer product is a semi-solid food product, such as a stirred yoghurt. A stirred yoghurt prepared using the denatured whey protein composition provided herein may exhibit reduced viscosity compared to a control yoghurt having the same ingredient composition and protein content except that the control yoghurt does not comprise a denatured whey protein composition provided herein.

In certain embodiments, the set or stirred yoghurt exhibits reduced in-mouth texture (or reduced grittiness) and/or exhibits a negligible or no increase in undesirable flavours compared to the appropriate control yoghurt.

Examples of suitable beverages include, but are not limited to, cultured and ready-to-drink (RTD) beverages as well as aqueous liquids (e.g., concentrates) that may be diluted and powders that may be reconstituted to provide such beverages. In certain embodiments, the beverage is a drinking yoghurt (including an ambient drinking yoghurt), a milk, a milk powder, a sports supplement including dairy and non-dairy based sports supplements, a fruit juice, or a formula such as infant formula, follow-on formula, or growing-up formula, in powder or liquid form. In certain embodiments, the beverage is a neutral high protein beverage. In certain embodiments, the beverage is an acidic high protein beverage.

An exemplary beverage is a drinking yoghurt. A drinking yoghurt is a fermented diary beverage having a low viscosity. A drinking yoghurt may be an ambient drinking yoghurt.

Another exemplary beverage is a sports beverage. A sports beverage typically comprises a high content of protein, has a low-fat content and has added vitamins and minerals, flavours, sweeteners, stabilisers, and/or salt.

In certain embodiments, the denatured whey protein composition disclosed herein is used as an ingredient in the preparation of a nutritional composition, preferably a liquid nutritional composition (e.g., a medical food). By way of example only, U.S. federal law and the Food and Drug Administration regulations define medical food as, “a food which is formulated to be consumed or administered enterally under the supervision of a physician and which is intended for the specific dietary management of a disease or condition for which distinctive nutritional requirements, based on recognized scientific principles, are established by medical evaluation” (§ 5(b) of the 1988 Orphan Drug Act (21 U.S.C. 360ee(b)(3)) and FDA regulation 21 CFR 101.9(j)(8)). In some such embodiments, the liquid nutritional composition further comprises a fat and/or a carbohydrate component.

In certain embodiments, the denatured whey protein composition disclosed herein is formulated into a nutritional composition by wet blending. In some such embodiments, the nutritional composition is a wet blended nutritional composition, for example a wet blended meal replacement composition or a wet blended infant formula.

The denatured whey protein composition disclosed herein may be useful in the manufacture of powdered or ready-to-mix compositions, particularly wet blended compositions, wet blended meal replacement compositions, and/or wet blended infant formula. Wet blended compositions are compositions that have been prepared using a wet blending step, in which two or more ingredients are combined as an aqueous solution, and optionally subsequently dried to a powder. Wet blending may be required, for example, for ready-to-mix nutritional compositions that need a wet blending step to incorporate a fat source into the composition.

The denatured whey protein composition disclosed herein are particularly useful in wet blended applications, as the low viscosity of the compositions may enable a high total solids content to be achieved during evaporation. When the solids content during the evaporation step is high, less water must be removed during spray drying, with a corresponding reduction in energy usage. Additionally, the heat stability of the denatured whey protein composition disclosed herein may reduce line fouling during evaporation and drying, with corresponding reductions in production downtime, and increases in plant throughput and product yields.

Methods for preparing wet blended compositions are known to those skilled in the art. Briefly, methods for preparing wet blended compositions may comprise the step of combining two or more ingredients to form an aqueous solution. The aqueous solution may optionally be subjected to one or more additional steps, such as homogenisation, standardisation, heat treatment (for example pasteurisation and/or UHT treatment), homogenisation, evaporation, and/or spray drying. The aqueous solution may comprise a heat stable protein composition of the invention and one or more additional ingredients, optionally selected from one or more lipids, one or more carbohydrates, one or more additional ingredients as described herein, or any combination of these.

In at least one aspect, this disclosure provides a method for providing nutritional support to a subject comprising enterally administering to the subject a nutritional composition comprising the denatured whey protein composition disclosed herein. In certain embodiments, the subject is a subject in need of nutritional support. Thus, nutritional compositions described herein are for use in a method for providing nutritional support to a subject in need thereof. In some such embodiments, the subject is a human. In some such embodiments, the subject is a human infant or toddler. In other such embodiments, the subject is a human adult. In some such embodiments, the subject is a pregnant female. The enteral administration may be orally or via a tube (e.g., naso-gastric feeding or gastric feeding).

In certain embodiments, the nutritional composition is administered enterally to a subject maintain or increase muscle protein synthesis, maintain or increase muscle mass, prevent or increase loss of muscle mass, maintain or increase growth, prevent or decrease muscle catabolism, prevent or treat cachexia, prevent or treat sarcopenia, increase rate of glycogen resynthesis, modulate blood sugar levels, increase insulin response to raised blood glucose concentration, reduce satiety, reduce satiation, increase food intake, increase calorie intake, improve glucose metabolism, increase rate of recovery following surgery, increasing prehabilitation efficacy prior to surgery or chemotherapy, increase rate of recovery following injury, increase rate of recovery following exercise, increase sports performance, and/or provide nutrition. The enteral administration may be orally or via a tube (e.g., naso-gastric feeding or gastric feeding).

In certain embodiments, the nutritional composition comprising the denatured whey protein composition disclosed herein is for use to maintain or increase muscle protein synthesis, maintain or increase muscle mass, prevent or increase loss of muscle mass, maintain or increase growth, prevent or decrease muscle catabolism, prevent or treat cachexia, prevent or treat sarcopenia, increase rate of glycogen resynthesis, modulate blood sugar levels, increase insulin response to raised blood glucose concentration, reduce satiety, reduce satiation, increase food intake, increase calorie intake, improve glucose metabolism, increase rate of recovery following surgery, increasing prehabilitation efficacy prior to surgery or chemotherapy, increase rate of recovery following injury, increase rate of recovery following exercise, increase sports performance, and/or provide nutrition.

### F. HIGH PROTEIN LIQUID COMPOSITIONS

In at least one aspect, this disclosure provides a high protein liquid composition comprising denatured whey protein. The high protein liquid composition can be an acidic or neutral pH composition including a neutral pH high protein beverage, or an acidic high protein beverage or a drinking yoghurt or an acidic or neutral pH liquid nutritional composition, each of which are discussed in further detail herein. In certain embodiments, the high protein liquid composition comprises at least 6% (w/v) denatured whey protein. In some such embodiments, the high protein liquid composition comprises at least 7% (w/v), at least 8% (w/v), at least 9% (w/v), at least 10% (w/v), at least 11% (w/v), at least 12% (w/v), at least 13% (w/v), at least 14% (w/v), at least 15% (w/v), at least 16% (w/v), at least 17% (w/v), at least 18% (w/v), at least 19% (w/v), at least 20% (w/v), at least 21% (w/v), at least 22% (w/v) denatured whey protein. In some such embodiments, the liquid composition comprises from 6% to 30% (w/v) denatured whey protein, such as from 7% to 28% (w/v) denatured whey protein, from 8% to 26% (w/v) denatured whey protein, or from 10% to 24% (w/v) denatured whey protein.

In certain embodiments, at least 50%, at least 60%, at least 70%, at least 80%, at least 85%, at least 90%, or at least 95% of the total protein in the high protein liquid composition is denatured whey protein. In some such embodiments substantially all of the total protein in the high protein liquid composition is denatured whey protein. In other such embodiments, the high protein liquid composition comprises other dairy proteins and/or non-dairy proteins. In other such embodiments, the high protein liquid composition comprises whey protein from two or more sources, such as a heat-denatured whey protein composition, a non-denatured whey protein composition, a whey protein hydrolysate, or an ingredient comprising both whey and casein (such as an MPC), the total whey protein in the composition is the sum of the total whey protein present in the heat-denatured whey protein composition, the non-denatured whey protein composition, the whey protein hydrolysate, and/or the MPC.

In certain embodiments, the high protein liquid composition comprises at least 5%, at least 10%, at least 15%, or at least 20% (w/v) total protein. The total protein in the liquid composition is the sum of all protein contributed by all protein-containing ingredients in the composition. For example, in embodiments where the liquid composition comprises a heat-denatured whey protein composition as well other non-dairy and/or dairy proteins derived from, for example, skim milk powder (SMP) or milk protein concentrate (MPC), the total protein in the liquid composition is the sum of the total protein present in the heat-denatured whey protein composition and the SMP and/or MPC. In some such embodiments, the liquid composition comprises at least 7% (w/v), at least 8% (w/v), at least 9% (w/v), at least 10% (w/v), at least 11% (w/v), at least 12% (w/v), at least 13% (w/v), at least 14% (w/v), at least 15% (w/v), at least 16% (w/v), at least 17% (w/v), at least 18% (w/v), at least 19% (w/v), at least 20% (w/v), at least 21% (w/v), at least 22% (w/v) total protein. In some such embodiments, the liquid composition comprises from 6% to 30% (w/v) total protein, such as from 7% to 28% (w/v) total protein, from 8% to 26% (w/v) total protein or from 10% to 24% (w/v) total protein. In some such embodiments, the high protein liquid composition comprises 10% (w/v), 11% (w/v), 12% (w/v), 13% (w/v), 14% (w/v), 15% (w/v), 16% (w/v), 17% (w/v), 18% (w/v), 19% (w/v), 20% (w/v), 21% (w/v), or 22% (w/v) total protein.

In certain embodiments, less than about 5%, less than about 4%, less than about 3%, less than about 2%, less than about 1%, or less than about 0.1% of the total protein in the high protein liquid composition is casein. In some such embodiments, at most 5%, at most 4%, at most 3%, at most 2%, at most 1%, or at most 0.1% of the total protein in the high protein liquid composition is casein. In some such embodiments, the high protein liquid composition is substantially free of casein. In certain embodiments, the high protein liquid composition comprises not more than 12% (w/v) total protein, such as 5% (w/v), 6% (w/v), 7% (w/v), 8% (w/v), 9% (w/v), 10% (w/v), or 11% (w/v) total protein. In some such embodiments, at least 90% or at least 95% of all of the total protein in the high protein liquid composition is denatured whey protein. In some such embodiments substantially all of the total protein in the high protein liquid composition is denatured whey protein.

In certain embodiments, the high protein liquid composition comprises at least 12% (w/v) total protein, such as 12% (w/v), 13% (w/v), 14% (w/v), 15% (w/v), 16% (w/v), 17% (w/v), 18% (w/v), 19% (w/v), or 20% (w/v) total protein. In some such embodiments, the high protein liquid composition comprises 12% to 18% (w/v) total protein. In some such embodiments, at least 90% or at least 95% of all of the total protein in the high protein liquid composition is denatured whey protein. In some such embodiments substantially all of the total protein in the high protein liquid composition is denatured whey protein.

In certain embodiments, the mean particle size (characterized by D(4,3)) of the high protein liquid composition after sterilization or pasteurization is less than 5 μm, less than 4 μm, less than 3 μm, less than 2 μm, or less than 1 μm. In some such embodiments, the mean particle size (characterized by D(4,3)) of a high protein liquid composition comprising from 7% to 25% (w/v) total protein is from about 0.1 μm to about 5 μm or from about 0.5 μm to about 3 μm, preferably about 1 μm. In some such embodiments, the mean particle size (characterized by D(4,3)) of a high protein liquid composition comprising from 9% to 20% (w/v) total protein is less than 1 μm.

In certain embodiments, the liquid composition has been sterilized and/or pasteurized in a manner suitable for commercial applications. In some such embodiments, the sterilization and/or pasteurization comprises a thermal (i.e., heat) treatment. In other such embodiments, the sterilization and/or pasteurization comprises a non-thermal treatment. Exemplary techniques for sterilization and/or pasteurization include, but are not limited to, high temperature pasteurization, ultra-high temperature (UHT) treatment and retort heat treatment. In some such embodiments, the particle size distribution of the liquid composition after such sterilization or pasteurization comprises a D(4,3) less than 1 μm, a d₅₀ less than 1 μm, and a d₉₀ less than 5 μm. In some such embodiments, the particle size distribution of the liquid composition after such sterilization or pasteurization comprises a D(4,3) less than 1 μm, a d₅₀ less than 1 μm, and a d₉₀ less than 3 μm.

The lethal effect of high temperatures on microorganisms is dependent on both temperature and holding time, and the reduction in time required to kill the same number of microorganisms as temperature is increased is well known. The time taken to reduce initial microbial numbers, at a specified temperature, by a particular amount, is commonly referred to as an “F value.” The F₀ value is the equivalent time in minutes for the specified temperature that gives the same thermal lethality as at 121 °C. As is known in the relevant art, acidic products generally require a lower F₀ value to achieve commercial sterility than products processed at neutral pH.

In certain embodiments, the liquid composition is shelf-stable following sterilization and/or pasteurization. In some such embodiments, the liquid composition exhibits minimal or essentially no sedimentation, gelation, or aggregation and negligible bacterial growth when packaged aseptically after prolonged storage at a temperature from about 20 °C to about 25 °C for at least 2 months, at least 3 months, at least 6 months or at least 12 months. In some such embodiments, the liquid composition exhibits minimal or essentially no powderiness or grittiness. Thus, for example, the liquid composition may be a heat-treated, shelf-stable liquid composition.

In certain embodiments, the liquid composition exhibits minimal or essentially no sedimentation under conditions amenable to sedimentation.

In certain embodiments, the high protein liquid composition includes non-whey and/or non-dairy protein in addition to the denatured whey protein. Exemplary sources of non-whey protein include, but are not limited to, skim milk powder (SMP) or whole milk powder or milk protein concentrate (MPC), or milk protein isolate (MPI) or micellar casein concentrate (MCC). As another example, casein may be included in the form of sodium caseinate or potassium caseinate or calcium caseinate or magnesium caseinate to the high protein liquid composition.

In certain embodiments, the high protein liquid composition comprises one or more, two or more, or three or more non-dairy proteins. Suitable non-dairy proteins for inclusion in the liquid composition include algal proteins, fungal proteins (e.g., mycoprotein), plant proteins, and animal proteins, and hydrolyzed forms thereof. In some such embodiments, the liquid composition comprises soy protein, rice protein, and/or pea protein.

Additionally, the high protein liquid composition may comprise whey protein from two or more sources. For example, the liquid composition may comprise a mixture of WPC and WPI, one or both of which has been heat-denatured. As another example, the liquid composition may comprise a mixture of WPCs made in different ways or having different properties.

In addition to the methods disclosed herein, exemplary methods for preparing a heat-denatured whey protein composition suitable for use in a liquid composition are provided in PCT International Application PCT/NZ2007/000059 (published as WO2007/108709) and PCT/NZ2010/000072 (published as WO2010/120199) and PCT International Application PCT/IB2012/056103 (published as WO2013/065014), each incorporated by reference herein in their entirety.

In certain embodiments, one or more of the protein ingredients, for example the heat-denatured whey protein composition, or the high protein liquid composition may be treated to reduce lactose content. In some such embodiments, the protein ingredient or high protein liquid composition is treated with an enzyme such as beta-galactosidase, or subjected to filtration to remove lactose. Suitable enzyme treatments and filtration protocols to reduce lactose content will be apparent to those skilled in the art.

In certain embodiments, the high protein liquid composition comprises less than about 10% (w/v), less than about 9% (w/v), less than about 8% (w/v), less than about 7% (w/v), less than about 6% (w/v), less than about 5% (w/v), less than about 4% (w/v), less than about 3% (w/v), less than about 2% (w/v), less than about 1% (w/v), or less than about 0.1% (w/v) lactose. In some such embodiments, the high protein liquid composition has a lactose content of at most 10% (w/v), at most 8% (w/v), at most 6% (w/v), or at most 4% (w/v).

In addition to protein, exemplary high protein liquid compositions can also contain fat and/or carbohydrates. In certain embodiments, the high protein liquid composition also comprises a lipid component. In some such embodiments, the lipid component is present in amount up to 30% (w/v). In certain embodiments, the high protein liquid composition also comprises a carbohydrate component. In some such embodiments, the carbohydrate component is present in amount up to 30% (w/v), In certain embodiments, the high protein liquid composition has a caloric density of not more than 1 kcal/ml, from 1 to 2 kcal/ml, or greater than 2 kcal/ml.

In certain embodiments, the high protein liquid composition comprises at least one monovalent cation and/or at least one divalent metal cation. In some such embodiments, the high protein liquid composition comprises at least 30 mg/100 mL, at least 50 mg/100 mL, or at least 100 mg/100 mL, of the divalent metal cation.

Each feature of the high protein liquid composition described herein may be combined with any other feature or features unless clearly indicated to the contrary. In particular, any feature indicated as being preferred or advantageous may be combined with any other feature or features indicated as being preferred or advantageous. One exemplary liquid composition is a liquid nutritional composition. The liquid nutritional composition can provide enteral nutrition either by oral administration or be administered through a tube (e.g., naso-gastric feeding or gastric feeding). In addition to protein, exemplary liquid nutritional compositions typically also contain fat and/or carbohydrates in levels and combinations to attain calorific values of at least 0.5 kcal/g or kcal/ml. For example, a liquid nutritional composition may have a calorific density up to 3 kcal/g or more. Up to this point, such high calorific densities have been difficult to achieve with low viscosity and sufficient protein.

In certain embodiments, the liquid nutritional composition also comprises a lipid component. The lipid component may comprise a vegetable lipid or an animal (e.g., bovine, porcine, etc.) lipid, including dairy lipid and fish oils. In some such embodiments, vegetable oils are suitable because of their ease of formulation and lower saturated fatty acid content. Exemplary vegetable oils include canola (rapeseed) oil, corn oil, sunflower oil, olive or soybean oil.

In various embodiments, the liquid nutritional composition comprises at least about 0.01, 0.1, 0.5, 1, 2, 3, 4, 5, 6, 7, 8, 9, 10, 15, 20, 25 or at least about 30 g lipid per 100 mL of the composition, and various ranges can be selected from between these values, for example, from about 0.01 to about 30, about 0.1 to about 30, about 1 to about 30, about 0.01 to about 25, about 0.1 to about 25, about 1 to about 25, about 0.01 to about 20, about 0.1 to about 20, about 0.5 to about 20, about 1 to about 20, about 2 to about 20, about 3 to about 20, about 5 to about 20 g about 0.01 to about 15, about 0.1 to about 15, about 1 to about 15, about 2 to about 15, about 5 to about 15, about 0.01 to about 10, about 0.1 to about 10, about 1 to about 10, or about 2 to about 10 g lipid per 100 mL of the composition.

In certain embodiments, the liquid nutritional composition also comprises a carbohydrate component. The carbohydrate component may comprise a digestible carbohydrate, a non-digestible carbohydrate, or a combination thereof. The carbohydrate component may comprise monosaccharides, disaccharides, oligosaccharides, polysaccharides, and mixtures thereof. Suitable oligosaccharides include, but are not limited to, oligosaccharides of glucose. Suitable non-digestible carbohydrates include, but are not limited to, fructooligosaccharides, inulin, and galactooligosaccharides.

In certain embodiments, the liquid nutritional composition comprises at least about 0.01, 0.1, 0.5, 1, 2, 3, 4, 5, 6, 7, 8, 9, 10, 15, 20, 25, 30, 35, 40 or at least about 45 g carbohydrate per 100 mL of the composition, and various ranges can be selected from between these values, for example, from about 0.01 to about 4, about 0.01 to about 45, about 0.1 to about 45, about 1 to about 45, about 4 to about 45, about 5 to about 45, about 0.01 to about 40, about 0.1 to about 40, about 1 to about 40, about 4 to about 40, about 5 to about 40, about 0.01 to about 30, about 1 to about 30, about 1 to about 30, about 4 to about 30, about 5 to about 30, 0.01 to about 20, about 0.1 to about 20, about 0.5 to about 20, about 0.1 to about 15, about 1 to about 20, about 2 to about 20, about 3 to about 20, about 4 to about 20, or about 5 to about 20 g carbohydrate per 100 mL of the composition.

In certain embodiments, the liquid nutritional composition also comprises a stabilizer or an emulsifier. Suitable emulsifiers include lecithins, mono and diglycerides, polyglycerol esters, milk phospholipids, citric acid esters (CITREM), and diacetyl tartaric acid ester of mono- and di-glycerides (DATEM). These emulsifiers can be added in an amount of about 0.003 g to about 0.06 g per gram of lipid. Suitable stabilizers include, but are not limited to, carrageenan, gellan gum, pectin, guar gum, locust bean gum, xanthan gum, carboxymethyl cellulose and microcrystalline cellulose and combinations thereof. Those of skill in the art will recognize that many different gum forms, in addition to those listed above are suitable for use in the liquid compositions disclosed herein.

In certain embodiments, the liquid nutritional composition also comprises a source of amino acids, amino acid precursors, amino acid metabolites, or any combination of any two or more thereof, preferably free amino acids, amino acid precursors or amino acid metabolites.

In certain embodiments, the liquid nutritional composition also comprises vitamins and/or minerals required to sustain patients nutritionally for long periods of time, as well as minor components such as antioxidants, flavouring agents, and/or colouring agents. The amount of vitamins and/or minerals to be used in the liquid nutritional composition are those typical of meal replacement products known to those skilled in the art. The micro-nutritional requirements of various sub-groups of the population are also known. The recommended daily requirements of vitamins and minerals can be specified for various population subgroups. See, e.g., Dietary Reference Intakes (DRIs): Recommended Dietary Allowances and Adequate Intakes, United States National Academy of Sciences, Institute of Medicine, Food and Nutrition Board (2010).

In certain embodiments, the liquid nutritional composition is a neutral pH liquid nutritional composition comprising at least 12% (w/v) total protein, such as from 12% to 18% (w/v) total protein. In some such embodiments, at least 90% or at least 95% of all of the total protein in the neutral pH liquid nutritional composition is denatured whey protein. In some such embodiments substantially all of the total protein in the neutral pH liquid nutritional composition is denatured whey protein. Thus, in certain embodiments, the neutral pH liquid nutritional composition may comprise from 12% to 18% (w/v) total protein, wherein substantially all of the total protein is coming from denatured whey protein. In some such embodiments, the neutral pH liquid nutritional composition includes fat and/or carbohydrates in levels and combinations to attain a caloric density of 1 to 3 kcal/ml, such as from 1.5 to 2.5 kcal/ml. An exemplary neutral pH liquid nutritional composition comprises 12% (w/v) total protein, wherein substantially all of the total protein is coming from denatured whey protein and has a caloric density of 1.60 kcal/ml. Another exemplary neutral pH liquid nutritional composition comprises 15% (w/v) total protein, wherein substantially all of the total protein is coming from denatured whey protein and has a caloric density of 2.25 kcal/ml.

Another exemplary liquid composition is a high protein drinking yoghurt. Processes for manufacturing a liquid composition such as a drinking yoghurt are generally known in the art.

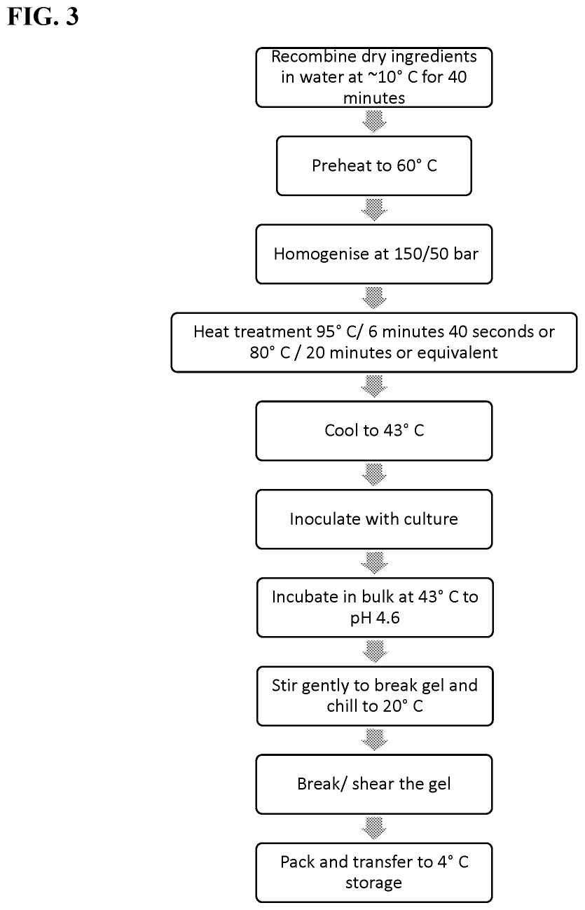

FIG. 3 shows an exemplary process for making a drinking yoghurt. In the exemplary process, ingredients (for example, skim milk powder and a whey protein composition) are combined and added to 60 °C water. The mixture is then homogenized and heated, such as to 95 °C for 6 minutes, to 85 °C for 15 minutes, or to 80 °C for 20 minutes. The mixture is then cooled, such as to 38 °C or 42 °C. The mixture is then inoculated with bacterial starter culture. The mixture is then fermented until at least a pH of less than 4.6 is achieved and subsequently cooled to 20 °C. The so-formed gel is broken and sheared and then packed and cooled to 4 °C.

In certain embodiments, the high protein drinking yoghurt comprises 15% total protein, wherein the same drinking yogurt contains at least 12% denatured whey protein (i.e., at least 80% (w/w) of the total protein is coming from denature whey protein). In certain embodiments, the high protein drinking yoghurt comprises 20% total protein, wherein the same drinking yoghurt contains at least 17% denatured whey protein (i.e., at least 85% (w/w) of the total protein is coming from denature whey protein).

In certain embodiments, the high protein drinking yoghurt has been sterilized and/or pasteurized. For example, the drinking yoghurt may have been sterilized.

In certain embodiments, the mean particle size (characterized by D(4,3)) of the drinking yoghurt is less than 3.0 μm, less than 2.5 μm, less than 2.0 μm, or less than 1.5 μm. In some such embodiments, the mean particle size (characterized by D(4,3)) of a drinking yoghurt is from about 0.6 μm to about 1.5 μm or from about 0.8 μm to about 1.3 μm or from about 0.9 μm to about 1.2 μm. In some such embodiments, the mean particle size (characterized by D(4,3)) of a drinking yoghurt, wherein at least 75%, at least 80%, or at least 85% of the total protein of the drinking yoghurt is from a denatured whey protein composition, is from about 0.6 μm to about 1.5 μm or from about 0.8 μm to about 1.3 μm or from about 0.9 μm to about 1.2 μm.

In certain embodiments, the d₅₀ of the drinking yoghurt is less than 2.0 μm, less than 1.5 μm, or less than 1.0 μm. In some such embodiments, the d₅₀ of a drinking yoghurt is from about 0.5 μm to about 1.3 μm or from about 0.6 μm to about 1.2 μm or from about 0.7 μm to about 1.1 μm. In some such embodiments, the d₅₀ of a drinking yoghurt, wherein at least 75%, at least 80%, or at least 85% of the total protein of the drinking yoghurt is from a denatured whey protein composition, is from about 0.5 μm to about 1.3 μm or from about 0.6 μm to about 1.2 μm or from about 0.7 μm to about 1.1 μm.

In certain embodiments, the doo of the drinking yoghurt is less than 3.0 μm, less than 2.5 μm, or less than 2.0 μm. In some such embodiments, the d₉₀ of a drinking yoghurt is from about 1.3 μm to about 2.5 μm or from about 1.4 μm to about 2.4 μm or from about 1.5 μm to about 2.3 μm. In some such embodiments, the d₉₀ of a drinking yoghurt, wherein at least 75%, at least 80%, or at least 85% of the total protein of the drinking yoghurt is from a denatured whey protein composition, is from about 1.3 μm to about 2.5 μm or from about 1.4 μm to about 2.4 μm or from about 1.5 μm to about 2.3 μm.

In certain embodiments, the high protein drinking yoghurt exhibits minimal or essentially no sedimentation over the shelf-life of the product, such as up to 6 weeks for a chilled drinking yoghurt and up to 6 to 9 months for an ambient drinking yoghurt. For example, the high protein drinking yoghurt exhibits minimal or essentially no sedimentation over the shelf-life of the product (e.g., up to 6 weeks). In some such embodiments, the high protein drinking yoghurt exhibits less than 20% sedimentation over the shelf-life of the product. In some such embodiments, the high protein drinking yoghurt exhibits less than 15%, less than 12%, less than 10%, less than 8%, or less than 6% sedimentation over the shelf-life of the product. In some such embodiments, high protein drinking yoghurt exhibits from about 2% to about 6% or from about 3% to about 5% sedimentation over the shelf-life of the product.

As another example, a centrifuge test can be used to assess sedimentation. Thus, in some such embodiments, the high protein drinking yoghurt exhibits less than 20% sedimentation after centrifugation at 1540×g for 5 minutes. In some such embodiments, the liquid composition exhibits less than 15%, less than 12%, less than 10%, less than 8%, or less than 6% sedimentation after centrifugation. In some such embodiments, the liquid composition exhibits from about 2% to about 6% or from about 3% to about 5% sedimentation after centrifugation.

In certain embodiments, the viscosity of the high protein drinking yoghurt is less than about 400 mPa·s, less than about 300 mPa·s, less than about 200 mPa·s, or less than about 100 mPa·s. In certain embodiments, the viscosity of the high protein drinking yoghurt is less than about 300 mPa·s, less than about 200 mPa·s, or less than about 100 mPa·s. In some such embodiments, the drinking yoghurt has a viscosity from about 20 to about 400 mPa·s. In some such embodiments, the viscosity of a high protein drinking yoghurt comprising from 10% to 20% (w/v) total protein is from about 20 to about 400 mPa·s, from about 20 to about 300 mPa·s, from about 20 to about 200 mPa·s, from about 20 to about 100 mPa·s, from about 30 to about 90 mPa·s, or from about 40 to about 80 mPa·s.

The viscosity of the sample may be measured by methods known in the art. For example, one method involves using an MCR302 rheometer (Anton-Paar) and subjecting the sample to a pre-shear (e.g., 300 s⁻¹ for 1 minute) followed by a rest period prior to measurement at 20 °C during a shear rate sweep (e.g., from 0.001-398 s⁻¹ with the viscosity taken at 50 s⁻¹ and/or 100 s⁻¹). Alternatively, apparent viscosity can be measured at 10 °C using a Haake viscometer (Haake Mess-Technik, Gmbh & Co., Karlsruhe, Germany). The viscosity measurement is carried out by increasing the shear rate from 0 to 120 s⁻¹ over a period of 180 seconds and then reducing the shear to 0 s⁻¹ over a period of 30 seconds. The apparent viscosity is taken at a shear rate of 50 s⁻¹.

The compositions, methods, and uses described herein will be better understood by reference to the following exemplary embodiments and examples, which are included as an illustration of and not a limitation upon the scope of the invention.

### G. HIGH PROTEIN SET AND STIRRED YOGHURTS

In at least one aspect, this disclosure provides a high protein food product comprising denatured whey protein. The high protein food product can be a yoghurt, such as a set yoghurt or stirred yoghurt, each of which are discussed in further detail herein. Processes for manufacturing a set and stirred yoghurts are generally known in the art.

In certain embodiments, the high protein food product comprises at least 6% (w/w) denatured whey protein. In some such embodiments, the high protein food product comprises at least 7% (w/w), at least 8% (w/w), at least 9% (w/w), at least 10% (w/w), at least 11% (w/w), at least 12% (w/w), at least 13% (w/w), at least 14% (w/w), or at least 15% (w/w) denatured whey protein. In some such embodiments, the food product comprises from 6% to 30% (w/w) denatured whey protein, such as from 7% to 25% (w/w) denatured whey protein, from 8% to 20% (w/w) denatured whey protein, or from 10% to 15% (w/w) denatured whey protein.

In certain embodiments, at least 50%, at least 60%, at least 70%, at least 80%, at least 85%, at least 90%, or at least 95% of the total protein in the high protein food product is denatured whey protein. In some such embodiments substantially all of the total protein in the high protein food product is denatured whey protein. In other such embodiments, the high protein food product comprises other dairy proteins and/or non-dairy proteins. In other such embodiments, the high protein food product comprises whey protein from two or more sources, such as a heat-denatured whey protein composition, a non-denatured whey protein composition, a whey protein hydrolysate, or an ingredient comprising both whey and casein (such as an MPC), the total whey protein in the composition is the sum of the total whey protein present in the heat-denatured whey protein composition, the non-denatured whey protein composition, the whey protein hydrolysate, and/or the MPC.

In certain embodiments, the high protein food product comprises at least 5%, at least 10%, at least 15%, or at least 20% (w/w) total protein. The total protein in the food product is the sum of all protein contributed by all protein-containing ingredients in the product. For example, in embodiments where the food product comprises a heat-denatured whey protein composition as well other non-dairy and/or dairy proteins derived from, for example, skim milk powder (SMP) or milk protein concentrate (MPC), the total protein in the food product is the sum of the total protein present in the heat-denatured whey protein composition and the SMP and/or MPC. In some such embodiments, the food product comprises at least 7% (w/w), at least 8% (w/w), at least 9% (w/w), at least 10% (w/w), at least 11% (w/w), at least 12% (w/w), at least 13% (w/w), at least 14% (w/w), or at least 15% (w/w) total protein. In some such embodiments, the food product comprises from 6% to 30% (w/w) total protein, such as from 8% to 25% (w/w) total protein or from 10% to 15% (w/w) total protein. In some such embodiments, the high protein food product comprises 10% (w/w), 11% (w/w), 12% (w/w), 13% (w/w), 14% (w/w), 15% (w/w), 16% (w/w), 17% (w/w), 18% (w/w), 19% (w/w), or 20% (w/w) total protein.

In certain embodiments, the food product has been sterilized and/or pasteurized in a manner suitable for commercial applications. In some such embodiments, the sterilization and/or pasteurization comprises a thermal (i.e., heat) treatment. In other such embodiments, the sterilization and/or pasteurization comprises a non-thermal treatment.

In certain embodiments, the high protein food product comprises a set gel, such as a set yoghurt. In some such embodiments, the set gel comprises at least 6% (w/w), at least 7% (w/w), at least 8% (w/w), at least 9% (w/w), at least 10% (w/w), at least 11% (w/w), at least 12% (w/w), at least 13% (w/w), at least 14% (w/w), or at least 15% (w/w) whey protein. The whey protein comprises microparticles comprising denatured whey protein.

In some such embodiments, the set gel exhibits a firmness of less than 1000 g·sec or less than 900 g·sec or less than 800 g·sec or less than 700 g·sec. In some such embodiments, the set gel exhibits a fracture force of less than 50 g, less than 45 g, or less than 40 g.

In certain embodiments, the high protein food product is a semi-solid food product, such as a stirred yoghurt. In some such embodiments, the particle size distribution of the semi-solid food product after sterilization or pasteurization comprises a d₅₀ less than 1 μm and a d₉₀ less than 5 μm. In some such embodiments, the semi-solid food product comprises at least 6% (w/w), at least 7% (w/w), at least 8% (w/w), at least 9% (w/w), at least 10% (w/w), at least 11% (w/w), at least 12% (w/w), at least 13% (w/w), at least 14% (w/w), or at least 15% (w/w) whey protein. The whey protein comprises microparticles comprising denatured whey protein.

In some such embodiments, the semi-solid food product has a viscosity of less than 500 mPa·s or less than less than 400 mPa·s measured at 50 s⁻¹ at 20 °C.

### H. EXEMPLARY EMBODIMENTS

In one aspect, the disclosure provides a heat-stable, denatured whey protein composition comprising microparticles comprising denatured whey protein, wherein at least 50% or at least 55% by volume of the particles have a diameter from 0.2 μm to 1.0 μm.

In another aspect, the disclosure provides a heat-stable, denatured whey protein composition comprising microparticles comprising denatured whey protein, wherein the microparticles have a volume weighted mean diameter D(4,3) of not more than about 1.0 μm and at least 95% by volume of the particles have a diameter less than about 2.0 μm.

In certain embodiments of any aspect disclosed herein, the disclosure provides a heat-stable, denatured whey protein composition comprising microparticles comprising denatured whey protein, wherein the microparticles exhibit minimal or essentially no primary particle size growth after heating a 10% (w/w) protein content aqueous solution (at pH 6.8) at 120 °C for 15 minutes. In some such embodiments, the d₅₀ of a 10% (w/w) protein content aqueous solution following the primary particle growth test comprising heat treatment at 120 °C for 15 minutes is not more than about 1.0 μm, preferably from about 0.6 to about 1.0 μm. In some such embodiments, the d₉₀ of a 10% (w/w) protein content aqueous solution following the primary particle growth test comprising heat treatment at 120 °C for 15 minutes is less than about 2.0 μm, preferably from about 0.9 to about 1.7 μm or from about 1.1 to about 1.5 μm.

In certain embodiments of any aspect disclosed herein, the whey protein has a degree of hydrolysis of less than about 10%. In some such embodiments, the whey protein has a degree of hydrolysis of less than about 5%. In some such embodiments, the whey protein is substantially non-hydrolysed.

In certain embodiments of any aspect disclosed herein, the heat-stable, denatured whey protein composition comprises an amount of total protein of at least 65%, at least 70%, at least 75%, or at least 80% on a dry weight basis.

In certain embodiments of any aspect disclosed herein, the heat-stable, denatured whey protein composition comprises at least 70%, at least 80%, or at least 90% (w/w) whey protein relative to total protein.

In certain embodiments of any aspect disclosed herein, residual denaturable whey protein in the denatured whey protein composition is less than 16%, less than 14%, or less than 12%.

In certain embodiments of any aspect disclosed herein, the denatured whey protein composition has an insolubility of at least 60% or at least 65%.

In certain embodiments of any aspect disclosed herein, the heat-stable, denatured whey protein composition has a lactose content of at most 10%, at most 8%, at most 6%, or at most 4% by weight.

In certain embodiments of any aspect disclosed herein, the heat-stable, denatured whey protein composition has a fat content of at most 20%, at most 18%, at most 16%, at most 14%, at most 12%, at most 10%, at most 8%, or at most 6%.

In certain embodiments of any aspect disclosed herein, the heat-stable, denatured whey protein composition has an ash content of at most 10%, at most 8%, at most 6%, or at most 4% by weight.

In certain embodiments of any aspect disclosed herein, the heat-stable, denatured whey protein composition comprises less than about 10% casein by weight.

In certain embodiments of any aspect disclosed herein, the heat-stable, denatured whey protein composition is substantially free of casein.

Exemplary Embodiment 1. A heat-stable, denatured whey protein composition comprising an amount of total protein of at least 60% on a dry weight basis and microparticles comprising denatured whey protein, wherein the microparticles have a particle size distribution comprising at least two characteristics selected from the group consisting of: (i) a volume weighted mean diameter D(4,3) of not more than about 1.0 μm, (ii) a d₅₀ of not more than about 1.0 μm, (iii) a d₉₀ of not more than about 2.0 μm, (iv) at least 92% by volume of the particles have a diameter less than about 2.0 μm, and (v) not more than 45% by volume of the microparticles have a diameter between about 1.0 and about 10.0 μm.

Exemplary Embodiment 2. The heat-stable, denatured whey protein composition of exemplary embodiment 1, wherein the particle size distribution comprises (i) a volume weighted mean diameter D(4,3) of not more than about 1.0 μm, such as from about 0.6 to about 1.0 μm, and (iii) a d₉₀ of not more than about 2.0 μm, such as from about 0.9 to about 1.7 μm.

Exemplary Embodiment 3. The heat-stable, denatured whey protein composition of exemplary embodiment 1, wherein the particle size distribution comprises (ii) a d₅₀ of not more than about 1.0 μm, such as from about 0.6 to about 1.0 μm, and (iii) a doo of not more than about 2.0 μm, such as from about 0.9 to about 1.7 μm.

Exemplary Embodiment 4. The heat-stable, denatured whey protein composition of exemplary embodiment 3, wherein the particle size distribution comprises (i) a volume weighted mean diameter D(4,3) of not more than about 1.0 μm, such as from about 0.6 to about 1.0 μm.

Exemplary Embodiment 5. The heat-stable, denatured whey protein composition of any one of exemplary embodiments 1-4, wherein the particle size distribution comprises (iv) at least 92%, at least 95%, or at least 98% by volume of the particles have a diameter less than about 2.0 μm.

Exemplary Embodiment 6. The heat-stable, denatured whey protein composition of any one of exemplary embodiments 1-5, wherein the particle size distribution comprises (v) not more than 45% by volume of the microparticles have a diameter between about 1.0 and about 10.0 μm.

Exemplary Embodiment 7. The heat-stable, denatured whey protein composition of any one of exemplary embodiments 1-6, wherein the particle size distribution does not substantially change after heating a 10% (w/w) protein content aqueous solution comprising the denatured whey protein composition at 120 °C for 15 minutes.

Exemplary Embodiment 8. The heat-stable, denatured whey protein composition of any one of exemplary embodiments 1-7, wherein the d₅₀ is from about 0.6 to about 1.0 μm after heating a 10% (w/w) protein content aqueous solution comprising the denatured whey protein composition at 120 °C for 15 minutes.

Exemplary Embodiment 9. The heat-stable, denatured whey protein composition of any one of exemplary embodiments 1-8, wherein the doo is not more than about 2.0 μm, such as from about 0.9 to about 1.7 μm, after heating a 10% (w/w) protein content aqueous solution comprising the denatured whey protein composition at 120 °C for 15 minutes.

Exemplary Embodiment 10. The heat-stable, denatured whey protein composition of any one of exemplary embodiments 1-9, wherein the volume weighted mean diameter D(4,3) is not more than about 1.0 μm, such as from about 0.6 to about 1.0 μm, after heating a 10% (w/w) protein content aqueous solution comprising the denatured whey protein composition at 120 °C for 15 minutes.

Exemplary Embodiment 11. The heat-stable, denatured whey protein composition of any one of exemplary embodiments 1-10, wherein a 10% (w/w) protein content aqueous solution comprising the denatured whey protein composition has a heat coagulation time (HCT) of at least 3 minutes, at least 4 minutes, at least 5 minutes, at least 6 minutes, at least 9 minutes, at least 12 minutes, at least 15 minutes, or at least 18 minutes at 140 °C.

Exemplary Embodiment 12. The heat-stable, denatured whey protein composition of any one of exemplary embodiments 1-11, wherein the composition comprises less than about 10% casein by weight.

Exemplary Embodiment 13. The heat-stable, denatured whey protein composition of any one of exemplary embodiments 1-12, wherein the composition is substantially free of casein.

Exemplary Embodiment 14. The heat-stable, denatured whey protein composition of any one of exemplary embodiments 1-13, wherein the composition comprises from about 30% to about 80% β-lactoglobulin, about 35% to about 75% β-lactoglobulin, or about 40% to about 65% β-lactoglobulin, relative to total protein in the composition.

Exemplary Embodiment 15. The heat-stable, denatured whey protein composition of any one of exemplary embodiments 1-14, wherein the composition comprises at least 70% (w/w) whey protein relative to total protein, at least 80% (w/w) whey protein relative to total protein, or at least 90% (w/w) whey protein relative to total protein.

Exemplary Embodiment 16. The heat-stable, denatured whey protein composition of any one of exemplary embodiments 1-15, wherein residual denaturable whey protein in the denatured whey protein composition is less than 16%.

Exemplary Embodiment 17. The heat-stable, denatured whey protein composition of any one of exemplary embodiments 1-15, wherein the denatured whey protein composition has an insolubility of at least 60%.

Exemplary Embodiment 18. A liquid composition comprising the heat-stable, denatured whey protein composition of any one of exemplary embodiments 1-17.

Exemplary Embodiment 19. The liquid composition of exemplary embodiment 18, wherein the liquid composition is a drinking yoghurt.

Exemplary Embodiment 20. A food product comprising the heat-stable, denatured whey protein composition of any one of exemplary embodiments 1-17.

Exemplary Embodiment 21. The food product of exemplary embodiment 20, wherein the food product is a baked food product, a bar, or a set or stirred yoghurt.

Exemplary Embodiment 22. The food product of exemplary embodiment 20, wherein the food product is a set yoghurt, the set yoghurt optionally comprising from about 6% to about 20% (w/v) total protein with, optionally, at least 50% (w/w) of the total protein coming from the denatured whey protein composition, wherein the set yoghurt exhibits reduced firmness and/or reduced volume weighted mean particle size compared to a control set yoghurt product having the same ingredient composition and the same protein content except that the control set yoghurt product does not comprise a denatured whey protein composition of any one of exemplary embodiments 1-17.

Exemplary Embodiment 23. The food product of exemplary embodiment 20, wherein the food product is a stirred yoghurt, the stirred yoghurt optionally comprising from about 6% to about 20% (w/v) total protein with, optionally, at least 50% (w/w) of the total protein coming from the denatured whey protein composition, wherein the stirred yoghurt exhibits reduced viscosity and/or reduced volume weighted mean particle size compared to a control stirred yoghurt product having the same ingredient composition and the same protein content except that the control stirred yoghurt product does not comprise a denatured whey protein composition of any one of exemplary embodiments 1-17.

Exemplary Embodiment 24. A nutritional composition comprising the heat-stable, denatured whey protein composition of any one of exemplary embodiments 1-17.

Exemplary Embodiment 25. A liquid nutritional composition comprising the heat-stable, denatured whey protein composition of any one of exemplary embodiments 1-17.

Exemplary Embodiment 26. A method for providing nutrition to a subject in need thereof, the method comprising administering to the subject the nutritional composition of exemplary embodiment 24 or the liquid nutritional composition of exemplary embodiment 25.

Exemplary Embodiment 27. The nutritional composition of exemplary embodiment 24 or the liquid nutritional composition of exemplary embodiment 25 for use in providing nutrition to a subject in need thereof.

Exemplary Embodiment 28. A method for preparing a heat-stable, denatured whey protein composition, the method comprising: (a) providing an aqueous whey protein solution or a whey protein retentate; (b) contacting the aqueous whey protein solution or the whey protein retentate with an oxidizing agent; and (c) subjecting the whey protein solution or the whey protein retentate to a heat treatment under conditions of high shear stress/force, wherein the total protein content of the aqueous whey protein solution or whey protein retentate at step (c) is preferably at least 16% (w/w); wherein the high shear stress/force is optionally generated by increased serum phase viscosity, a wall shear rate higher than 1000 s−1, a turbulent flow pattern with Re of at least 2000, application of mechanical shear, or a combination thereof.

Exemplary Embodiment 29. The method of exemplary embodiment 28, wherein the oxidizing agent is hydrogen peroxide or benzoyl peroxide.

Exemplary Embodiment 30. The method of exemplary embodiment 29, wherein step (b) further comprises contacting the aqueous whey protein solution or the whey protein retentate with an oxidizing agent in combination with a catalyst, such as an enzymatic catalyst or a chemical catalyst, preferably a peroxidase enzyme.

Exemplary Embodiment 31. The method of any one of exemplary embodiments 28-30, wherein the oxidizing agent is present in step (b) in an amount less than 300 ppm or less than 200 ppm.

Exemplary Embodiment 32. The method of any one of exemplary embodiments 28-30, wherein the oxidizing agent is present in step (b) in an amount less than 1200×10⁻⁶ kg/kg whey protein, less than 2000×10⁻⁶ kg/kg denaturable whey protein, or less than 2400×10⁻⁶ kg/kg β-lactoglobulin protein.

Exemplary Embodiment 33. The method of any one of exemplary embodiments 28-32, wherein the oxidizing agent is inactivated, removed, or consumed prior to step (c) such that the whey protein solution or the whey protein retentate is substantially free of the oxidizing agent during the heat treatment of step (c).

Exemplary Embodiment 34. The method of any one of exemplary embodiments 28-33, wherein the aqueous whey protein solution or a whey protein retentate has a low level of denaturation prior to step (c).

Exemplary Embodiment 35. The method of exemplary embodiment 34, wherein the denaturation level of the whey protein solution or the whey protein retentate prior to step (c) is less than 10%, such as from about 3% to about 8%.

Exemplary Embodiment 36. The method of any one of exemplary embodiments 28-35, wherein the heat-stable, denatured whey protein composition is the heat-stable, denatured whey protein composition of any one of exemplary embodiments 1-17.

Exemplary Embodiment 37. A heat-stable, denatured whey protein composition prepared by the method of any one of exemplary embodiments 28-35.

Exemplary Embodiment 38. A method for preparing a liquid composition comprising combining the heat-stable, denatured whey protein composition of any one of exemplary embodiments 1-17 and exemplary embodiment 37 with at least one additional component such as a lipid component or a carbohydrate component and heating the liquid composition to a temperature above 80 °C to inhibit microbiological activity.

Exemplary Embodiment 39. A heat-treated, shelf-stable high protein liquid composition comprising at least 6% (w/v) whey protein, wherein said whey protein comprises microparticles comprising denatured whey protein; and wherein (i) the liquid composition has a d₅₀ of not more than about 1.0 μm and/or a d₉₀ of not more than about 2.0 μm after secondary heat treatment applied for microbial control; (ii) said liquid composition has a viscosity of less than 400 mPa·s or less than 200 mPa·s measured at 100 s−1 at 20 °C; (iii) said liquid composition exhibits less than 10% sedimentation following storage at a temperature from about 20 °C to about 25 °C for the shelf-life of the liquid composition; and/or (iv) said liquid composition exhibits less than 10% sedimentation after centrifugation at 1540×g for 5 minutes.

Exemplary Embodiment 40. The liquid composition of exemplary embodiment 18, the liquid nutritional composition of exemplary embodiment 25, or the heat-treated, shelf-stable liquid composition of exemplary embodiment 39, wherein the liquid composition or the liquid nutritional composition or the heat-treated, shelf-stable liquid composition:
has a d₅₀ of not more than about 1.0 μm and a doo of not more than about 2.0 μm;
comprises at least 12%, at least 14%, at least 16%, at least 18%, or at least 20% (w/v) total protein; and/or
comprises at least 6%, at least 8%, at least 10%, at least 12%, at least 14%, at least 16%, at least 18%, or at least 20% (w/v) denatured whey protein.

Exemplary Embodiment 41. The heat-treated, shelf-stable liquid composition of exemplary embodiment 39, wherein the liquid composition comprises at least 10%, at least 12%, at least 14%, at least 16%, at least 18%, or at least 20% (w/v) denatured whey protein.

Exemplary Embodiment 42. The heat-treated, shelf-stable liquid composition of exemplary embodiment 39, wherein the liquid composition is a drinking yoghurt and the drinking yoghurt comprises at least 6%, at least 8%, at least 10%, at least 12%, at least 14%, at least 16%, at least 18%, or at least 20% (w/v) total protein and at least 6%, at least 8%, at least 10%, at least 12%, at least 14%, at least 16%, at least 18%, or at least 20% (w/v) denatured whey protein.

Exemplary Embodiment 43. The heat-treated, shelf-stable liquid composition of exemplary embodiment 42, wherein the drinking yoghurt has a viscosity less than about 400 mPa·s, less than about 300 mPa·s, less than about 200 mPa·s, or less than about 100 mPa·s measured at 50 s−1 at 20 °C.

Exemplary Embodiment 44. The heat-treated, shelf-stable liquid composition of exemplary embodiment 42 or exemplary embodiment 43, wherein the drinking yoghurt comprises at least 9%, at least 12%, at least 15%, at least 18%, or at least 20% (w/v) total protein.

Exemplary Embodiment 45. The heat-treated, shelf-stable liquid composition exemplary embodiment 39, wherein the liquid composition is an acidic beverage.

Exemplary Embodiment 46. The heat-treated, shelf-stable liquid composition of exemplary embodiment 45, wherein the acidic beverage has a pH from about 2 to about 4.8.

Exemplary Embodiment 47. The heat-treated, shelf-stable liquid composition of exemplary embodiment 45, wherein the acidic beverage comprises at least 6%, at least 8%, at least 10%, at least 12%, at least 14%, at least 16%, at least 18%, or at least 20% (w/v) total protein and at least 6%, at least 8%, at least 10%, at least 12%, at least 14%, at least 16%, at least 18%, or at least 20% (w/v) denatured whey protein.

Exemplary Embodiment 48. The heat-treated, shelf-stable liquid composition of exemplary embodiment 47, wherein the acidic beverage has a viscosity less than about 400 mPa·s, less than about 300 mPa·s, less than about 200 mPa·s, or less than about 100 mPa·s measured at 100 s−1 at 20 °C.

Exemplary Embodiment 49. The heat-treated, shelf-stable liquid composition of exemplary embodiment 47 or exemplary embodiment 48, wherein the acidic beverage comprises at least 9%, at least 12%, at least 15%, at least 18%, or at least 20% (w/v) total protein.

Exemplary Embodiment 50. The heat-treated, shelf-stable liquid composition exemplary embodiment 39, wherein the liquid composition is a neutral beverage.

Exemplary Embodiment 51. The heat-treated, shelf-stable liquid composition of exemplary embodiment 50, wherein the neutral beverage has a pH from about 6.5 to 7.5.

Exemplary Embodiment 52. The heat-treated, shelf-stable liquid composition of exemplary embodiment 50 or exemplary embodiment 51, wherein the neutral beverage comprises at least 6%, at least 8%, at least 10%, at least 12%, at least 14%, at least 16%, at least 18%, or at least 20% (w/v) total protein and at least 6%, at least 8%, at least 10%, at least 12%, at least 14%, at least 16%, at least 18%, or at least 20% (w/v) denatured whey protein.

Exemplary Embodiment 53. The heat-treated, shelf-stable liquid composition exemplary embodiment 39, wherein the liquid composition is a liquid nutritional composition for use in providing nutrition to a subject in need thereof.

Exemplary Embodiment 54. The heat-treated, shelf-stable liquid composition of exemplary embodiment 53, wherein the liquid nutritional composition comprises at least 30 mg/100 mL, at least 50 mg/100 mL, or at least 100 mg/100 mL, of a divalent cation, such as Ca++.

Exemplary Embodiment 55. The heat-treated, shelf-stable liquid composition of exemplary embodiment 53 or exemplary embodiment 54, wherein the neutral beverage comprises at least 6%, at least 8%, at least 10%, at least 12%, at least 14%, at least 16%, at least 18%, or at least 20% (w/v) total protein and at least 6%, at least 8%, at least 10%, at least 12%, at least 14%, at least 16%, at least 18%, or at least 20% (w/v) denatured whey protein.

Exemplary Embodiment 56. The heat-treated, shelf-stable liquid composition of any one of exemplary embodiments 53-55, wherein the liquid nutritional composition comprises a lipid component and a carbohydrate component.

Exemplary Embodiment 57. The heat-treated, shelf-stable liquid composition of any one of exemplary embodiments 53-56, wherein the liquid composition has an energy density of at least 0.5, at least 1.0, at least 1.5, or at least 2.0 kcal/ml.

Exemplary Embodiment 58. The heat-treated, shelf-stable liquid composition of any one of exemplary embodiments 39-57, further comprising a non-whey protein, preferably selected from the group consisting of casein, caseinate, micellar casein isolate, and a mixture thereof.

Exemplary Embodiment 59. A liquid nutritional composition comprising at least 6% (w/v) whey protein, wherein said whey protein comprises microparticles comprising denatured whey protein; and wherein the liquid nutritional composition further comprises a lipid component, wherein the lipid component is optionally present in amount up to 30% (w/v), a carbohydrate component, wherein the carbohydrate component is optionally present in amount up to 30% (w/v), at least one monovalent cation, and at least one divalent metal cation, wherein the liquid nutritional composition comprises at least 30 mg/100 mL, at least 50 mg/100 mL, or at least 100 mg/100 mL, of the divalent metal cation.

Exemplary Embodiment 60. The liquid nutritional composition of exemplary embodiment 59, wherein the composition comprises at least 12%, at least 14%, at least 16%, at least 18%, or at least 20% (w/w) whey protein.

Exemplary Embodiment 61. A method for providing nutrition to a subject in need thereof, the method comprising administering to the subject the liquid nutritional composition of any one of exemplary embodiments 25, 53-57, or 59-60.

Exemplary Embodiment 62. A heat-treated, high protein set gel, said set gel comprising at least 10% or at least 15% (w/v) total protein, wherein at least 50% or at least 60% (w/w) of the total protein is denatured whey protein; and wherein the set gel (i) exhibits a firmness of less than 1000 g·sec and/or (ii) a fracture force of less than 50 g.

Exemplary Embodiment 63. The heat-treated, high protein set gel of exemplary embodiment 62, wherein the set gel comprises a yoghurt.

Exemplary Embodiment 64. The heat-treated, high protein set gel of exemplary embodiment 62 or exemplary embodiment 63, wherein the set gel comprises at least 12%, at least 14%, at least 16%, at least 18%, or at least 20% (w/w) whey protein.

Exemplary Embodiment 65. A heat-treated, high protein semi-solid food product, said semi-solid food product comprising at least 10% or at least 15% (w/v) total protein, wherein at least 50% or at least 60% (w/w) of the total protein is denatured whey protein; and wherein the semi-solid food product has a viscosity of less than 1000 mPa·s, less than 800 mPa·s, less than 600 mPa·s, or less than 400 mPa·s measured at 50 s−1 at 20 °C.

Exemplary Embodiment 66. The heat-treated, high protein semi-solid food product of exemplary embodiment 65, wherein the semi-solid food product comprises a stirred yoghurt.

Exemplary Embodiment 67. The heat-treated, high protein semi-solid food product of exemplary embodiment 65 or exemplary embodiment 66, wherein the semi-solid food product comprises at least 12%, at least 14%, at least 16%, at least 18%, or at least 20% (w/w) whey protein.

Exemplary Embodiment 68. A liquid nutritional composition comprising microparticles comprising denatured whey protein, wherein the liquid nutritional composition comprises not more than 12% (w/v) total protein and at least 95% of the total protein in the liquid nutritional composition is denatured whey protein; and wherein the liquid nutritional composition optionally further comprises a lipid component and/or a carbohydrate component.

Exemplary Embodiment 69. The liquid nutritional composition of exemplary embodiment 68, wherein substantially all of the total protein in the high protein liquid composition is denatured whey protein.

Exemplary Embodiment 70. The liquid nutritional composition of exemplary embodiment 68 or exemplary embodiment 69, wherein the lipid component is optionally present in amount up to 30% (w/v) and the carbohydrate component is optionally present in amount up to 30% (w/v).

Exemplary Embodiment 71. The liquid nutritional composition of any one of exemplary embodiments 68-70, further comprising at least one divalent metal cation, wherein the liquid nutritional composition comprises at least 30 mg/100 mL, at least 50 mg/100 mL, or at least 100 mg/100 mL, of the divalent metal cation

Exemplary Embodiment 72. The liquid nutritional composition of any one of exemplary embodiments 68-71, wherein the liquid nutritional composition has a caloric density less than 1 kcal/ml.

Exemplary Embodiment 73. The liquid nutritional composition of any one of exemplary embodiments 68-71, wherein the liquid nutritional composition has a caloric density of 1 to 2 kcal/ml.

Exemplary Embodiment 74. The liquid nutritional composition of any one of exemplary embodiments 68-71, wherein the liquid nutritional composition has a caloric density greater than 2 kcal/ml.

Exemplary Embodiment 75. The liquid nutritional composition of any one of exemplary embodiments 68-71, wherein the liquid nutritional composition has a caloric density of 1.5 to 2.5 kcal/ml.

Exemplary Embodiment 76. The liquid nutritional composition of any one of exemplary embodiments 68-75, wherein (i) the liquid composition has a d50 of not more than about 1.0 μm after secondary heat treatment applied for microbial control; (ii) said liquid composition has a viscosity of less than 400 mPa·s or less than 200 mPa·s measured at 100 s−1 at 20 °C; (iii) said liquid composition exhibits less than 10% sedimentation following storage at a temperature from about 20 °C to about 25 °C for at least 3 months; and/or (iv) said liquid composition exhibits less than 10% sedimentation after centrifugation at 1540×g for 5 minutes.

Exemplary Embodiment 77. A liquid nutritional composition comprising microparticles comprising denatured whey protein, wherein the liquid nutritional composition comprises at least 12% (w/v) total protein and at least 95% of the total protein in the liquid nutritional composition is denatured whey protein; wherein the liquid nutritional composition further comprises a lipid component and/or a carbohydrate component.

Exemplary Embodiment 78. The liquid nutritional composition of exemplary embodiment 77, wherein substantially all of the total protein in the liquid nutritional composition is denatured whey protein.

Exemplary Embodiment 79. The liquid nutritional composition of exemplary embodiment 77 or exemplary embodiment 78, wherein the liquid nutritional composition has a neutral pH.

Exemplary Embodiment 80. The liquid nutritional composition of any one of exemplary embodiments 77-79, wherein the liquid nutritional composition comprises 12% to 18% (w/v) total protein, wherein substantially all of the total protein is coming from denatured whey protein.

Exemplary Embodiment 81. The liquid nutritional composition of any one of exemplary embodiments 77-80, wherein the lipid component is optionally present in amount up to 30% (w/v) and the carbohydrate component is optionally present in amount up to 30% (w/v).

Exemplary Embodiment 82. The liquid nutritional composition of any one of exemplary embodiments 77-81, further comprising at least one divalent metal cation, wherein the liquid nutritional composition comprises at least 30 mg/100 mL, at least 50 mg/100 mL, or at least 100 mg/100 mL, of the divalent metal cation

Exemplary Embodiment 83. The liquid nutritional composition of any one of exemplary embodiments 77-82, wherein the liquid nutritional composition has a caloric density less than 1 kcal/ml.

Exemplary Embodiment 84. The liquid nutritional composition of any one of exemplary embodiments 77-82, wherein the liquid nutritional composition has a caloric density of 1 to 2 kcal/ml.

Exemplary Embodiment 85. The liquid nutritional composition of any one of exemplary embodiments 77-82, wherein the liquid nutritional composition has a caloric density greater than 2 kcal/ml.

Exemplary Embodiment 86. The liquid nutritional composition of any one of exemplary embodiments 77-82, wherein the liquid nutritional composition has a caloric density of 1.5 to 2.5 kcal/ml.

Exemplary Embodiment 87. The liquid nutritional composition of any one of exemplary embodiments 77-86, wherein (i) the liquid composition has a d₅₀ of not more than about 1.0 μm after secondary heat treatment applied for microbial control; (ii) said liquid composition has a viscosity of less than 400 mPa·s or less than 200 mPa·s measured at 100 s⁻¹ at 20 °C; (iii) said liquid composition exhibits less than 10% sedimentation following storage at a temperature from about 20 °C to about 25 °C for at least 3 months; and/or (iv) said liquid composition exhibits less than 10% sedimentation after centrifugation at 1540×g for 5 minutes.

### I. EXAMPLES

In order to demonstrate the practice of the subject matter disclosed herein, the following examples have been prepared and tested. The examples should not, however, be viewed as limiting the scope of the invention.

### Methodology

### Preparation and Assessment of the Denatured Whey Protein Powders

All powders are recombined at 10% (w/w) protein concentration using ambient (~20 °C) deionized water with a magnetic stirrer. The protein powders are gradually added into the water under a vortex mixing condition with a care to avoid any foaming. Once all the powder is dispersed, hydration is continued for 30 minutes with continuous stirring. The solutions are homogenized at 150/50 bar and tested for primary particle size, primary particle size growth, heat coagulation time, insolubility and denaturation as described below.

The primary particle size of the reconstituted powders is determined using a Malvern Mastersizer 2000 or Malvern Mastersizer 3000 (Malvern Instruments Ltd, Worcs, UK) with a refractive index for the particles of 1.46 and for the solvent 1.33. Volume weighted mean particle size d [4,3], the percentile values of D₅₀ and D₉₀ values were calculated using Mastersizer software.

The % Volume of particles in a defined size range is determined by taking the sum of the relevant size classes of the raw data reported by the Mastersizer software.

Primary particle size growth is determined after heating the 10% protein solution (at pH 6.8) in a silicone oil bath at 120 °C for 15 mins. A 5 mL aliquot of 10% protein solution is put in an 8 mL glass vial with a closed cap, placed in a rocking unit that is inserted in the oil bath at 120 °C while samples are gently rocked during 15 mins of heating. The samples are cooled immediately by inserting in ice water and particle size analysis is carried out as described above.

Heat coagulation time: 1 ml aliquot of 10% protein (w/w) solutions (at pH 6.8) are placed in a glass vial which is clipped onto a platform and placed in a silicone oil bath thermostatically controlled at 140 °C with a gentle rocking rate. The length of time, in minutes, that elapses between placing the container in the oil bath and onset of visible aggregate formation is defined as the heat coagulation time (HCT).

Insolubility (%)=7.5 g of denatured whey protein powder is dissolved in 192.5 g of 0.1 M NaCl solution by mixing for 30 minutes using a magnetic stirrer. A 50 g portion of this suspension is pH adjusted to pH 4.6 using 15% acetic acid (amount of acetic acid addition is recorded for dilution correction factor). 40 g of this suspension is transferred into a 50 ml centrifuge tube and centrifuged (Beckman) at 7250 g for 20 min. The supernatant of this solution is analyzed for total protein by testing the total nitrogen content by Kjeldahl method (ISO 8968-1/2|IDF 020-1/2-Milk-Determination of nitrogen content—Part 1/2: Determination of nitrogen content using the Kjeldahl method). Total protein content is calculated by multiplying the total nitrogen result by a conversion factor of 6.38. Another portion of the suspension (not subjected to centrifuge) is also analyzed for total protein.

$$\% insolubility = 1 - \frac{Total Nitrogen of supernant}{Total Nitrogen of total solutution} \times dilution factor of acetic acid$$

Denaturation and soluble proteins are analysed based on the method described by Elgar et al (2000) J Chromatography A, 878, 183-196.

The powders are characterized by measuring the residual denaturable protein as a proportion of total protein according to the following formula:

$$\% Residual denaturable protein = \frac{soluble denaturable protein \times 100}{Total Nitrogen \times 6.38}$$

Where the soluble whey protein is determined using reversed phase HPLC and described as grams protein/100 grams powder.

The denaturable whey protein is measured as Σ bovine serum albumin+α-lactalbumin+β-lactoglobulin+lactoferrin+immunoglobulins.

The % denaturation of denaturable proteins can be calculated based on the following formula:

$$( 1 - \frac{residual denaturable protein}{total denaturable protein} ) \times 100$$

The percentage of β-lactoglobulin that is covalently cross-linked is determined using the 2100 Agilent Bioanalyzer System (Agilent, USA), which utilizes microfluidic SDS electrophoretic technology, using the method of Anema (2009), with modifications (SG Anema, 2009, The use of “lab-on-a-chip” microfluidic SDS electrophoresis technology for the separation and quantification of milk proteins. International Dairy Journal, Volume 19, Issue 4, Pages 198-204).

The proportion of residual native protein, covalently aggregated protein and non-covalently aggregated protein is determined by dissolving the denatured whey protein composition in buffers that dissociate different bonds and determine the change in soluble protein after a centrifugation step.

To determine the residual native protein content, samples before and after heating are dissolved/or diluted to 10% (w/w) protein in water. A 300 mg aliquot of sample is dissolved in 1.2 mL acetate buffer (0.2M, pH 4.35).

A 0.1M phosphate buffer (pH=6.7) prepared from 0.0281 mol of NaH₂PO₄·2H₂O and 0.0218 mol of Na₂HPO₄ is prepared; urea is added to a final concentration of 8M and sodium dodecyl sulfate (SDS) is added to a final concentration of 2% (w/v). A 300 mg aliquot of sample is dissolved in 1.2 mL of the phosphate/urea/SDS buffer (PSU buffer).

The prepared samples are shaken using a test tube shaker for 1 hour.

The samples are centrifuged at 20,000×g for 1 hour at 25 °C.

A 100 μL aliquot of the supernatant is carefully taken and run using the Bioanalyzer System and are prepared according to the method of Anema. The area under the curve for the protein peaks are automatically integrated by the software (2100 Bioanalyzer Expert Software package). The peak area is used to calculate the type of bonding based on the sample preparation as described above.

### Rationale

Acetate buffer used in this experiment precipitates any denatured whey protein or residual casein in solution. The unheated sample is expected to have low levels of denatured protein. The heated sample is expected to have high levels of denaturation. The residual native protein in the heated sample is calculated as a proportion of the unheated feed native protein.

$$Residual native like protein = \frac{\begin{matrix}Peak area soluble β LG in heated \\ solution in pH 4.35 acetic buffer\end{matrix}}{Peak area soluble β LG in unheated ( feedstock ) solution} \times 100 \%$$

Urea is able to break hydrophobic bonds and SDS is able to break non-covalent bonds such as hydrogen and hydrophobic bonds. The heated sample that is added to the phosphate buffer containing urea and SDS will cause the solubilization of non-covalent bonds and therefore allows the calculation of the non-covalently aggregated protein as compared to the total soluble protein in the unheated solution, taking into account the residual native-like protein.

$$Non covalently aggregated protein = \frac{\begin{matrix}( Peak area of soluble β LG in PSU buffer ) - ( Peak area \\ soluble β LG in heated solution in pH 4.35 acetic buffer )\end{matrix}}{Peak area soluble β LG in unheated ( feedstock ) solution} \times 100 \%$$

The covalently aggregated protein can therefore be calculated as the remainder of the protein that was not solubilized by the PSU buffer.

Covalently aggregated protein=1−(Residual native like protein−Non covalently aggregated protein)

Preparation and Analysis of High Protein Liquid Nutritional Compositions and/or Beverages

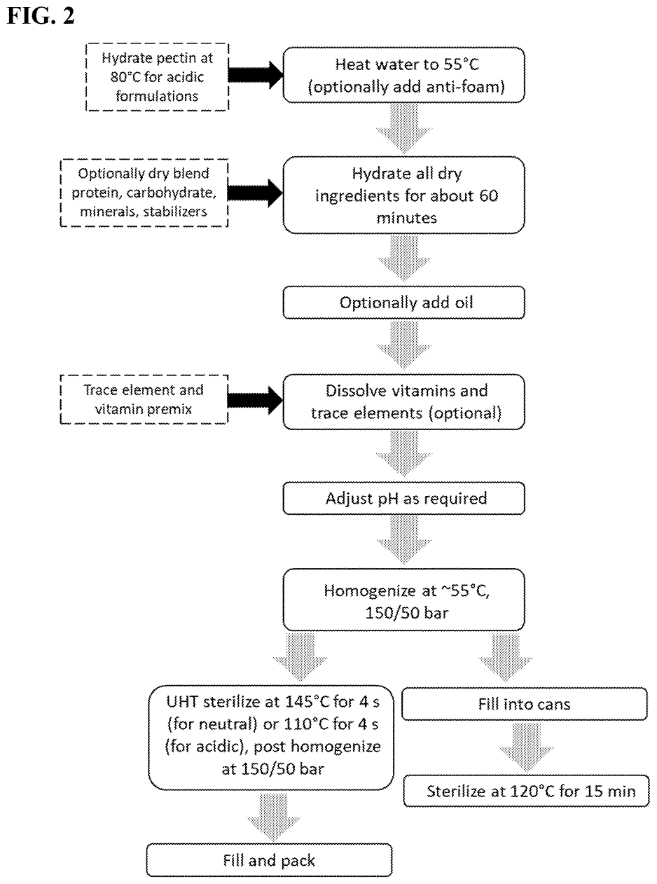

A flow chart of the overall process for the manufacture of high protein beverages is shown in FIG. 2.

### Neutral High Protein Beverages

The required protein, carbohydrates, minerals and stabilizers are dry blended and hydrated in water heated to 55 °C for 60 minutes, which has anti-foam added, if required. Oil is added to the mixture. The pH is adjusted to about pH 6.8=0.1 using 5% KOH. The mixture is homogenized at 55 °C, 150/50 bar. The beverages can be sterilized in two ways:
(1) The homogenized mixture is filled into retort cans and heated treated at 120 °C for 15 minutes.
(2) The homogenized mixture is UHT sterilized at 145 °C for 4 seconds followed by homogenization at 150/50 bar. The product is aseptically packed.

### Acidic High Protein Beverages

The same process was followed according to that of the neutral beverages; however, a pectin solution is prepared at 80 °C and added to the water, prior to the addition of the protein, carbohydrates, minerals and stabilizers. The pH is adjusted to pH 4.0±0.1 with 15% hydrochloric acid. The UHT sterilization is performed at 110 °C for 4 seconds followed by homogenization at 150/50 bar. The product is aseptically packed.

The viscosity of the formulations is measured at 20 °C using a rheometer such as an Anton Paar instrument using a cup and bob assembly at a shear rate of 100 s⁻¹, unless otherwise indicated. It will be appreciated that other methods to measure or estimate viscosity are well known in the art and may be employed where appropriate.

The particle size distribution of beverages is measured in the same manner described in the Primary Particle size and the % volume of particles analysis is done in the same manner as stated above.

Testing for sedimentation: After the suitable heat treatment of beverages, the products are stored at 25 °C for shelf-life testing at 1 month, 3 month, 6 month or 12 month shelf life. To test the sediment, the product is inverted 3 times and carefully poured out. The container is placed upside down for 30 minutes; the weight of the container plus sediment is recorded; the amount of sediment is calculated by subtracting the empty container weight. The % sediment is then calculated by the ratio of the weight of sediment over total weight of the product in the container.

### Preparation and Analysis of High Protein Drinking Yoghurts, Set and Stirred Yoghurts

A flow chart of the yoghurt manufacture process in shown in FIG. 3. The denatured whey protein particle concentrates, skim milk powder (SMP) and optionally MPC are recombined in water at 10 °C for 60 minutes using an overhead stirrer. The composition is held overnight at 4 °C. The mixture is pre-heated to 60 °C followed by homogenization at 150/50 bar. The composition is then heated to 95 °C and held for 6 minutes, 80 °C for 20 minutes, or equivalent then cooled to 42 °C. The mixture is inoculated with starter culture (Chr Hansen YF-L702). The mixture is incubated for approximately 9-16 hours at 42 °C to a final pH of about 4.6 to form yoghurt. The drinking and/or stirred yoghurts are cooled to 20 °C and processed to break the gel. The yoghurts were packed into containers and cooled to about 4 °C. The set yoghurts are filled into pottles immediately after inoculation and fermented to produce a set yoghurt.

The pH is measured at about 10 °C using a pH meter (model pHM210; Radiometer Analytical SAS, France) that is calibrated against pH 7.0 and pH 4.0 buffers prior to use. The pH of each sample is measured at least twice from separate pottles at Day 7.

The apparent viscosity is measured at 10 °C using a Haake viscometer (Haake Mess-Technik, Gmbh & Co., Karlsruhe, Germany). The viscosity measurement is carried out by increasing the shear rate from 0 to 120 s⁻¹ over a period of 180 s and then reducing the shear to 0 s⁻¹ over a period of 30 s. The apparent viscosity at a shear rate of 50 s⁻¹ is reported. The test is performed in duplicate from separate sample pottles at Day 7.

The sediment via centrifugation is determined by centrifuging a sample of the drinking yoghurt at 3000 rpm (1540×g) for 5 minutes at a temperature of 10-15 °C using a Sorvall EvolutionRC centrifuge (Rotor F13S-14×50 cY, Rotor code is C=SLA600TC Angle Rotor). The supernatant is carefully removed, and the sides of the tube wall are dried. The sediment as a percentage of the total weight of the original sample in the tube is calculated as the sediment %.

The sediment is determined by carefully pouring the drinking yoghurt out of the container allowing the liquid to drain. The sediment is determined by measuring the height of the sediment in the pottle and the height of the yoghurt in the pottle and calculating the sediment as a percentage of the total sample. The test is performed in duplicate from separate sample pottles after 1 and 6 weeks storage.

Phase separation is determined by measuring the height of the clear layer formed at the top of the yoghurt and the height of the yoghurt in the pottle and calculating the phase separation as a percentage of the total sample. The test is performed in duplicate from separate sample pottles after 1 and 6 weeks storage.

Fracture force and firmness is evaluated using a TAHD Plus Texture Analyser from Stable Micro Systems, Godalming, England. A 1.27 cm Perspex cylinder is used in a single compression test; the initial force to break the surface of the set yoghurt is recorded as the fracture force (g) and the area under the curve was recorded as the firmness (g.s).

Sensory attributes of the food products are assessed using the following sensory procedure. The food products are presented in clear sample cups labelled with randomised 3-digit blinding codes. The samples are presented to the panel at a temperature appropriate for the particular food product. Sensory evaluation is performed by a panel of 8 expert panellists familiar with a high degree of experience tasting the particular food product. The food products samples are evaluated with participants describing the texture and flavour attributes and intensities. A consensus approach is used to collate the attributes that best described each sample.

FIG. 2 is an exemplary process flow diagram for the manufacture of an exemplary liquid composition, namely a high protein beverage, comprising a denatured whey protein concentrate.

FIG. 3 is an exemplary process flow diagram for the manufacture of an exemplary liquid composition, namely a drinking yoghurt, comprising a denatured whey protein composition

### Example 1A: Preparation of the Inventive Denatured Whey Protein Particle Composition

An annatto-colored dairy cheese whey was concentrated up to about 22-24% (w/w) protein concentration using standard commercial ultrafiltration/diafiltration techniques. Table 1 shows the specific conditions used for producing Powders A, B, C, and D from colored whey. The colored whey retentate was decolorized by pre-loading the retentate silo with fungal peroxidase enzyme MaxiBright and addition of a total of 50-80 ppm of hydrogen peroxide. The ratio of hydrogen peroxide to retentate, hydrogen peroxide addition rate as well as retentate mixing-holding time in the silo after hydrogen peroxide addition were selected to provide optimum improvement to the denaturable whey protein composition while providing the desired whiteness and preventing the formation of off flavors. This step was completed at temperature <10 °C. Before further processing, the retentate was sampled and tested for detectable peroxide, using a Merck peroxide indicator test strip (MQuant Peroxide test strip, 0.5-25 mg/L H₂O₂), and no peroxide was detected.

The pH of whey protein concentrates was adjusted as described in Table 1 using 2% (w/v) NaOH solution and preheated to 54 °C using a heat exchanger heated by hot water. Subsequently, denatured whey protein compositions were prepared according to the method described in WO2010120199. Whey protein concentrates were fed into two identical single tube high pressure steam heated shell and tube heat exchangers in series using a high-pressure pump with delivery pressure of 250-350 bar at high enough flowrate to achieve Reynolds number of ≥2100. The concentrate exited the first high pressure heater at 71-73 °C and exited the second high pressure heater at 80-85 °C as shown in Table 1.

After emerging from the second heater, the heat-treated whey protein concentrates passed through a holding tube and a pipe to the nozzle bank at the top of spray drier with similar tube specification as high-pressure heaters which implies the turbulent flow was maintained. The length of holding tube is selected in a manner that in conjunction with the pipe to nozzle bank provides extra 20 s of residence time for heated stream before being spray dried with <1 °C temperature loss across the pipe from exit of second high pressure heater up to the nozzle bank. This means no additional mechanical shear inducing device was used during heating and post the heater-reactor system and prior to spray drying.

At the spray drier, the heat-treated concentrate was delivered to a bank of three nozzles and was atomized into a droplet spray at a pressure greater than 200 bar. An inlet hot air temperature of 210-220 °C and an outlet chamber temperature of 60-70 °C were used. The powder was further dried and then cooled in vibrating fluidized bed prior to sifting and packaging of materials to produce a powder with <5% moisture. Several uncolored whey protein concentrates were also processed without addition of hydrogen peroxide and peroxidase enzyme (Powder E, F, G) according to the method described in WO2010120199 under turbulent flow with a Reynolds number of ≥2100. A commercial microparticulated WPC (Nutrilac YO-8075) from Arla Foods (Powder H) was obtained and tested in comparison using the methods described in the methodology section.

TABLE 1
Comparison of the process variables that were used
for production of denatured whey compositions

| Powder | A | B | C | D | E | F | G | H |
|---|---|---|---|---|---|---|---|---|
| Annatto- | Yes | Yes | Yes | Yes | No | No | No | Commercial |
| Colored | | | | | | | | micro- |
| H₂O₂ and | Yes | Yes | Yes | Yes | No | No | No | particulated |
| peroxidase | | | | | | | | WPC Nutrilac |
| Heating | 80 | 80 | 83 | 85 | 80 | 80 | 85 | YO-8075 |
| temperature | °C | °C | °C | °C | °C | °C | °C | |
| pH | 6.3 | 6.7 | 6.5 | 6.3 | 6.3 | 6.3 | 6.7 | |

TABLE 2
Typical gross composition (dry weight basis) and protein profile
of the whey protein concentrates prior to heating.

| | Annatto- | Uncolored |
|---|---|---|
| Composition | colored whey | whey |
| Protein (w/w) | 84.9 | 83.75 |
| Fat (w/w) | 5.78 | 5.3 |
| Lactose (w/w) | 5.66 | 5.75 |
| Ash (w/w) | 2.62 | 3.0 |
| Ca (mg/100 g) | 390 | 395 |
| Na (mg/100 g) | 160 | 227 |
| K (mg/100 g) | 620 | 609 |
| Soluble GMP/total soluble protein (%) | 20.3 | 21.5 |
| Soluble pp5/total soluble protein (%) | 3.2 | 4.8 |
| Soluble α-lac/total soluble protein (%) | 13.7 | 14.7 |
| Soluble BSA/total soluble protein (%) | 1.07 | 1.7 |
| Soluble β-1 g/total soluble protein (%) | 57.6 | 52.6 |
| Soluble igg/total soluble protein (%) | 4.1 | 4.6 |

TABLE 3
Comparison of the features of denatured whey protein concentrate powders after recombining

| | A | B | C | D | E | F | G | H |
|---|---|---|---|---|---|---|---|---|
| Volume weighted mean particle | 0.70 | 0.83 | 0.87 | 0.73 | 1.5 | 1.16 | 1.53 | 1.12 |
| size d_{4, 3} (μm) | | | | | | | | |
| D₅₀ (μm) | 0.66 | 0.78 | 0.82 | 0.69 | 1.37 | 1.09 | 1.43 | 0.86 |
| D₉₀ (μm) | 1.05 | 1.3 | 1.4 | 1.08 | 2.6 | 2.0 | 2.6 | 2.4 |
| % Volume of particles <1 μm | 77.8 | 56.8 | 64 | 73.5 | 26 | 39.9 | 21.5 | 53.5 |
| % Volume of particles 1-10 μm | 22.2 | 43.2 | 35.8 | 26.5 | 73.5 | 60.1 | 78.5 | 46.5 |
| % Volume of particles >2 μm | 0 | 0.5 | 0.8 | 0 | 26 | 11.3 | 27.2 | 17.7 |
| Heat coagulation time of 10% | 17.5 mins | 18.5 mins | 20 mins | 14 mins | 37 sec | 43 sec | 2 min | 86 sec |
| protein solution at 140 °C | | | | | | | | |
| Primary particle growth after | 0.64 | 0.78 | 0.76 | 0.69 | Gelled | Gelled | 1.53 | 1.23 |
| heating 10% protein solution | | | | | | | | |
| (D₅₀) | | | | | | | | |
| Primary particle growth after | 1.2 | 1.3 | 1.3 | 1.25 | Gelled | Gelled | 4.3 | 6.2 |
| heating 10% protein solution | | | | | | | | |
| (D₉₀) | | | | | | | | |
| Total protein (TNx6.38) | 81 | 79 | 77 | 79 | 80 | 78 | 79 | 81 |
| Insolubility (%) | 64.6 | 66.1 | 66.7 | 64.9 | 61.2 | 65.0 | 65.0 | 71.8 |
| Residual denaturable protein | 12.7 | 12.4 | 11.3 | 11.9 | 15.5 | 14.2 | 12.8 | 4.9 |
| (%) | | | | | | | | |
| Denaturation (%) of | 81 | 81.8 | 83.7 | 83 | 80.4 | 81.8 | 84 | N/A |
| denaturable protein | | | | | | | | |
| % of β-lg covalently cross- | 87.5 | 92 | 85 | 84 | 30.5 | 30 | 53.6 | N/A |
| linked | | | | | | | | |

### Example 1B: Turbidity of Denatured Whey Protein Concentrate Powder after Recombining

The turbidity of the denatured whey protein concentrate was determined by recombining a powder prepared in accordance with Powder C (above) in water. An absorbance of 0.1% protein solution measured at 500 nm was out of range (>1). The solution was further diluted to 0.025% protein (w/w) to enable a reading within the measurement range of the spectrophotomter. The absorbance of the 0.025% protein solution at 500 nm at about 20 °C was 0.857. Taking into account the dilution factor, the turbidity of the 0.1% protein solution was 3.4 absorbance units.

### Example 2: Preparation of 9% Protein (w/v) Shelf Stable Beverages

This example describes the preparation of an exemplary high protein liquid beverage comprising powder (Powder A) using the method according to the invention compared to comparative powders described in Example 1 (Powder F, G, H). The beverages were prepared under neutral conditions according to the procedure in the methodology section. The formulation used to prepare the beverages are shown in Table 4, the nutritional compositions of the beverages are summarized in Table 5.

TABLE 4
Formulations of high protein liquid beverages comprising
different denatured whey protein concentrates

| | Powder | Powder | Powder | Powder |
|---|---|---|---|---|
| Ingredient (g/100 g) | A | F | G | H |
| Water | 87.66 | 90.14 | 87.66 | 88.67 |
| Powder A | 10.70 | | | |
| Powder F | | 11.02 | | |
| Powder G | | | 10.70 | |
| Powder H | | | | 10.60 |
| Canola Oil | 0.18 | 0.18 | 0.18 | 0.18 |
| Sodium chloride | 0.06 | 0.06 | 0.06 | 0.06 |
| tri-potassium citrate monohydrate | 0.060 | 0.060 | 0.060 | 0.060 |
| Gellan Gum DAI Dupont | 0.040 | 0.040 | 0.040 | 0.040 |
| Novagel 1518 | 0.190 | 0.190 | 0.190 | 0.190 |
| Antifoam | 0.01 | 0.01 | 0.01 | 0.01 |
| 5% potassium hydroxide | 0.8 | 0.8 | 0.8 | 0.8 |

TABLE 5
Nutritional composition of high protein liquid beverages
comprising different denatured whey protein concentrates

| Component | Nutritional composition |
|---|---|
| Protein (g/100 ml) | 9.0 |
| Protein (g/100 ml) from denatured WPC | 9.0 |
| Fat (g/100 ml) | 0.8 |
| Carbohydrates (g/100 ml) | 1.0 |
| Ash (g/100 ml) | 0.5 |
| Total solids (g/100 ml) | 11.9 |
| Energy (kcal/ml) | 0.5 |
| Sodium (mg/100 ml) | 93 |
| Potassium (mg/100 ml) | 65 |
| Calcium (mg/100 ml) | 32 |

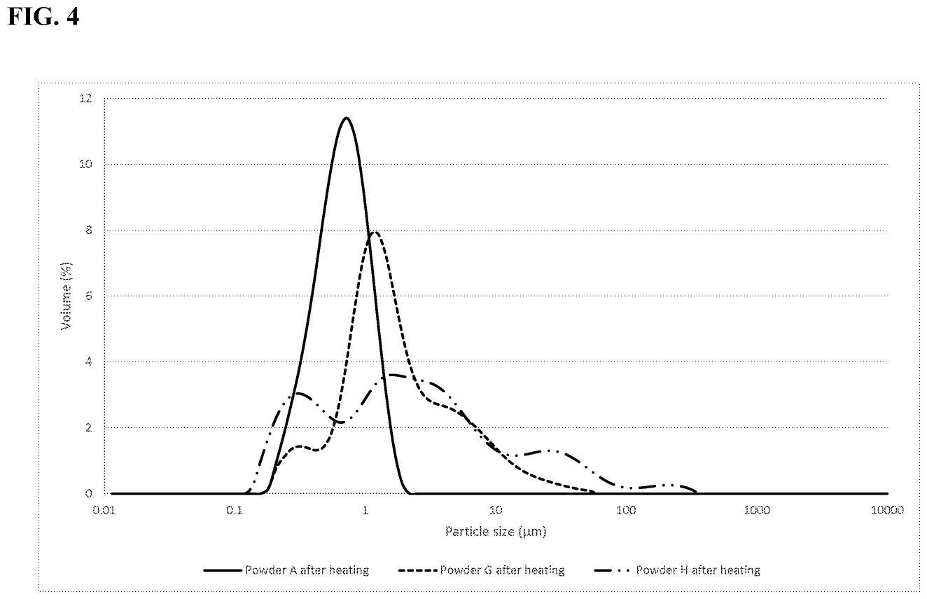

Table 6 shows the properties of the high protein beverages prepared using different denatured whey protein concentrates. The high protein beverage comprising Powder A showed minimal changes in the particle size characteristics after heating at 120 °C for 15 minutes when compared to the Powder A properties summarized in Example 1, Table 3. The high protein beverage prepared with Powder A had a homogenous consistency with a smooth appearance which was very thin and pourable. Powder F caused the high protein beverage to gel, forming large aggregates with a grainy appearance in the solution, during the heat treatment and therefore shows significant instability to sterilization conditions. Powder G and Powder H exhibited significant particle growth due to the heat treatment, which caused a noticeably gritty/powdery mouthfeel which was undesirable. This difference in particle size distribution after sterilization can clearly be seen in FIG. 4. FIG. 4 shows particle size distributions of high protein beverages after heating at 120 °C for 15 minutes prepared with Powder A, Powder G or Powder H.

TABLE 6
Beverage characteristics after retort heat treatment

| Beverage | | | | |
|---|---|---|---|---|
| characteristics | Powder A | Powder F | Powder G | Powder H |
| Volume weighted | 0.67 | GELLED | 2.96 | 9.35 |
| particle size d_{4, 3} | | | | |
| (μm) | | | | |
| D₅₀ (μm) | 0.62 | GELLED | 1.35 | 1.8 |
| D₉₀ (μm) | 1.09 | GELLED | 6.86 | 22.3 |
| % Volume of | 82.8 | N/A | 30.4 | 34.2 |
| particles <1 μm | | | | |
| % Volume of | 17.2 | N/A | 64.0 | 48.8 |
| particles 1-10 μm | | | | |
| % Volume of | 0.0 | N/A | 35.7 | 48.5 |
| particles >2 μm | | | | |
| Viscosity (mPa · s at | 5.01 | GELLED | 15.6 | 18.8 |
| 100 s⁻¹) after | | | | |
| heating. | | | | |

### Example 3: Primary Particle Size Growth

This example shows the particle sizes of the denatured whey protein concentrates of the invention and comparative denatured whey protein concentrates after heating at 120 °C for 15 minutes.

All powders were prepared according to the recombining method stated in the methodology, however, protein solutions of 12, 14, 16 and 18% (w/w) protein were also prepared. The particle size was measured according to the primary particle size growth method described in the methodology.

Table 7 shows the particle size, in terms of D₅₀ and D₉₀ of the protein solutions after heating. The values can be compared to the respective powders in Example 1, Table 3, which shows the particle size before heating at 120 °C for 15 minutes. The appearance of the denatured whey protein composition after heating is also described in the Table as either a liquid, thick liquid or in a gelled state.

TABLE 7
Change in particle size of denatured whey protein composition after heating
at 120 °C for 15 mins. D₅₀ and D₉₀ reported in μm.

| | 10% protein | 12% protein | 14% protein | 16% protein | 18% protein |
|---|---|---|---|---|---|
| Powder A | Liquid | Liquid | Liquid | Liquid | Thick Liquid |
| | D₅₀ = 0.64 | D₅₀ = 0.69 | D₅₀ = 0.68 | D₅₀ = 0.69 | D₅₀ = 0.5 |
| | D₉₀ = 1.22 | D₉₀ = 1.3 | D₉₀ = 1.3 | D₉₀ = 1.5 | D₉₀ = 8.1 |
| Powder B | Liquid | Liquid | Liquid | Liquid | Thick Liquid |
| | D₅₀ = 0.78 | D₅₀ = 0.80 | D₅₀ = 0.82 | D₅₀ = 0.84 | D₅₀ = 4.2 |
| | D₉₀ = 1.3 | D₉₀ = 1.4 | D₉₀ = 1.4 | D₉₀ = 1.8 | D₉₀ = 20.4 |
| Powder C | Liquid | Liquid | Liquid | Liquid | Thick Liquid |
| | D₅₀ = 0.76 | D₅₀ = 0.77 | D₅₀ = 0.78 | D₅₀ = 0.8 | D₅₀ = 11.1 |
| | D₉₀ = 1.28 | D₉₀ = 1.3 | D₉₀ = 1.4 | D₉₀ = 2.0 | D₉₀ = 39.8 |
| Powder D | Liquid | Liquid | Liquid | Liquid | Thick Liquid |
| | D₅₀ = 0.66 | D₅₀ = 0.62 | D₅₀ = 0.68 | D₅₀ = 0.74 | D₅₀ = 5.3 |
| | D₉₀ = 1.25 | D₉₀ = 1.2 | D₉₀ = 1.4 | D₉₀ = 1.5 | D₉₀ = 20.9 |
| Powder E | Gelled after | Gelled after | Gelled after 1 | Gelled <1 | Gelled <0.5 |
| | 3 min | 1.30 min | min | min | min |
| Powder F | Gelled after 9 | Gelled after 2 | Gelled after | Gelled after 1 | Gelled <1 |
| | mins | mins | 1.5 mins | min | min |
| Powder G | Liquid | Gelled after | Gelled after 5 | Gelled after 2 | Gelled <1.5 |
| | D₅₀ = 1.53 | 12 mins | mins | mins | min |
| | D₉₀ = 4.29 | | | | |
| Powder H | Liquid | Gelled after | Gelled after 5 | Gelled after 2 | Gelled <1 |
| | D₅₀ = 1.23 | 10 mins | mins | mins | min |
| | D₉₀ = 6.20 | | | | |

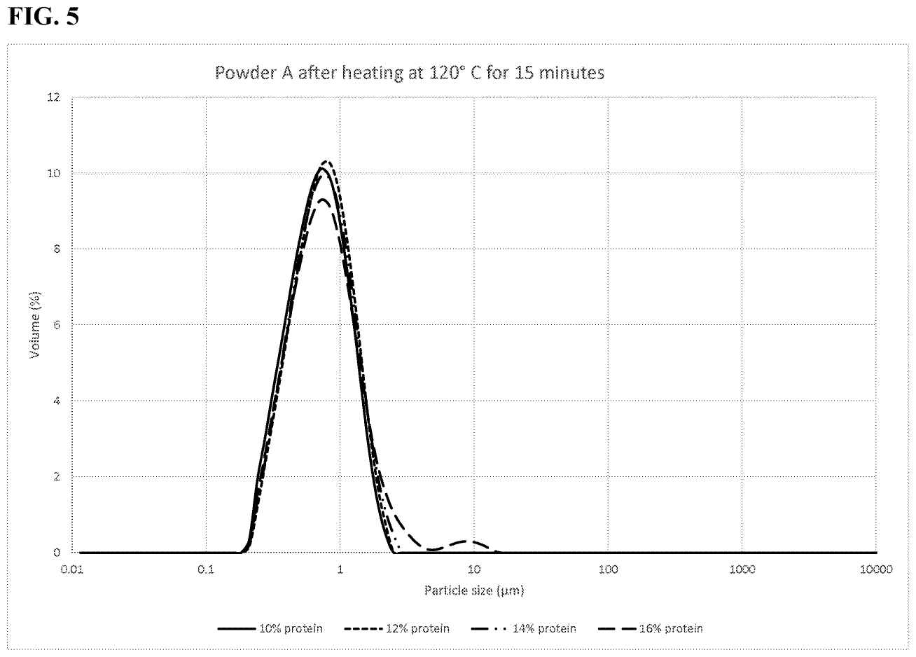

The powders of the invention showed no significant change in particle size after the heat treatment of 120 °C for 15 minutes for solutions containing up to 16% (w/w) protein and at 18% (w/w) protein was still a liquid. The comparative compositions gelled after the same heat treatment at a protein content of 10% (w/w) or 12% (w/w) protein. The inventive denatured whey protein compositions exhibit excellent heat stability even at higher protein concentrations and show minimal or no change in the particle size distribution compared to the comparative denatured whey protein compositions. FIG. 5 shows the particle size distribution of protein solutions containing Powder A from 10% to 16% (w/w) protein after heating at 120 °C for 15 mins.

Maintaining a particle size distribution with D₅₀ less than 1 μm and D₉₀ less than 2 μm after a heat treatment is an important feature to enable good shelf-life stability, minimal sedimentation, low viscosity and good mouthfeel properties such as no powderiness and grittiness. This was representative of all the powders of the invention.

FIG. 5 shows particle size distributions of protein solutions containing Powder A after heating at 120 °C for 15 minutes at 10%, 12%, 14% or 16% (w/w) protein.

### Example 4: Heat Coagulation Time at High Protein Concentrations and Use of Denatured Whey Protein Concentrate of the Invention in High Protein Liquid Nutritional Compositions

This example shows the heat coagulation time (at 140 °C) of the protein solutions containing denatured whey protein concentrates of the invention and comparative whey protein concentrates at high protein concentrations.

All compositions were prepared according to the recombining method stated in the methodology, however, protein concentrations of 12, 14, 16 18% and 20% (w/w) protein were also prepared. The heating was done according to the heat coagulation time method stated in the methodology.

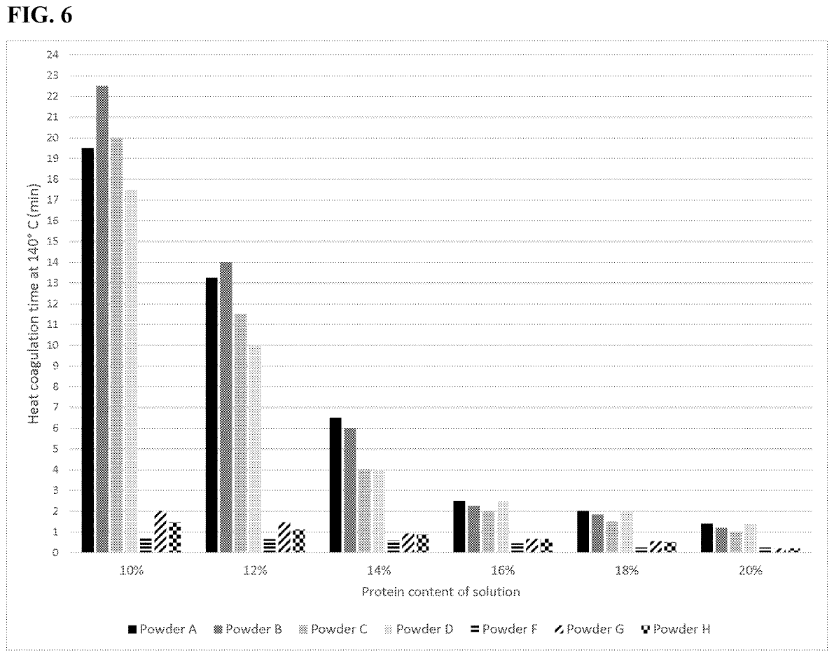

FIG. 6 shows that the denatured whey protein composition of the invention is significantly more heat stable than comparative denatured whey protein compositions. Based on the inventors' experience, it is known that the sample takes at least 1 min to 1.5 minute to reach 140 °C therefore, any samples that do not show a heat coagulation time of greater than 1 minute are unlikely to be stable during UHT heat treatment process. All the denatured whey protein compositions of the invention had a heat coagulation time of 1 minute or greater at up to 20% (w/w) protein. Powders G and H exhibited a heat coagulation time of less than 1 minute when prepared at concentration of 14% (w/w) or greater; Powder F exhibited a heat coagulation time of less than 1 minute when prepared at a concentration of 10% (w/w) or greater

FIG. 6: Heat coagulation time of the denatured whey protein compositions prepared at protein concentrations of 10% to 20% (w/w).

As a next step, the particle size distribution of protein solutions containing inventive Powder C at 10%-18% (w/w) protein was measured after heating at 140 °C for 90 seconds and immediately cooling. The values in Table 8 can be compared to the respective powder in Example 1, Table 3, which shows the particle size prior to heating. Powder C not only remains liquid after such heating conditions but also shows minimal change in particle size up to a protein concentration of 18% (w/w) protein when heated at 140 °C for 90 seconds.

TABLE 8
Particle size distribution of Powder C after heating at 140 °C for 90 seconds.
D₅₀ and D₉₀ reported in μm. Appearance of the composition after heating is described.

| | 10% | 12% | 14% | 16% | 18% |
|---|---|---|---|---|---|
| | protein | protein | protein | protein | protein |
| Powder C | Liquid | Liquid | Liquid | Liquid | Liquid |
| | D₅₀ = 0.77 | D₅₀ = 0.78 | D₅₀ = 0.82 | D₅₀ = 0.79 | D₅₀ = 0.82 |
| | D₉₀ = 1.3 | D₉₀ = 1.4 | D₉₀ = 1.7 | D₉₀ = 1.5 | D₉₀ = 2.66 |

Based on these findings, several high protein liquid nutritional compositions were prepared using an inventive powder (Powder A) as described in Table 9, 10, 11. Since, the comparative denatured whey protein concentrates at concentrations of 14% (w/w) or greater were not stable to heating at 140 °C, no further testing of these samples was performed in high protein nutritional compositions. The beverages were prepared according to the procedure shown in the methodology section.

TABLE 9
Formulations of neutral and acidic pH high protein
liquid beverages comprising Powder A

| | Formulation | Formulation | Formulation |
|---|---|---|---|
| Ingredient (g/100 g) | 1 | 2 | 3 |
| Water | 80.86 | 69.92 | 78.41 |
| Powder A | 16.99 | 15.909 | 19.05 |
| Canola Oil | 0.62 | 6.10 | 0.4 |
| Sugar | 0.6 | 2.0 | 0.64 |
| Maltodextrin T400 | | 5.0 | |
| Lecithin (Metarin P IP) | 0.10 | 0.13 | 0.40 |
| tri-potassium citrate | 0.060 | 0.06 | 0.032 |
| monohydrate | | | |
| MCC/CMC stabiliser | 0.10 | 0.10 | |
| (Novagel 1518) | | | |
| Gellan Gum | 0.025 | | |
| Carrageenan | | 0.04 | |
| Pectin YM 115 | | | 0.056 |
| Sodium chloride | 0.03 | | |
| Tri-sodium citrate | | 0.075 | |
| dihydrate | | | |
| Calcium carbonate | | 0.209 | |
| Antifoam | 0.01 | 0.01 | 0.01 |
| 5% potassium hydroxide | 0.6 | 0.45 | |
| 15% hydrochloric acid | | | 1.0 |
| Product pH | 7.0 | 7.0 | 4.0 |
| UHT Process conditions | 145 °C | 145 °C | 110 °C |
| (Temp, time) | for 4 s | for 4 s | for 4 s |

TABLE 10
Nutritional composition of pH neutral and acidic high protein liquid
beverages comprising various protein contents and compositions

| | Nutritional composition | | |
|---|---|---|---|
| | Formulation | Formulation | Formulation |
| Component | 1 | 2 | 3 |
| Protein (g/100 ml) | 14 | 14 | 16 |
| Protein (g/100 ml) from | 14 | 14 | 14 |
| denatured WPC | | | |
| Fat (g/100 ml) | 1.8 | 7.94 | 2.1 |
| Carbohydrates (g/100 ml) | 1.9 | 8.68 | 3.2 |
| Ash (g/100 ml) | 0.6 | 0.88 | 0.6 |
| Total solids (g/100 ml) | 18.3 | 31.53 | 21.8 |
| Energy (kcal/ml) | 0.8 | 1.6 | 0.8 |
| Sodium (mg/100 ml) | 40.5 | 48.3 | 32.2 |
| Potassium (mg/100 ml) | 141.6 | 139 | 124 |
| Calcium (mg/100 ml) | 68.2 | 160.3 | 78.4 |
| Magnesium (mg/100 ml) | 7.0 | 7.0 | 8.0 |

TABLE 11
Beverage characteristics of pH neutral and acidic high
protein liquid beverages comprising various protein
contents and compositions after UHT heat treatment

| | Formulation | Formulation | Formulation |
|---|---|---|---|
| | 1 | 2 | 3 |
| Volume weighted particle | 0.71 | 0.68 | 0.71 |
| size d_{4, 3} (μm) | | | |
| D50 (μm) | 0.64 | 0.46 | 0.67 |
| D90 (μm) | 1.21 | 1.13 | 1.16 |
| % Volume of particles <1 μm | 77.9 | 85.2 | 78.8 |
| % Volume of particles | 22.1 | 14.7 | 21.2 |
| 1-10 μm | | | |
| % Volume of particles >2 μm | 0.6 | 3.4 | 0.0 |
| Viscosity (mPa · s at 100 s⁻¹) | 7.9 | 11.8 | 9.7 |

Additional high protein liquid nutritional compositions were prepared using Powder A as described in Table 12, 13, and 14.

TABLE 12
Formulations of neutral pH high protein
liquid beverages comprising Powder A

| Ingredient (g/100g) | Formulation 4 | Formulation 5 |
|---|---|---|
| Water | 70.12 | 58.04 |
| Powder A | 15.91 | 18.10 |
| Canola Oil | 6.10 | 8.51 |
| Sugar | 2.00 | 2.0 |
| Maltodextrin T400 | 5.00 | 12.40 |
| Lecithin (Metarin P IP) | 0.13 | 0.13 |
| tri-potassium citrate monohydrate | 0.06 | 0.06 |
| MCC/CMC stabiliser (Novagel 1518) | 0.10 | 0.10 |
| DiMagnesium phosphate 3 hydrate | 0.033 | 0.065 |
| Carrageenan | 0.04 | 0.04 |
| Antifoam | 0.01 | 0.01 |
| Sodium chloride | 0.049 | |
| Potassium chloride | | 0.095 |
| 5% potassium hydroxide | 0.45 | 0.45 |
| Product pH | 6.76 | 6.75 |
| UHT Process conditions | 146 °C | 146 °C |
| (Temp, time) | for 6 s | for 6 s |

TABLE 13
Nutritional composition of pH neutral high protein liquid beverages
comprising various protein contents and compositions

Nutritional composition

| Component | Formulation 4 | Formulation 5 |
|---|---|---|
| Protein (g/100 ml) | 12.3 | 15.1 |
| Protein (g/100 ml) from | 12.3 | 15.1 |
| denatured WPC | | |
| Fat (g/100 ml) | 7.4 | 11 |
| Carbohydrates (g/100 ml) | 8.8 | 17 |
| Ash (g/100 ml) | 0.5 | 0.8 |
| Total solids (g/100 ml) | 28.7 | 44.3 |
| Energy (kcal/ml) | 1.6 | 2.25 |
| Sodium (mg/100 ml) | 51 | 34 |
| Potassium (mg/100 ml) | 139 | 208 |
| Calcium (mg/100 ml) | 69 | 80 |
| Magnesium (mg/100 ml) | 12 | 18 |

TABLE 14
Beverage characteristics of pH neutral high protein
liquid beverages comprising various protein contents
and compositions after UHT heat treatment

| | Formulation | Formulation |
|---|---|---|
| | 4 | 5 |
| Volume weighted particle size d_{4, 3} (μm) | 0.692 | 2.74 |
| D50 (μm) | 0.587 | 0.75 |
| D90 (μm) | 1.09 | 7.74 |
| % Volume of particles <1 μm | 91.33 | 62.1 |
| % Volume of particles 1-10 μm | 8.66 | 37.92 |
| Viscosity (mPa · s at 100 s⁻¹) at time 0 | 19.9 | 81.8 |
| Viscosity (mPa · s at 100 s⁻¹) at 1 month | 21.9 | 60.9 |
| Viscosity (mPa · s at 100 s⁻¹) at 3 months | 21.9 | |
| Viscosity (mPa · s at 100 s⁻¹) at 6 months | 24.6 | 88.8 |
| Sediment percentage (%) at 1 month | 0.5 | 0.74 |
| Sediment percentage (%) at 3 months | 0.36 | |
| Sediment percentage (%) at 6 months | 0.70 | 0.72 |

Powder A exhibited minimal particle size growth after UHT heat treatment when used to prepare pH neutral and acidic beverages with varying compositions. The particle size of the beverages after heating can be compared to Example 1, Table 3. Powder A exhibited a very low viscosity for high protein beverages after UHT heat treatment as well as all having a homogenous consistency with no traces of graininess or separation in the pack.

### Example 5: Use of the Improved Denatured Whey Protein Particle Composition of the Invention in High Protein Drinking Yoghurts

This example describes the preparation of a number of exemplary high protein drinking yogurts comprising powder B and C using the method according to the invention, compared to other denatured whey protein concentrates. Table 15 shows the nutritional composition and properties of the yoghurts comprising the denatured whey protein concentrates.

A flow chart of the yoghurt manufacture process is shown in FIG. 3. The denatured whey protein concentrates, and skim milk powder (SMP) were recombined in water to produce an aqueous composition comprising 15% by weight protein, 12% protein from the denatured whey protein particle compositions or 20% by weight protein, 17% from the denatured whey protein particle compositions. For each batch 9.2% (w/w) SMP was recombined and topped up with either 15% or 20% (w/w) denatured whey protein concentrate, depending on the final target protein. 0.02% (w/w) bacterial culture was added for fermentation. The balance to 100% was achieved with additional water.

TABLE 15
Compositions and properties of high protein drinking yoghurts containing denatured
whey protein concentrates (all compositions had acceptable flavour)

| Component | Nutritional composition | | | | | |
|---|---|---|---|---|---|---|
| Powder | B | C | E | F | G | C |
| Protein (g/100 g) | 15.0 | 15.0 | 15.0 | 15.0 | 15.0 | 20.0 |
| Protein (g/100 g) from denatured WPC | 12.0 | 12.0 | 12.0 | 12.0 | 12.0 | 17.0 |
| Protein (g/100 g) from SMP | 3.0 | 3.0 | 3.0 | 3.0 | 3.0 | 3.0 |
| Fat (g/100 g) | 0.9 | 0.9 | 0.8 | 0.8 | 0.7 | 1.2 |
| Carbohydrates (g/100 g) | 5.8 | 5.8 | 6.1 | 6.1 | 5.8 | 6.2 |
| Ash (g/100 g) | 1.0 | 1.0 | 1.1 | 1.1 | 1.1 | 1.1 |
| Total solids (g/100 g) | 23.0 | 23.0 | 23.2 | 23.2 | 23.2 | 28.9 |
| pH after fermentation | 4.60 | 4.61 | 4.57 | 4.53 | 4.53 | 4.51 |

Properties at 1 week

| | | | | | | |
|---|---|---|---|---|---|---|
| Viscosity (mPa · s) at 50 s⁻¹ | 56 | 57 | 147 | 108 | 39 | 88 |
| Volume weighted particle size d_{4, 3} (μm) | 1.12 | 0.934 | 11.4 | 14.4 | 12.5 | 0.985 |
| D50 (μm) | 0.79 | 0.76 | 5.94 | 7.06 | 4.15 | 0.76 |
| D90 (μm) | 1.78 | 1.63 | 28.5 | 37.9 | 37.7 | 1.66 |
| % Volume of particles <1 μm | 73.8 | 77.1 | 12.7 | 8.6 | 16.7 | 77.04 |
| % Volume of particles 1-10 μm | 25.3 | 22.9 | 59.1 | 57.5 | 55.0 | 22.94 |
| % Volume of particles >2 μm | 6.8 | 5.5 | 82.9 | 87.8 | 67.9 | 6.01 |
| Sedimentation (%) via centrifugation | 4.35 | 4.83 | 20.14 | 25.69 | 14.17 | 5.10 |
| Visual Sediment (%) | <5 | <5 | 20 | 20 | 10 | 5 |
| Phase separation (%) | 0 | 0 | 0 | 10 | 10 | 0 |
| Sensory | Thin, not | Thin, not | Thick, | Thick, | Thin, some | |
| | powdery | powdery | powdery | powdery | powderiness | |
| Appearance/Taste | Slight yellow/ | Slight cooked | More sour | More sour | Slight protein | |
| | brown colour. | flavour. | than B & C | than B & C | flavour. | |

Properties at end of shelf life (6 weeks)

| | | | | | | |
|---|---|---|---|---|---|---|
| Visual Sediment (%) | 5 | 5 | 50 | 40 | 40 | 5 |
| Phase separation (%) | 0 | 0 | 25 | 10 | 10 | 0 |

When Powder B and C were used to prepare a 15% (w/w) protein drinking yoghurt, the yoghurts showed minimal changes in the particle size characteristics 1 week after manufacture compared to the powder properties in Example 1, Table 3. The comparative powders, E, F and G, exhibited particle size growth 1 week after yoghurt manufacture. The yoghurts prepared with Powder B and C also showed a lower sediment (%) than the comparative yoghurts. Similarly, 6 weeks after manufacture at the end of the shelf life, the sediment (%) remained low and no phase separation was observed Powder B and C. The overall appearances of the yoghurts were smooth and homogenous in appearance and were very thin and pourable and no powdery or gritty texture. In comparison, Powder E and F showed thicker texture, powdery/gritty mouthfeel. There was significant sediment formation in the drinking yoghurts prepared with Powder E, F and G at the end of the 6 week shelf life. The sediment was a very solid gel layer and could not be redispersed back into the drinking yoghurt by shaking.

When Powder C was used to prepare a 20% (w/w) protein drinking yoghurt, it showed minimal changes in the particle size characteristics 1 week after yoghurt manufacture compared to the powder properties in Example 1, Table 3. The yoghurt was smooth and homogenous and was very thin and pourable. Powder F and G were also used to prepare a 20% (w/w) protein drinking yoghurt; however, they were found to be unsuitable for use during the heat treatment of 85 °C for 15 minutes as the samples resulted in the formation of large, gelled particles and lumps with a significant increase in viscosity. The samples had a grainy texture, and it would result in the blockage of processing equipment.

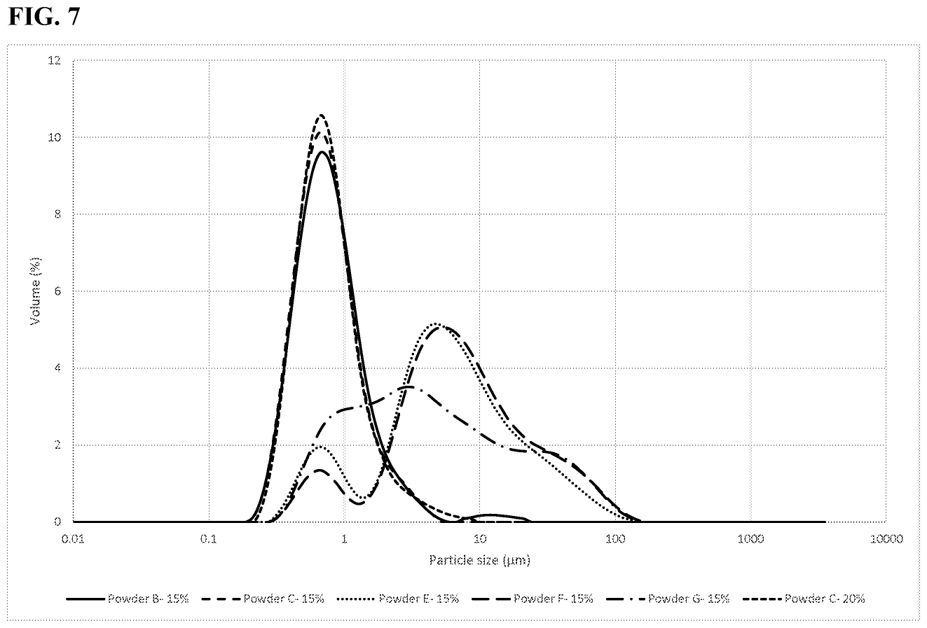

FIG. 7 shows the particle size distributions of the 15% (w/w) and 20% (w/w) protein yoghurts 1 week after manufacture which clearly shows the smaller particle size distribution of the denatured whey protein concentrates of the invention.

FIG. 7: Particle size distributions of high protein (15% (w/w) and 20% (w/w)) drinking yoghurts comprising denatured whey protein concentrates at 1 week.

### Example 6: Use of the Improved Denatured Whey Protein Concentrates in High Protein Set and Stirred Yoghurts

This example describes the preparation of exemplary high protein set and stirred yogurts comprising Powder C denatured whey protein composition of the invention, compared to Powder F. The formulations, composition and yoghurt properties of the set and stirred yoghurts are summarized in Table 16. The yoghurts were prepared according to FIG. 3, with some modifications stated in the methodology.

TABLE 16
Formulation, composition and properties of set
and stirred yoghurts using Powder C and Powder
F mixed with skim milk powder and MPC.

| Component | Powder C | Powder F |
|---|---|---|
| | Formulation | |
| Water | 76.05 | 75.83 |
| Powder C | 12.28 | |
| Powder F | | 12.50 |
| Skim Milk Powder (SMP) | 9.17 | 9.17 |
| Milk Protein Concentrate (MPC 85) | 2.48 | 2.48 |
| Bacterial culture | 0.02 | 0.02 |
| | Nutritional composition | |
| Protein (g/100 g) | 15.0 | 15.0 |
| Protein (g/100 g) from denatured WPC | 10.0 | 10.0 |
| Protein (g/100 g) from SMP | 3.0 | 3.0 |
| Protein (g/100 g) from MPC | 2.0 | 2.0 |
| Fat (g/100 g) | 0.8 | 0.8 |
| Carbohydrates (g/100 g) | 5.7 | 5.9 |
| Ash (g/100 g) | 1.1 | 1.2 |
| Total solids (g/100 g) | 23.0 | 23.1 |

Stirred yoghurt properties

| | | |
|---|---|---|
| pH after fermentation | 4.59 | 4.55 |
| Viscosity (mPa · s) at 50 s⁻¹ | 394 | 1129 |
| Volume weighted particle size d_{4, 3} (μm) | 1.82 | 4.16 |
| D50 (μm) | 0.793 | 3.25 |
| D90 (μm) | 4.78 | 8.61 |
| % Volume of particles <1 μm | 62.02 | 23.79 |
| % Volume of particles 1-10 μm | 37.56 | 71.50 |
| % Volume of particles >2 μm | 28.63 | 64.06 |

Set yoghurt properties

| | | |
|---|---|---|
| pH after fermentation | 4.59 | 4.55 |
| Fracture force (g) | 30.7 | 54.7 |
| Firmness (g · sec) | 533 | 1000 |

The stirred yoghurt prepared with Powder C exhibited a lower viscosity compared to Powder F; Powder C produced a yoghurt that was soft and spoonable with a shiny and smooth appearance while the yoghurt prepared with Powder F was rougher in texture. The set yoghurt prepared with Powder C exhibited a lower fracture force and firmness compared to Powder F.

### Example 7: Use of the Improved Denatured Whey Protein Concentrate in a Protein Bar

An exemplary way of showing the use of the denatured whey protein concentrate in a protein bar is described.

The protein bar was prepared by combining maltodextrin and Powder C. Glucose syrup, glycerine and water were combined and heated to 50-55 °C. The glucose syrup and glycerine mix was added to the maltodextrin and protein mix followed by the addition of the oil and lecithin mix. Confectionary fat and lecithin were heated until the fat melted. The mix was mixed using a Hobart mixer (Model N-50) at Speed 1 for 90 seconds, and then the bowl was scraped down. Mixing (Speed 2) was continued until a homogenous mass was obtained.

The mix was poured and spread evenly into a bar frame (~16 mm deep) and was rolled out so that it was flush with the frame, any excess was cut off. The mix was left overnight to set. The mix was loosened from the frame and cut into bars of 30 mm×100 mm. The bars were packed in foil sachets for storage until use. The composition and fracture force (g) properties of the protein bars are described in Table 17.

The fracture force (g) of the bar was evaluated using a TAHD Plus texture analyser from Stable Micro Systems, Godalming, England. The texture measurements were performed by penetration. Forces were measured over a set penetration depth of 12 mm. A 5 mm stainless steel cylindrical probe was pushed into the bar at a constant rate of 1 mm/s to a depth of 12 mm, and was then withdrawn at a rate of 10 mm/s. The force (g) versus time(s) for the movement of the probe was measured. Three compressions were made over the surface of each bar sample. Two bars were evaluated for each sample. The samples were removed from 20 °C storage and texture measurements were made at 20 °C in a temperature-controlled room.

TABLE 17
Formulation, composition and properties
of a protein bar using Powder C

| | Powder C |
|---|---|
| Component | Formulation |
| Powder C | 36.81 |
| Maltodextrin DE18 | 2.90 |
| Glucose syrup | 34.90 |
| Glycerine | 17.40 |
| Confectionary fat | 6.59 |
| Water | 0.9 |
| Soy lecithin | 0.50 |
| | Nutritional composition |
| Protein (g/100 g) | 30.0 |
| Fat (g/100 g) | 8.8 |
| Carbohydrates (g/100 g) | 48.8 |
| Ash (g/100 g) | 1.1 |
| Total solids (g/100 g) | 89.7 |

Protein bar properties

| | |
|---|---|
| Firmness (g) after 1 week | 1658 |
| Firmness (g) after 1 month | 2319 |

Powder C produced an acceptable protein bar in terms of texture. The sensory properties of the bar were acceptable in terms of texture attributes including firmness, hardness, cohesiveness, and graininess. No off-flavour attributes we detected in the protein bar. The firmness of the protein bar was 2310 g after 1 month storage and a firmness of less than about 4000 g after 12 months storage is suitable. The water activity of the bar was 0.51 after 1 month storage, which is below the limit for microbial stability of 0.65. The results indicate that the denatured whey protein concentrate is suitable for use in protein bars.

### Example 8: Effect of Addition Rate on Improvement of Heat Stability of Denatured Whey Protein Particle Composition

An uncolored dairy cheese whey solution was prepared via reconstitution of powder of dairy cheese whey protein (WPC 80) up to 20-22% (w/w) protein concentration. The composition of WPC 80 powder is summarized in Table 18. The solution was homogenized at 200/50 bar then divided into four (4) batches. Three batches were pH adjusted to 6.2 using a KOH: NaOH (50:50) blend at 1M concentration and one sample was pH adjusted to pH 5.3 using HCl 6M. pH 5.3 is close to the optimum pH for maximum activity of MaxiBright which would enable peroxide to be dosed at higher rate without inhibiting enzyme activity. Adequate equal amounts of commercial MaxiBright solution was added to all four samples and the samples were mixed using over head strirrer at 150 rpm in the chiller at 4 °C. Samples named as follow 1) Control-No peroxide addition, 2) pH 6.2-75 ppm peroxide all was added at one step, 3) pH 6.2-75 ppm peroxide was added incrementally at rate of 10 ppm/hr, and 4) pH 5.3-75 ppm peroxide was added incrementally at rate of 30 ppm/hr. 75 ppm of peroxide was equivalent to 0.375 mole H₂O₂/mole of β-lactoglobulin protein. The enzyme dairy bleaching activity as per COA from DSM was 5000 U/g. After completion of peroxide dosing and ensuring no peroxide left in the solutions, sample 4 was pH adjusted to 6.2 using aforementioned KOH: NaOH blend prior to heating. Subsequently to produce heat stable denatured whey protein particle composition, a combination of scraped surface heat exchanger and steam heated pilot scale tubular heat exchanger were used. Samples were preheated to 55 °C in a scraped surface heat exchanger followed by heating up to 85 °C in steam-heated tubular heat exchanger. The flowrate was adjusted to achieve wall shear rate of 1800 s⁻¹ in tubular heat exchanger. A holding tube with the similar tube specification as steam heated tubular heat exchanger was used to keep the sample temperature at 85 °C for extra 20 s to provide required residence time for achieving desired HCT. Then samples were cooled down, collected, and tested for HCT as described in section 3-Heat Coagulation Time. Protein profile was tested for all samples before and after heat treatment as described in section 5-Highly denatured.

FIG. 8: Heat coagulation time of the denatured whey protein compositions prepared from samples treated at different peroxide dosing rate.

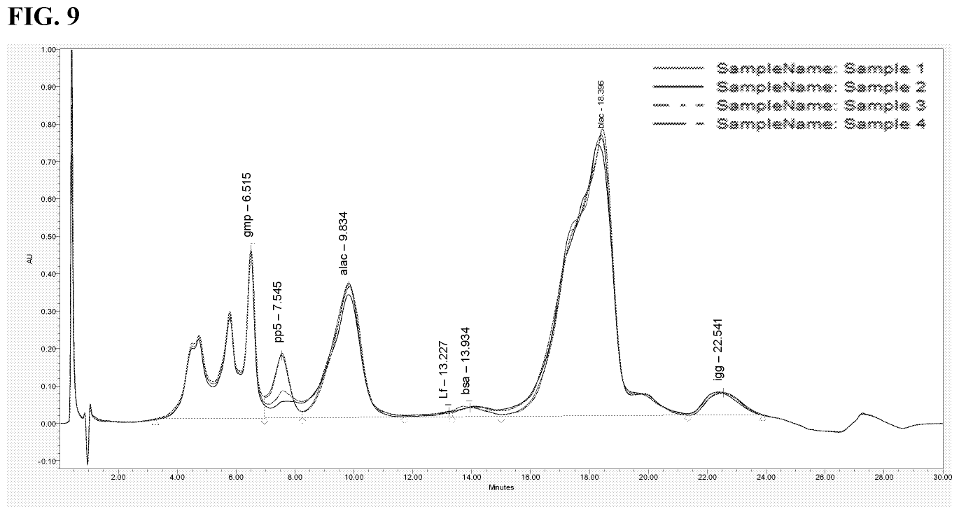

FIG. 9: Protein profile of samples after treatment by enzyme and before heat treatment analyzed by HPLC, including peaks for glycomacropeptide (gmp), proteose peptone 5 (pp5), α-lactalbumin (alac), lactoferrin (Lf), BSA, β-lactoglobulin (blac), and immunoglobulins (igg).

TABLE 18
Composition of WPC 80 powder

| | |
|---|---|
| Moisture content (g/100 g powder) | 4.5 |
| Ash (g/100 g powder) | 2.63 |
| Carbohydrates (g/100 g powder) | 6.8 |
| Fat (g/100 g powder) | 5.6 |
| Protein content (g/100 g powder) | 80.5 |
| β-Lg (% protein) | 52.9 |
| α-Lac (% protein) | 13.2 |
| GMP (% protein) | 23.2 |
| pp5 (% protein) | 4.9 |
| Lactoferrin (% protein) | 0.2 |
| BSA (% protein) | 1.5 |
| IGG (% protein) | 4 |
| Ca (mg/100 g powder) | 386 |
| K (mg/100 g powder) | 567 |
| Na (mg/100 g powder) | 115 |

### Example 9: Use of the Improved Denatured Whey Protein Particle Composition of the Invention in Low Calorie High Protein Liquid Nutritional Compositions at Neutral pH

This example describes the preparation of neutral pH low-calorie high protein beverages comprising powder A denatured whey protein composition of the invention. The formulation, composition and properties of the neutral pH low-calorie high protein beverage are summarized in Table 19. The beverage with a protein level of 12% (w/v) was prepared according to FIG. 2, with some modifications in UHT condition. Indirect UHT condition 143 °C for 6 s was used.

TABLE 19
Formulation of neutral pH low calorie high protein
liquid beverage comprising Powder A.

| Ingredient (g/100 g) | Formulation 6 |
|---|---|
| Water | 82.81 |
| Powder A | 15.40 |
| Canola oil | 0.59 |
| Sodium chloride | 0.01 |
| Tri-potassium citrate | 0.22 |
| Tri-sodium citrate | 0.10 |
| Potassium chloride | 0.08 |
| Di-magnesium phosphate | 0.18 |
| Choline chloride | 0.03 |
| Mineral & Vitamin premix | 0.06 |
| Tri Calcium phosphate | 0.09 |
| Gellan gum | 0.04 |
| Cellulose gum | 0.20 |
| Lecithin | 0.01 |
| Antifoam | 0.01 |
| 5% potassium hydroxide | 0.18 |
| pH | 6.8 |
| UHT Process conditions (Temp, | 143 °C for 6 s |
| time) | |

TABLE 20
Nutritional composition of neutral pH low calorie
high protein liquid beverage comprising powder A

| Component | Formulation 6 |
|---|---|
| Protein (g/100 ml) | 12.4 |
| Protein (g/100 ml) from denatured | 12.4 |
| WPC | |
| Fat (g/100 ml) | 1.6 |
| Ash (g/100 ml) | 1.2 |
| Sodium (mg/100 ml) | 77 |
| Potassium (mg/100 ml) | 218 |
| Calcium (mg/100 ml) | 108 |
| Phosphorus (mg/100 ml) | 102 |
| Iron (mg/100 ml) | 1.1 |
| Magnesium (mg/100 ml) | 38.3 |
| Zinc (mg/100 ml) | 1.0 |
| Manganese (mg/100 ml) | 0.24 |
| Selenium (ug/100 ml) | 9.4 |
| Copper (mg/100 ml) | 0.13 |
| Chloride (mg/100 ml) | 63 |
| Iodine (μg/100 ml) | 19 |
| Vit A (% RE) (μg/100 ml) | 167 |
| Vit C (mg/100 ml) | 19 |
| Vit D (μg/100 ml) | 1.7 |
| Vit E (mg/100 ml) | 1.2 |
| Vit K (μg/100 ml) | 5.7 |
| Thiamine (mg/100 ml) | 0.35 |
| Riboflavin (mg/100 ml) | 0.26 |
| Niacin (mg/100 ml) | 2.1 |
| Vit B6 (mg/100 ml) | 0.30 |
| Biotin (μg/100 ml) | 5.3 |
| Folic acid (μg/100 ml) | 36 |
| Vit B12 (μg/100 ml) | 0.19 |
| Vit B5 (mg/100 ml) | 0.91 |
| Choline (mg/100 ml) | 35 |
| Carbohydrates (g/100 ml) | 1.7 |
| Energy (Cal/100 ml) | 72 |

TABLE 21
Beverage characteristics of neutral pH low calorie high
protein liquid beverage before UHT heat treatment.

| | Formulation 6 |
|---|---|
| Volume weighted particle size d_{4, 3} (μm) | 0.85 |
| D₅₀ (μm) | 0.57 |
| % Volume of particles <1 μm | 93 |
| % Volume of particles 1-10 μm | 6.3 |
| % Volume of particles >2 μm | 3.1 |
| Viscosity (mPa · s at 100 s⁻¹) | 42 |

TABLE 22
Beverage characteristics of neutral pH low calorie high protein liquid
beverage comprising Powder A after Indirect UHT heat treatment.

| | Formulation 6 |
|---|---|
| Volume weighted particle size d_{4, 3} | 1.3 |
| (μm) | |
| D₅₀ (μm) | 0.65 |
| D₉₀ (μm) | 3.15 |
| % Volume of particles <1 μm | 76 |
| % Volume of particles 1-10 μm | 24 |
| % Volume of particles >2 μm | 15 |
| Viscosity (mPa · s at 100 s⁻¹) at time | 31 |
| 0 | |
| Viscosity (mPa · s at 100 s⁻¹) at 1 | 37 |
| month | |
| Viscosity (mPa · s at 100 s⁻¹) at 3 | 50 |
| months | |
| Viscosity (mPa · s at 100 s⁻¹) at 6 | 54 |
| months | |

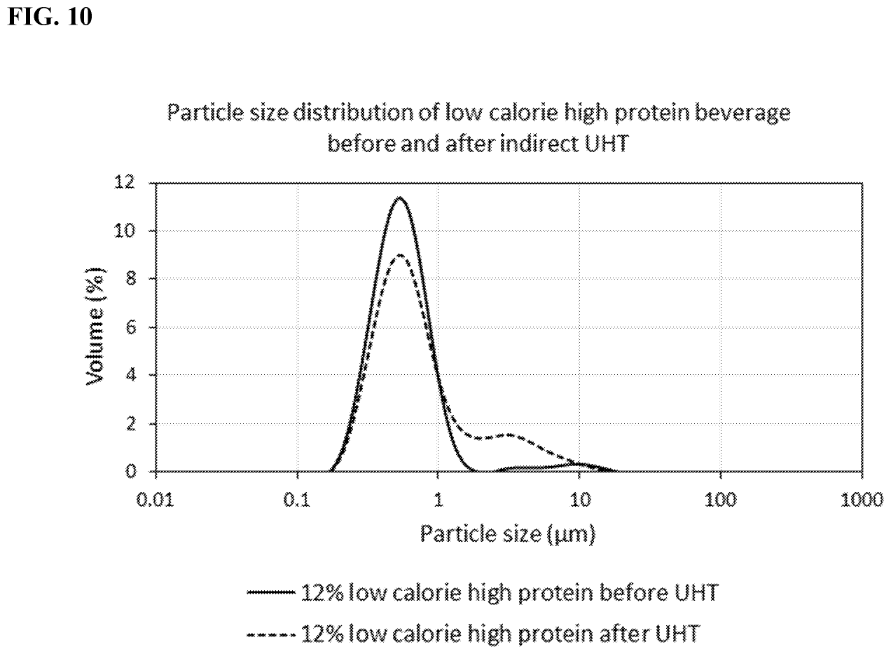

FIG. 10: Particle size distribution of 12% (w/v) low calorie high protein beverage before and after indirect UHT heating (143 °C. 6 s).

It can be seen from above results, Powder A exhibited minimal particle size growth after indirect UHT heat treatment in formulation 6 beverage with viscosity less than 100 mPa·s at 100 s⁻¹ during shelf-life storage. Formulation 6 beverage showed homogenous consistency with no separation and visible protein particles or aggregates in the pack.

### Example 10: Use of the Improved Denatured Whey Protein Concentrates in High Protein Cookies

This example describes the preparation of high protein cookies comprising powder C denatured whey protein composition of the invention. A high protein (~20%) cookie was made based on the formulation and method of Cooper et al., J. Food Sci., 49 (2), 376-379 (1984) to compare the performance of the performance of denatured whey protein composition of the invention with another insoluble whey protein ingredient, lactalbumin, on an equivalent protein basis. The formulations of the high protein cookies are summarized in Table 23.

TABLE 23
High protein cookie formulations

| Ingredient (weight, g) | Powder C | Lactalbumin |
|---|---|---|
| Butter | 122 | 122 |
| Sugar (caster) | 100 | 100 |
| Powder C | 90 | — |
| NZMP SureProtein ™ | — | 80 |
| Lactalbumin 825 | | |
| Flour, regular (10% | 200 | 200 |
| protein), | | |
| Baking powder (double | 6.4 | 6.4 |
| acting) | | |
| Water | 71 | 85 |

The butter at 20 °C was mixed with a flat beater at speed 2 for 30 s in a Hobart mixer (Model N50, Hobart Corporation, US). Sugar was added over 30 s; the bowl scraped down and mixed for a further 60 s. The protein ingredient was added over the next 60 s at speed 1; scraped down and mixed for a further 60 s at speed 2. Sifted flour and baking powder were added over 60 s at speed 1. Water (55 g) was added over 60 s at speed 1. If the dough was too crumbly and dry and did not form a cohesive mass, further water was added whilst mixing. The dough was rolled out to 5 mm thickness and cut into 50 mm diameter discs. The discs were placed on a baking paper-lined metal tray and baked at 180 °C for 12.5 minutes until the bottom surface was brown. The baked cookies were cooled on a wire rack for 30 minutes before evaluation. The experiment was replicated.

The cookies were evaluated subjectively for color; surface appearance (smooth to rough); initial texture (appearance when broken in half: close to open texture); crispness (ease with which broken when first bitten); residual mouthfeel (fine to floury; powdery, amount of residue). The spread ratio (Width/Thickness) was determined according to the AACC method (American Association of Cereal Chemists (1984) Approved Methods of the American Association of Cereal Chemists. Vol I. (8th edn). Method 10-50D, revised 1986. Baking quality of cookie flour. St Paul, Minnesota, US) using 6 baked cookies. The evaluation of the baked cookies can be found in Table 24.

TABLE 24
Characteristics of high protein cookies

| | | Comparator: Lactalbumin |
|---|---|---|
| Characteristics | Powder C | high protein cookie |
| Colour | Golden brown | Pale cream |
| Surface appearance | Smooth, some slight | Smooth, slight cracking on |
| | cracking | all cookies |
| Internal texture | Open, similar to | Open, similar to shortbread |
| | shortbread | |
| Crispness | Crisp on first bite | Slightly crisp on first bite |
| Residual mouthfeel | Fine, dissolvable | Powdery, slightly sandy |
| | | mouthfeel |
| Width (W), mm | 49.0, 49.2, 49.5, 49.5 | 49.1, 49.3; 49.0, 48.7 |
| Thickness (T), mm | 10.8, 10.5; 10.8, 10.5 | 9.5, 9.5; 10.1, 9.8 |
| Spread ratio = W/T | 4.6 ± 0.1 | 5.0 ± 0.1 |

The cookie containing powder C (of example 1) as protein source was browner, crispier and had a better mouthfeel than the comparator ingredient.

### Example 11: Use of the Improved Denatured Whey Protein Concentrates in High Protein Ambient Yoghurt

This example describes the preparation of exemplary high protein ambient yogurts comprising denatured whey protein composition of the invention, compared to Powder F. The formulations and composition of the ambient yoghurts are summarized in Table X. The yoghurts are prepared according to FIG. 3, with modifications. Amidated Low Methoxyl (LMA) pectin and gellan gum are added during recombining of the dry ingredients and cream is added in the last 10 minutes of recombining. After stirring to break the gel the ambient yoghurts are thermalized at 75 °C for 30 seconds and packed, then stored at ambient temperature.

TABLE 25
Formulation and composition of ambient yoghurts using
Powder C and Powder F mixed with skim milk powder.

| Component | Powder C | Powder F |
|---|---|---|
| | Formulation | |
| Water | 70.03 | 69.76 |
| Powder C | 7.38 | |
| Powder F | | 7.49 |
| Skim Milk Powder (SMP) | 8.76 | 8.76 |
| Cream | 6.65 | 6.81 |
| LMA pectin | 0.15 | 0.15 |
| Kelcogel YSS gellan gum | 0.03 | 0.03 |
| Sugar | 7 | 7 |
| Bacterial culture | 0.02 | 0.02 |
| | Nutritional composition | |
| Protein (g/100 g) | 9.0 | 9.0 |
| Protein (g/100 g) from denatured WPC | 6.0 | 6.0 |
| Protein (g/100 g) from SMP | 3.0 | 3.0 |
| Fat (g/100 g) | 3.0 | 3.0 |
| Carbohydrates (g/100 g) | 12.61 | 12.67 |
| Ash (g/100 g) | 0.8 | 0.8 |
| Total solids (g/100 g) | 25.4 | 25.6 |

The pH, flavour, viscosity, particle size distribution, visual sediment (%) at the end of shelf life, phase separation (%) at the end of shelf life, and sediment after centrifugation of the ambient yoghurts produced is assessed using the methods described herein.

It is expected that the pH will be acceptable for a yoghurt product. It is expected that the viscosity and sedimentation of the ambient yoghurt prepared with Powder C remains low over the shelf life and have acceptable sensory properties.

It is understood that the foregoing detailed description and accompanying examples are merely illustrative and are not to be taken as limitations upon the scope of the invention, which is defined solely by the appended claims and their equivalents. Various changes and modifications to the disclosed embodiments will be apparent to those skilled in the art. Such changes and modifications, including without limitation those relating to the chemical structures, substituents, derivatives, intermediates, syntheses, formulations, or methods, or any combination of such changes and modifications of use of the invention, may be made without departing from the spirit and scope thereof.

All references (patent and non-patent) cited above are incorporated by reference into this patent application. The discussion of those references is intended merely to summarize the assertions made by their authors. No admission is made that any reference (or a portion of any reference) is relevant prior art (or prior art at all). Applicant reserves the right to challenge the accuracy and pertinence of the cited references.

1. A heat-stable, denatured whey protein composition comprising an amount of total protein of at least 60% on a dry weight basis and microparticles comprising denatured whey protein, wherein either:
(a) the microparticles have a particle size distribution comprising at least two characteristics selected from the group consisting of: (i) a volume weighted mean diameter D(4,3) of not more than about 1.0 μm, (ii) a d₅₀ of not more than about 1.0 μm, (iii) a d₉₀ of not more than about 2.0 μm, (iv) at least 92% by volume of the particles have a diameter less than about 2.0 μm, and (v) not more than 45% by volume of the microparticles have a diameter between about 1.0 and about 10.0 μm, and/or
(b)
i. wherein the d₅₀ is from about 0.6 to about 1.0 μm after heating a 10% (w/w) protein content aqueous solution comprising the denatured whey protein composition at 120 °C for 15 minutes;
ii. wherein the doo is not more than about 2.0 μm, such as from about 0.9 to about 1.7 μm, after heating a 10% (w/w) protein content aqueous solution comprising the denatured whey protein composition at 120 °C for 15 minutes;
iii. wherein the volume weighted mean diameter D(4,3) is not more than about 1.0 μm, such as from about 0.6 to about 1.0 μm, after heating a 10% (w/w) protein content aqueous solution comprising the denatured whey protein composition at 120 °C for 15 minutes; and/or
iv. wherein a 10% (w/w) protein content aqueous solution comprising the denatured whey protein composition has a heat coagulation time (HCT) of at least 3 minutes, at least 4 minutes, at least 5 minutes, at least 6 minutes, at least 9 minutes, at least 12 minutes, at least 15 minutes, or at least 18 minutes at 140 °C.

2. The heat-stable, denatured whey protein composition of claim 1, wherein the particle size distribution comprises (iv) at least 92%, at least 95%, or at least 98% by volume of the particles have a diameter less than about 2.0 μm and/or (v) not more than 45% by volume of the microparticles have a diameter between about 1.0 and about 10.0 μm.

3. The heat-stable, denatured whey protein composition of claim 1, wherein the microparticles have a particle size distribution comprising at least two characteristics selected from the group consisting of: (i) a volume weighted mean diameter D(4,3) of not more than about 1.0 μm, (ii) a d₅₀ of not more than about 1.0 μm, (iii) a d₉₀ of not more than about 2.0 μm, (iv) at least 92% by volume of the particles have a diameter less than about 2.0 μm, and (v) not more than 45% by volume of the microparticles have a diameter between about 1.0 and about 10.0 μm.

4. The heat-stable, denatured whey protein composition of claim 1, wherein the composition comprises less than about 10% casein by weight, preferably wherein the composition is substantially free of casein.

5. The heat-stable, denatured whey protein composition of claim 1, wherein the composition comprises from about 30% to about 80% β-lactoglobulin, about 35% to about 75% β-lactoglobulin, or about 40% to about 65% β-lactoglobulin, relative to total protein in the composition.

6. The heat-stable, denatured whey protein composition of claim 1, wherein the composition comprises at least 70% (w/w) whey protein relative to total protein, at least 80% (w/w) whey protein relative to total protein, or at least 90% (w/w) whey protein relative to total protein.

7. The heat-stable, denatured whey protein composition of claim 1, wherein residual denaturable whey protein in the denatured whey protein composition is less than 16%.

8. The heat-stable, denatured whey protein composition of claim 1, wherein a 3.4% (w/w) protein content aqueous solution containing the heat-stable, denatured whey protein composition exhibits a turbidity value measured at 500 nm at about 20 °C of at least 50 absorbance units, preferably at least 100 absorbance units, and/or a 4% (w/w) protein content aqueous solution containing the denatured whey protein composition exhibits a turbidity value measured at 500 nm at about 20 °C of at least 90 absorbance units, preferably at least 100 absorbance units.

9. The heat-stable, denatured whey protein composition of claim 1, wherein the denatured whey protein composition has an insolubility of at least 60%.

10. A composition comprising the heat-stable, denatured whey protein composition of claim 1.

11. The composition of claim 10, wherein the composition is (i) a liquid composition, such as a drinking yoghurt, a liquid nutritional composition (e.g., a medical food), or a high protein beverage such as a neutral or acidic high protein beverage or (ii) a food product, such as a baked food product, a bar, or a set or stirred yoghurt.

12. A composition comprising the heat-stable, denatured whey protein composition of claim 1, wherein the composition is a food product, wherein
the food product is a set yoghurt, the set yoghurt optionally comprising from about 6% to about 20% (w/v) total protein with, optionally, at least 50% (w/w) of the total protein coming from the denatured whey protein composition, wherein the set yoghurt exhibits reduced firmness and/or reduced volume weighted mean particle size compared to a control set yoghurt product having the same ingredient composition and the same protein content except that the control set yoghurt product does not comprise a denatured whey protein composition of claim 1; or
the food product is a stirred yoghurt, the stirred yoghurt optionally comprising from about 6% to about 20% (w/v) total protein with, optionally, at least 50% (w/w) of the total protein coming from the denatured whey protein composition, wherein the stirred yoghurt exhibits reduced viscosity and/or reduced volume weighted mean particle size compared to a control stirred yoghurt product having the same ingredient composition and the same protein content except that the control stirred yoghurt product does not comprise a denatured whey protein composition of claim 1.

13. A method for preparing a heat-stable, denatured whey protein composition, the method comprising: (a) providing an aqueous whey protein solution or a whey protein retentate; (b) contacting the aqueous whey protein solution or the whey protein retentate with an oxidizing agent in combination with a catalyst, such as an enzymatic catalyst or a chemical catalyst, preferably a peroxidase enzyme; and (c) subjecting the whey protein solution or the whey protein retentate to a heat treatment under conditions of high shear stress/force, wherein the total protein content of the aqueous whey protein solution or whey protein retentate at step (c) is preferably at least 16% (w/w); wherein the high shear stress/force is optionally generated by increased serum phase viscosity, a wall shear rate higher than 1000 s⁻¹, a turbulent flow pattern with Re of at least 2000, application of mechanical shear, or a combination thereof.

14. The method of claim 13, wherein the oxidizing agent is hydrogen peroxide or benzoyl peroxide and/or the catalyst is a peroxidase enzyme.

15. The method of claim 13, wherein the oxidizing agent is present in step (b) in an amount less than 300 ppm or less than 200 ppm or the mole ratio of the oxidizing agent to β-lactoglobulin is less than 2, preferably less than 1 or from about 0.1 to about 0.85.

16. A heat-stable, denatured whey protein composition prepared by the method of claim 13.

17. A heat-treated, shelf-stable high protein liquid composition comprising at least 6% (w/v) whey protein,
wherein said whey protein comprises microparticles comprising denatured whey protein; and
wherein (i) the liquid composition has a d₅₀ of not more than about 1.0 μm and/or a d₉₀ of not more than about 2.0 μm after secondary heat treatment applied for microbial control; (ii) said liquid composition has a viscosity of less than 400 mPa·s or less than 200 mPa·s measured at 100 s⁻¹ at 20 °C; (iii) said liquid composition exhibits less than 10% sedimentation following storage at a temperature from about 20 °C to about 25 °C for the shelf-life of the liquid composition; and/or (iv) said liquid composition exhibits less than 10% sedimentation after centrifugation at 1540×g for 5 minutes.

18. The heat-treated, shelf-stable liquid composition of claim 17, wherein the liquid composition comprises at least 8%, at least 10%, at least 12%, at least 14%, at least 16%, at least 18%, or at least 20% (w/v) denatured whey protein.

19. The heat-treated, shelf-stable liquid composition of claim 17, wherein the liquid composition is a liquid nutritional composition for use in providing nutrition to a subject in need thereof and the liquid composition has an energy density of at least 0.5, at least 1.0, at least 1.5, or at least 2.0 kcal/ml.

20. The heat-treated, shelf-stable liquid composition of claim 17, further comprising other dairy proteins and/or non-dairy proteins.

21. A liquid nutritional composition comprising microparticles comprising denatured whey protein,
wherein at least 95% of the total protein in the liquid nutritional composition is denatured whey protein;
wherein the liquid nutritional composition optionally further comprises a lipid component and/or a carbohydrate component.

22. The liquid nutritional composition of claim 21, wherein substantially all of the total protein in the liquid nutritional composition is denatured whey protein.

23. The liquid nutritional composition of claim 21, wherein the liquid nutritional composition comprises at least 12% (w/v) total protein.

24. The liquid nutritional composition of claim 21, wherein the liquid nutritional composition comprises not more than 12% (w/v) total protein.

25. The liquid nutritional composition of claim 21, wherein (i) the liquid composition has a d₅₀ of not more than about 1.0 μm after secondary heat treatment applied for microbial control; (ii) said liquid composition has a viscosity of less than 400 mPa·s or less than 200 mPa·s measured at 100 s⁻¹ at 20 °C; (iii) said liquid composition exhibits less than 10% sedimentation following storage at a temperature from about 20 °C to about 25 °C for at least 3 months; and/or (iv) said liquid composition exhibits less than 10% sedimentation after centrifugation at 1540×g for 5 minutes.
